(19) United States
(12) Patent Application Publication
(10) Pub. No.: US 2025/0220171 A1
(43) Pub. Date: Jul. 3, 2025

(54) Classifying Samples for Multi-Model Reference Filtering

(71) Applicant: Ofinno, LLC, Reston, VA (US)

(72) Inventors: Alexey Konstantinovich Filippov, Khimki (RU); Vasily Alexeevich Rufitskiy, Vladimir (RU); Esmael Hejazi Dinan, McLean, VA (US)

(21) Appl. No.: 19/002,160

(22) Filed: Dec. 26, 2024

Related U.S. Application Data
(60) Provisional application No. 63/615,031, filed on Dec. 27, 2023.

(51) Int. Cl. H04N 19/117; H04N 19/105; H04N 19/176; H04N 19/80

(52) U.S. Cl. CPC H04N 19/117; H04N 19/105; H04N 19/176; H04N 19/80

(57) ABSTRACT

A video coder (encoder or decoder) classifies, based on a first threshold, first samples neighboring a reference block into a first and a second group. The coder classifies, based on a second threshold, second samples corresponding to the first samples and neighboring a current block into the first and second groups. A first filter is determined based on first sample pairs of samples, of the first samples, classified in the first group and corresponding samples, of the second samples, classified in the first group. A second filter is determined based on second sample pairs of samples, of the first samples, classified in the second group and corresponding samples, of the second samples, classified in the second group. The current block is coded based on a prediction block determined by applying at least the first and second filters to the reference block.

### CROSS-REFERENCE TO RELATED APPLICATIONS

This application claims the benefit of U.S. Provisional Application No. 63/615,031, filed Dec. 27, 2023, which is hereby incorporated by reference in its entirety.

### BRIEF DESCRIPTION OF THE DRAWINGS

Some features are shown by way of example, and not by limitation, in the accompanying drawings. In the drawings, like numerals reference similar elements.

FIG. 1 shows an example video coding/decoding system in which embodiments of the present disclosure may be implemented.

FIG. 2 shows an example encoder in which embodiments of the present disclosure may be implemented.

FIG. 3 shows an example decoder in which embodiments of the present disclosure may be implemented.

FIG. 4 shows an example quadtree partitioning of a coding tree block (CTB).

FIG. 5 shows an example quadtree corresponding to the example quadtree partitioning of the CTB in FIG. 4.

FIG. 6 show examples of binary tree and ternary tree partitions.

FIG. 7 shows an example of combined quadtree and multi-type tree partitioning of a CTB.

FIG. 8 shows an example tree corresponding to the combined quadtree and multi-type tree partitioning of the CTB shown in FIG. 7.

FIG. 9 shows an example set of reference samples determined for intra prediction of a current block.

FIGS. 10A and 10B show example intra prediction modes.

FIG. 11 shows an example of a current block and corresponding reference samples.

FIG. 12 shows an example of applying an intra prediction mode (e.g., an angular mode) for prediction of a current block.

FIG. 13A shows an example of inter prediction performed for a current block in a current picture.

FIG. 13B shows an example motion vector.

FIG. 14 shows an example of bi-prediction performed for a current block.

FIG. 15A shows example spatial candidate neighboring blocks relative to a current block being coded.

FIG. 15B shows example locations of two temporal, co-located blocks relative to a current block.

FIG. 16 shows an example of intra block copy (IBC).

FIG. 17A shows an example of a current block and a reference block with corresponding templates used in determining scale and offset parameters for local illumination compensation (LIC) during inter prediction, according to some embodiments.

FIG. 17B shows a process for generating a prediction block when LIC is used during inter prediction, according to some embodiments.

FIG. 18A shows a process for generating a prediction block by applying an illumination compensation function (e.g., a filter model) that uses a multiple-tap filter to generate predicted samples from samples of the reference template, according to some embodiments.

FIG. 18B shows an example reference template and example multiple-tap filter models that can be applied to the reference template to generate a multi-tap filter, according to some embodiments.

FIG. 19A shows an example process of using the gradients of multiple-tap filter samples to obtain illumination compensated predicted samples for inter prediction, according to some embodiments.

FIG. 19B shows examples of first-order derivatives and second-order derivatives of example samples for filtering, according to some embodiments.

FIG. 20 shows a flowchart of a process of signaling illumination compensation, according to some embodiments.

FIG. 21 shows a flowchart of a process by which the decoder can determine, when using inter prediction merge mode, whether illumination compensation based on multi-parametric reference filtering (MPRF) is used for the block, according to some embodiments.

FIG. 22 shows an example coding scheme to efficiently encode and decode an indication of filter models (e.g., an MPRF model), according to some embodiments.

FIG. 23A shows a flowchart of a method of deriving a filter model to be applied for illumination compensation in inter prediction, according to some embodiments.

FIG. 23B shows an example reference template format and a current template format that are used to derive the filter model of a plurality of filter models in the method shown in the flowchart of FIG. 23A, according to some embodiments.

FIG. 24 shows an example of when filter model parameters can be obtained from a merge candidate, according to some embodiments.

FIG. 25A and FIG. 25B show example block sizes of merge candidate blocks that can be considered when deciding whether to obtain filter model parameters from one of the merge candidates, according to some embodiments.

FIG. 26 shows a flowchart of a method for applying illumination compensation based on MPRF in inter prediction, according to some embodiments.

FIG. 27 shows a flowchart of a method for determining a current block that has been encoded by applying illumination compensation based on multi-parametric reference filtering (MPRF) in inter prediction, according to some embodiments.

FIG. 28 shows a first example histogram of values of reference samples (e.g., luma components of pixels) neighboring a reference block classified into two groups (e.g., first group (also referred to as group 0), second group (also referred to as group 1)) by a first threshold.

FIG. 29A shows a graph illustrating a plurality of sample pairs (with classification match), a first threshold for classifying reference samples of the sample pairs, and a second threshold for classifying current samples of the sample pairs according to some embodiments.

FIG. 29B shows a graph illustrating a plurality of sample pairs (eleven sample pairs with classification match and one sample pair with classification mismatch in this example), a first threshold for classifying reference samples of the sample pairs, and a second threshold for classifying current samples of the sample pairs according to some embodiments.

FIG. 30 shows a graph illustrating a plurality of sample pairs, a first threshold (e.g., initial first threshold, adjusted first threshold) for classifying reference samples of the sample pairs, and a second threshold for classifying current samples of the sample pairs according to some embodiments.

FIG. 31 illustrates a first threshold determined by the coder (e.g., initial first threshold, adjusted first threshold) and a second threshold determined by the coder according to some embodiments.

FIG. 32 illustrates a first line representing a first filter and a second line representing a second filter where the first line and the second line are not connected (e.g., non-continuous lines) according to some embodiments.

FIG. 33 illustrates a plurality of first thresholds (e.g., first first threshold determined by the coder, second first threshold determined by the coder) for classifying reference samples of sample pairs and a plurality of second thresholds (e.g., first second threshold determined by the coder, second second threshold determined by the coder) for classifying current samples of the sample pairs according to some embodiments.

FIG. 34 illustrates a first line representing a first filter, a second line representing a second filter, and a third line representing a third filter where the first line, the second line, and the third line are apart from each other (e.g., non-continuous lines) according to some embodiments.

FIG. 35A shows a flowchart of an example method for determining a first threshold for classifying reference samples according to some embodiments.

FIG. 35B shows a flowchart of an example method for determining a first threshold for classifying reference samples according to some embodiments.

FIG. 36A shows a flowchart of an example method for determining a second threshold for classifying current samples according to some embodiments.

FIG. 36B shows a flowchart of an example method for determining a second threshold for classifying current samples according to some embodiments.

FIG. 37 shows a flowchart of an example method for determining a plurality of first thresholds (e.g., first first threshold, second first threshold) for classifying reference samples according to some embodiments.

FIG. 38 shows a flowchart of an example method for determining a plurality of second thresholds (e.g., first second threshold, second second threshold) for classifying current samples according to some embodiments.

FIG. 39A and FIG. 39B illustrate a flowchart of an example method for generating a prediction block for a current block (e.g., for decoding a current block, for reconstructing a current block) according to some embodiments.

FIG. 40A and FIG. 40B illustrate a flowchart of an example method for generating a prediction block for a current block (e.g., for decoding a current block, for reconstructing a current block) according to some embodiments.

FIG. 41 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

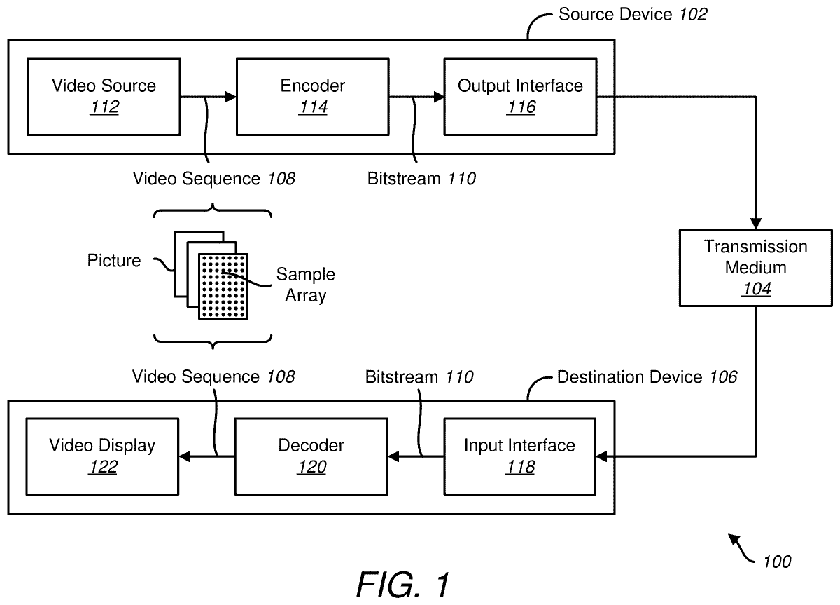

FIG. 1 shows an example video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or send/transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and/or destination device 106 may be any of a plurality of different devices (e.g., a desktop computer, laptop computer, tablet computer, smart phone, wearable device, television, camera, video gaming console, set-top box, video streaming device, etc.).

Source device 102 may comprise (e.g., for encoding video sequence 108 into bitstream 110) one or more of a video source 112, an encoder 114, and/or an output interface 116. Video source 112 may provide and/or generate video sequence 108 based on a capture of a natural scene and/or a synthetically generated scene. A synthetically generated scene may be a scene comprising computer generated graphics and/or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays (e.g., three sample arrays are used for one luma component and two chroma components, respectively) used to represent color pictures. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

Encoder 114 may encode video sequence 108 into bitstream 110. Encoder 114 may apply/use (e.g., to encode video sequence 108) one or more prediction techniques to reduce redundant information in video sequence 108. Redundant information is information that may be predicted at a decoder and need not be transmitted to the decoder for accurate decoding of video sequence 108. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Encoder 114 may partition pictures comprising video sequence 108 into rectangular regions referred to as blocks, for example, before applying one or more prediction techniques. Encoder 114 may then encode a block using the one or more of the prediction techniques.

For temporal prediction, encoder 114 may search for a block similar to the block being encoded in another picture (e.g., referred to as a reference picture) of video sequence 108. The block determined during the search (e.g., referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (e.g., also referred to as a residual) based on the difference between a block being encoded and a prediction block. The prediction error may represent non-redundant information that may be sent/transmitted to a decoder for accurate decoding of video sequence 108.

Encoder 114 may apply a transform to the prediction error (e.g. using a discrete cosine transform (DCT), or any other transform) to generate transform coefficients. Encoder 114 may form bitstream 110 based on the transform coefficients and other information used to determine prediction blocks using/based on prediction types, motion vectors, and/or prediction modes. Encoder 114 may perform one or more of quantization and entropy coding of the transform coefficients and/or the other information used to determine the prediction blocks, for example, before forming bitstream 110. The quantization and/or the entropy coding may further reduce the quantity of bits needed to store and/or transmit video sequence 108.

Output interface 116 may be configured to write and/or store bitstream 110 onto transmission medium 104 for transmission to destination device 106. In addition or alternatively, output interface 116 may be configured to send/transmit, upload, and/or stream bitstream 110 to destination device 106 via transmission medium 104. Output interface 116 may comprise a wired and/or a wireless transmitter configured to send/transmit, upload, and/or stream bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

Transmission medium 104 may comprise wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the internet) or file servers configured to store and/or send/transmit encoded video data.

Destination device 106 may decode bitstream 110 into video sequence 108 for display. Destination device 106 may comprise one or more of an input interface 118, a decoder 120, and/or a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or a wireless receiver configured to receive, download, and/or stream bitstream 110 in accordance with one or more proprietary, open-source, standardized communication protocols, and/or any other communication protocol (e.g., such as referenced herein). Decoder 120 may decode video sequence 108 from encoded bitstream 110. The decoder 120 may generate prediction blocks for pictures of video sequence 108 in a similar manner as encoder 114 and determine the prediction errors for the blocks, for example, to decode video sequence 108. Decoder 120 may generate the prediction blocks using/based on prediction types, prediction modes, and/or motion vectors received in bitstream 110. Decoder 120 may determine the prediction errors using the transform coefficients received in bitstream 110. Decoder 120 may determine the prediction errors by weighting transform basis functions using the transform coefficients. Decoder 120 may combine the prediction blocks and the prediction errors to decode video sequence 108. Video sequence 108 at the destination device 106 may be, or may not necessarily be, the same video sequence sent, such as video sequence 108 as sent by the source device 102. Decoder 120 may decode a video sequence that approximates video sequence 108, for example, because of lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, a liquid crystal display (LCD), a plasma display, a light emitting diode (LED) display, and/or any other display device suitable for displaying video sequence 108.

Video coding/decoding system 100 is merely an example and video encoding/decoding systems different from the video coding/decoding system 100 and/or modified versions of the video coding/decoding system 100 may similarly perform the methods and processes as described herein. For example, the video coding/decoding system 100 may comprise other components and/or arrangements. For example, video source 112 may be external to source device 102. Similarly, video display 122 may be external to destination device 106 or omitted altogether (e.g., if video sequence 108 is intended for consumption by a machine and/or storage device). In an example, source device 102 may further comprise a video decoder and destination device 106 may further comprise a video encoder. For example, source device 102 may be configured to further receive an encoded bitstream from destination device 106 to support two-way video transmission between the devices.

Encoder 114 and/or decoder 120 may operate according to one or more proprietary or industry video coding standards. For example, encoder 114 and/or decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC)), ITU-T H.265 and MPEG-I Part 3 (also known as Versatile Video Coding (VVC), the WebM VP8 and VP9 codecs, and/or AOMedia Video 1 (AV1), and/or any other video coding protocol).

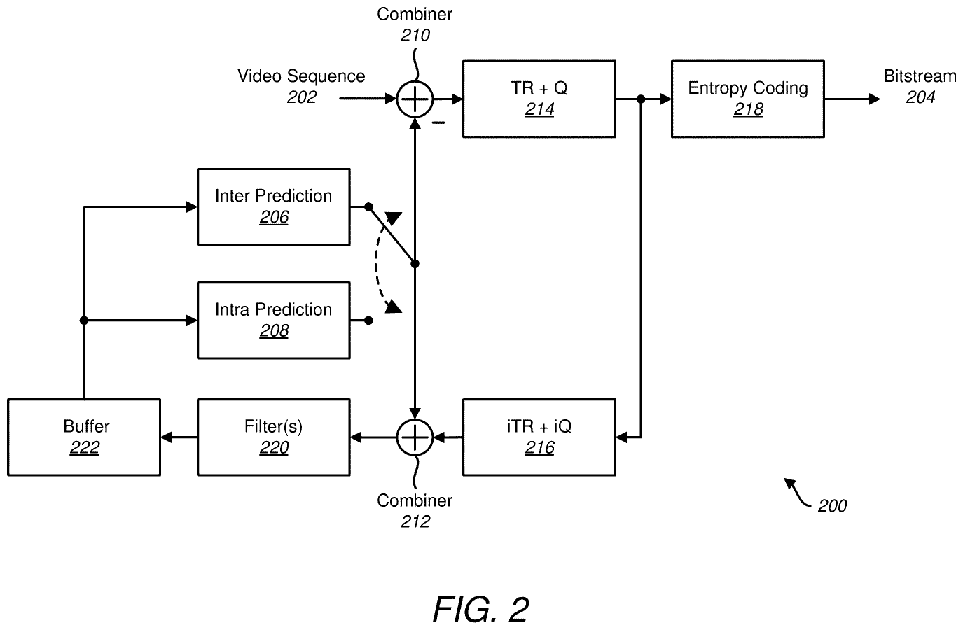

FIG. 2 shows an example encoder. Encoder 200 as shown in FIG. 2 may implement one or more processes described herein. Encoder 200 may encode a video sequence 202 into a bitstream 204 for more efficient storage and/or transmission. Encoder 200 may be implemented in video coding/decoding system 100 as shown in FIG. 1 (e.g., as encoder 114) or in any computing, communication, or electronic device (e.g., desktop computer, laptop computer, tablet computer, smart phone, wearable device, television, camera, video gaming console, set-top box, video streaming device, etc.). Encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

Encoder 200 may partition pictures (e.g., frames) of (e.g., comprising) video sequence 202 into blocks and encode video sequence 202 on a block-by-block basis. Encoder 200 may perform/apply a prediction technique on a block being encoded using either inter prediction unit 206 or intra prediction unit 208. Inter prediction unit 206 may perform inter prediction by searching for a block similar to the block being encoded in another, reconstructed picture (e.g., a reference picture) of video sequence 202. A reconstructed picture refers to a picture that was encoded and then decoded. The block determined during the search (e.g., referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion and/or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

Combiner 210 may determine a prediction error (e.g., referred to as a residual) based on the difference between the block being encoded and the prediction block. The prediction error may represent non-redundant information that may be sent/transmitted to a decoder for accurate decoding of video sequence 202.

Transform and quantization unit (TR+Q) 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. The irrelevant information refers to information that may be removed from the coefficients without producing visible and/or perceptible distortion in video sequence 202 after decoding (e.g., at a receiving device).

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form bitstream 204.

Inverse transform and quantization unit (iTR+iQ) 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block, for example, using a deblocking filter and/or a sample-adaptive offset (SAO) filter. Buffer 222 may store the reconstructed block for prediction of one or more other blocks in the same and/or different picture of video sequence 202.

Encoder 200 may further comprise an encoder control unit. The encoder control unit may be configured to control one or more units of encoder 200 as shown in FIG. 2. The encoder control unit may control the one or more units of encoder 200 such that bitstream 204 may be generated in conformance with the requirements of one or more proprietary coding protocols, industry video coding standards, and/or any other video cording protocol. For example, the encoder control unit may control the one or more units of encoder 200 such that bitstream 204 may be generated in conformance with one or more of ITU-T H.263, AVC, HEVC, VVC, VP8, VP9, AV1, and/or any other video coding standard/format.

The encoder control unit may be configured to attempt to minimize (or reduce) the bitrate of bitstream 204 and/or maximize (or increase) the reconstructed video quality (e.g., within the constraints of a proprietary coding protocol, industry video coding standard, and/or any other video cording protocol). For example, the encoder control unit may be configured to attempt to minimize or reduce the bitrate of bitstream 204 such that the reconstructed video quality does not fall below a certain level/threshold, and/or to maximize or increase the reconstructed video quality such that the bitrate of bitstream 204 does not exceed a certain level/threshold. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and/or one or more transform types and/or quantization parameters applied by transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to entropy coding unit 218 to be further compressed (e.g., to reduce the bitrate). For example, entropy coding unit 218 may apply context adaptive variable length coding (CAVLC), context adaptive binary arithmetic coding (CABAC), and/or syntax-based context-based binary arithmetic coding (SBAC) to achieve further compression. The prediction type, prediction information, and/or transform and/or quantization parameters may be packed with the prediction error to form bitstream 204.

Encoder 200 is merely an example and encoders different from encoder 200 and/or modified versions of encoder 200 may perform the methods and processes as described herein. For example, encoder 200 may comprise other components and/or arrangements. One or more of the components shown in FIG. 2 may be optionally included in encoder 200 (e.g., entropy coding unit 218 and/or filters(s) 220).

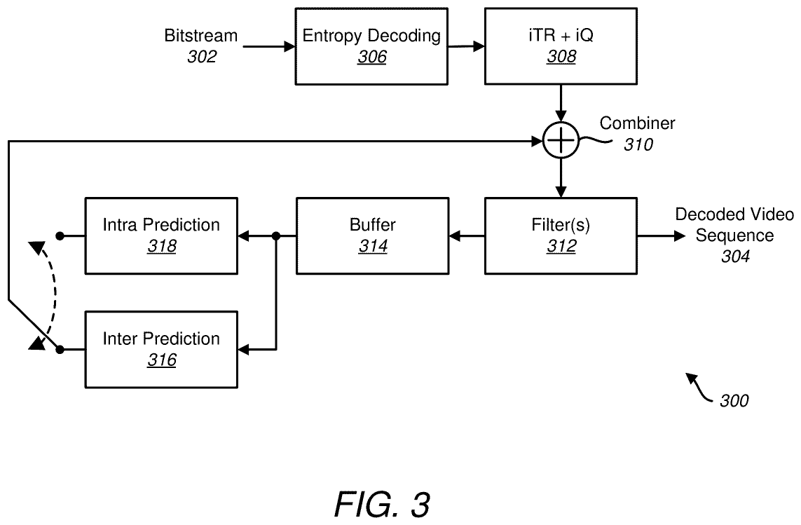

FIG. 3 shows an example decoder. A decoder 300 as shown in FIG. 3 may implement one or more processes described herein. Decoder 300 may decode a bitstream 302 into a decoded video sequence 304 for display and/or some other form of consumption. Decoder 300 may be implemented in video coding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). Decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318. Decoder 300 may comprise a decoder control unit configured to control one or more units of decoder 300. The decoder control unit may control the one or more units of decoder 300 such that bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and/or one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and/or inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 (e.g., as described above with respect to encoder 200 in FIG. 2). Filter(s) 312 may filter the decoded block, for example, using a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

Decoder 300 is merely an example and decoders different from decoder 300 and/or modified versions of decoder 300 may perform the methods and processes as described herein. For example, decoder 300 may have other components and/or arrangements. One or more of the components shown in FIG. 3 may be optionally included in decoder 300 (e.g., entropy decoding unit 306 and/or filters(s) 312).

Although not shown in FIGS. 2 and 3, each of encoder 200 and decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2n×2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. For transformations, a CB may be partitioned into one or more transform blocks (TBs). A TB may be a rectangular block of samples that may determine/indicate an applied transform size.

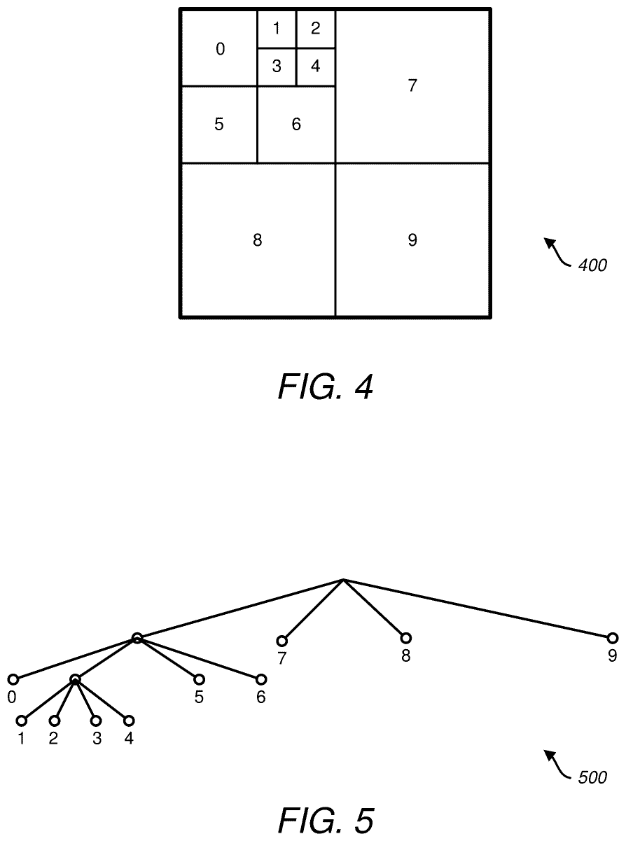

FIG. 4 shows an example quadtree partitioning of a CTB 400. FIG. 5 shows an example quadtree 500 corresponding to the example quadtree partitioning of CTB 400 in FIG. 4. As shown in the examples of FIGS. 4 and 5, CTB 400 may first be partitioned into four CBs of half vertical and half horizontal size. Three of the resulting CBs of the first level partitioning of CTB 400 are leaf CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, The non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

The example CTB 400 of FIG. 4 is partitioned into 10 leaf CBs respectively labeled 0-9, but may be partitioned into other quantities of leaf CBs. The 10 leaf CBs may correspond to 10 CB leaf nodes (e.g., 10 CB leaf nodes of quadtree 500 as shown in FIG. 5). In other examples, a CTB may be partitioned into a different number of leaf CBs. The resulting quadtree partitioning of CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBs.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in VVC) may be further partitioned by a binary tree or ternary tree partitioning (or any other partitioning) into CBs of unequal sizes.

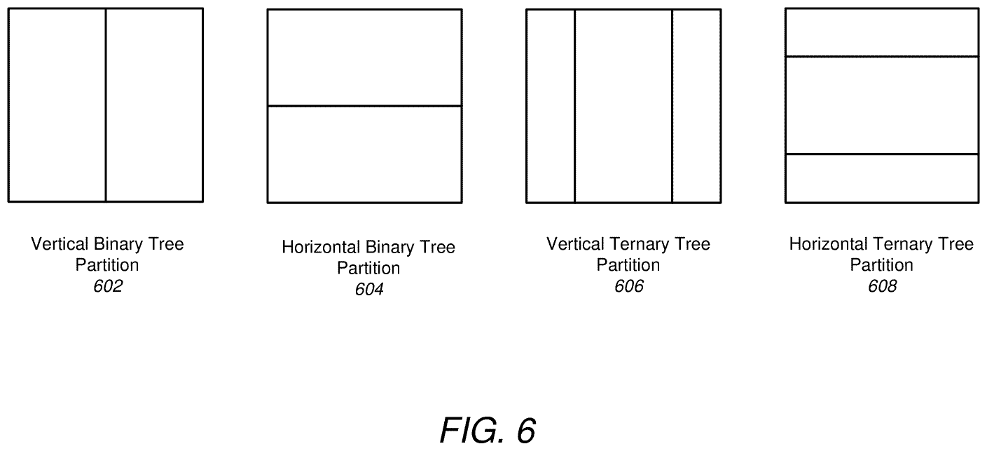

FIG. 6 shows example binary tree and ternary tree partitions. A binary tree partition may divide a parent block in half in either a vertical direction 602 or a horizontal direction 604. The resulting partitions may be half in size as compared to the parent block. In other examples, the resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

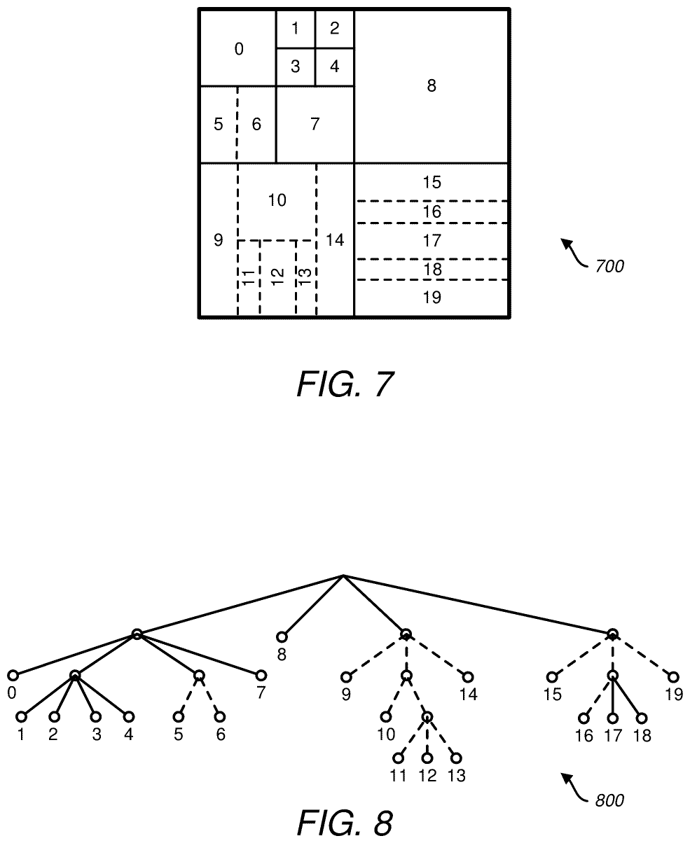

FIG. 7 shows an example of combined quadtree and multi-type tree partitioning of a CTB 700. FIG. 8 shows an example tree 800 corresponding to the combined quadtree and multi-type tree partitioning of CTB 700 shown in FIG. 7. In both FIGS. 7 and 8, quadtree splits are shown in solid lines and multi-type tree splits are shown in dashed lines. For ease of explanation, CTB 700 is shown with the same quadtree partitioning as the CTB 400 described in FIG. 4, and a description of the quadtree partitioning of CTB 700, which is similar to that for CTB 400, is omitted. The quadtree partitioning of the CTB 700 is merely an example and a CTB may be quadtree partitioned in a manner different from the CTB 700. Additional multi-type tree partitions of CTB 700 may be made relative to three leaf CBs shown in FIG. 4. The three leaf CBs in FIG. 4 that are shown in FIG. 7 as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7 and 8. The leaf CB 8 of FIG. 4 may be partitioned into three CBs based on a vertical ternary tree partition. Two of the three resulting CBs may be leaf CBs respectively labeled 9 and 14 in FIGS. 7 and 8. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBs respectively labeled 11, 12, and 13 in FIGS. 7 and 8. The leaf CB 9 of FIG. 4 may be partitioned into three CBs based on a horizontal ternary tree partition. Two of the three CBs may be leaf CBs respectively labeled 15 and 19 in FIGS. 7 and 8. The remaining, non-leaf CB may be partitioned into three CBs based on another horizontal ternary tree partition. The resulting three CBs may all be leaf CBs respectively labeled 16, 17, and 18 in FIGS. 7 and 8.

Altogether, CTB 700 may be partitioned into 20 leaf CBs respectively labeled 0-19. The 20 leaf CBs may correspond to 20 leaf nodes (e.g., 20 leaf nodes of tree 800 shown in FIG. 8). The resulting combination of quadtree and multi-type tree partitioning of the CTB 700 may be scanned using a z-scan (left-to-right, top-to-bottom) to form the sequence order for encoding/decoding the CB leaf nodes. A numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and/or TBs.

A coding standard/format (e.g., HEVC, VVC, or any other coding standard/format) may define various units (e.g., in addition to specifying various blocks (e.g., CTBs, CBs, PBs, TBs)). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

A block may refer to any of a CTB, CB, PB, TB, CTU, CU, PU, and/or TU (e.g., in the context of HEVC, VVC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block in the AV1 coding format.

In intra prediction, samples of a block to be encoded (e.g., also referred to as a current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., referred to as a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

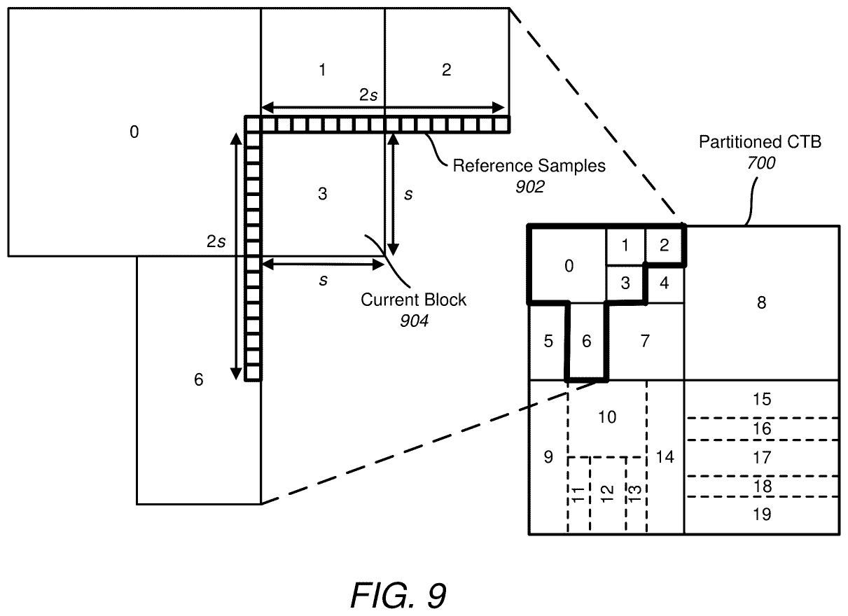

FIG. 9 shows an example set of reference samples 902 determined for intra prediction of a current block 904. Current block 904 may correspond to a block being encoded and/or decoded. Current block 904 may correspond to block 3 of partitioned CTB 700 as shown in FIG. 7. As described herein, the numeric labels 0-19 of the blocks of partitioned CTB 700 may correspond to the sequence order for encoding/decoding the blocks and may be used as such in the example of FIG. 9.

For current block 904 that is w×h samples in size, reference samples 902 may comprise: 2w samples (or any other quantity of samples) of the row immediately adjacent to the top-most row of current block 904, 2h samples (or any other quantity of samples) of the column immediately adjacent to the left-most column of current block 904, and the top left neighboring corner sample to current block 904. Current block 904 may be square, such that w=h=s. In other examples, a current block need not be square, such that w≠h. Available samples from neighboring blocks of current block 904 may be used for constructing the set of reference samples 902. Samples may not be available for constructing the set of reference samples 902, for example, if the samples lie outside the picture of the current block, the samples are part of a different slice of the current block (e.g., if the concept of slices is used), and/or the samples belong to blocks that have been inter coded and constrained intra prediction is indicated. Intra prediction may not be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. In the example of FIG. 9, samples from neighboring blocks 0, 1, and 2 may be available to construct reference samples 902 given that these blocks are encoded and reconstructed at an encoder and decoded at a decoder prior to coding of current block 904. The samples from neighboring blocks 0, 1, and 2 may be available to construct reference samples 902, for example, if there are no other issues (e.g., as mentioned above) preventing the availability of the samples from the neighboring blocks 0, 1, and 2. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

In some examples, unavailable samples from reference samples 902 may be filled with one or more of the available reference samples 902. For example, an unavailable reference sample may be filled with a nearest available reference sample. The nearest available reference sample may be determined by moving in a clock-wise direction through reference samples 902 from the position of the unavailable reference. The reference samples 902 may be filled with the mid-value of the dynamic range of the picture being coded, for example, if no reference samples are available.

Reference samples 902 may be filtered based on the size of current block 904 being coded and an applied intra prediction mode. FIG. 9 shows an example determination of reference samples for intra prediction of a block. Reference samples may be determined in a different manner than described above. For example, multiple reference lines may be used in other instances (e.g., in VVC).

Samples of current block 904 may be intra predicted based on reference samples 902, for example, based on (e.g., after) determination and (optionally) filtering of reference samples 902. At least some (e.g., most) encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

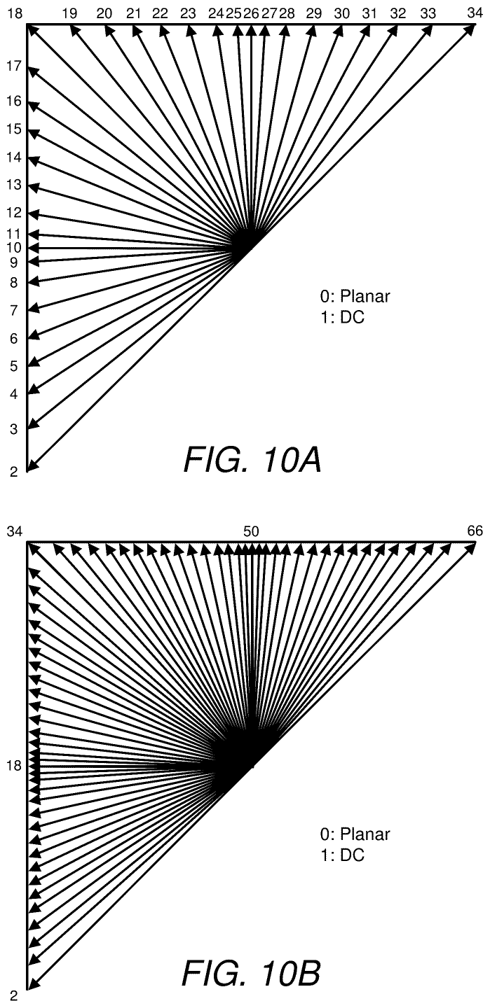

FIGS. 10A and 10B show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

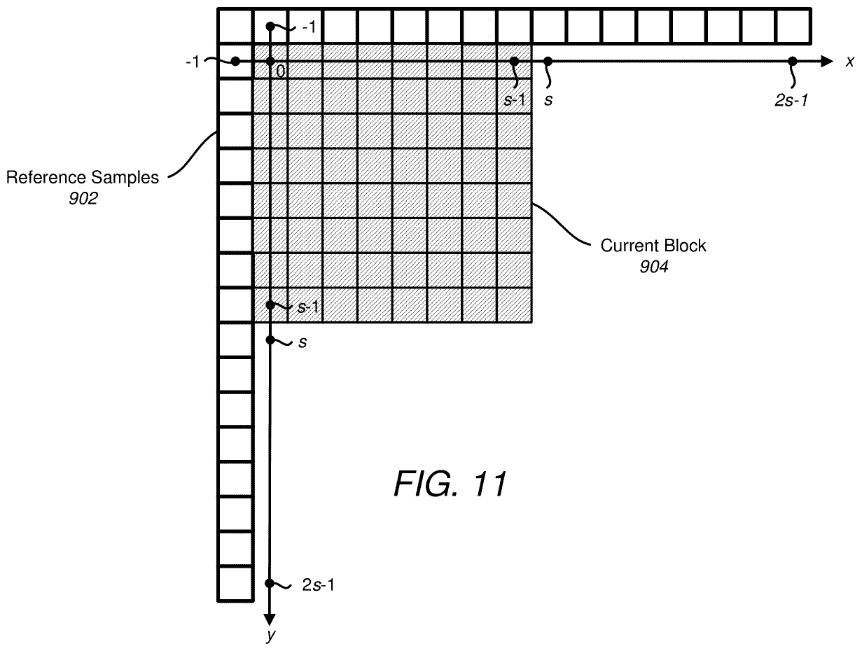

FIG. 11 shows a current block 904 and corresponding reference samples 902 from FIG. 9. To further describe how intra prediction modes are applied to determine a prediction (e.g., a prediction block) of current block 904, FIG. 11 shows current block 904 and reference samples 902 in a two-dimensional x, y plane, where a sample may be referenced as p[x][y]. To simplify the prediction process, reference samples 902 may be placed in two, one-dimensional arrays. The reference samples 902, above the current block 904, may be placed in the one-dimensional array ref₁[x]:

$$r e {f}_{1} [ x ] = p [ - 1 + x ] [ - 1 ] , ( x \geq 0 ) . \qquad ( 1 )$$

The reference samples 902 to the left of current block 904 may be placed in the one-dimensional array ref₂[y]:

$$r e {f}_{2} [ y ] = p [ - 1 ] [ - 1 + y ] , ( y \geq 0 ) . \qquad ( 2 )$$

The prediction process may comprise determination of a predicted sample p[x][y] (e.g., a predicted value) at a location [x][y] in current block 904. For planar mode, a sample at the location [x][y] in current block 904 may be predicted by determining/calculating the mean of two interpolated values. The first of the two interpolated values may be based on a horizontal linear interpolation at the location [x][y] in current block 904. The second of the two interpolated values may be based on a vertical linear interpolation at location [x][y] in current block 904. The predicted sample p[x][y] in current block 904 may be determined/calculated as:

$$p [ x ] [ y ] = \frac{1}{2 \cdot s} ( h [ x ] [ y ] + v [ x ] [ y ] + s ) , \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizontal linear interpolation at the location [x][y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at the location [x][y] in current block 904. s may be equal to a length of a side (e.g., a number of samples on a side) of the current block 904.

For DC mode, a sample at a location [x][y] in current block 904 may be predicted by the mean of the reference samples 902. The predicted sample p[x][y] in current block 904 may be determined/calculated as:

$$p [ x ] [ y ] = \frac{1}{2 \cdot s} ( {\sum }_{x = 0}^{s - 1} r e {f}_{1} [ x ] + {\sum }_{y = 0}^{s - 1} r e {f}_{2} [ y ] ) . \qquad ( 6 )$$

For angular modes, a sample at a location [x][y] in current block 904 may be predicted by projecting the location [x][y] in a direction specified by a given angular mode to a point on the horizontal or vertical line of samples comprising reference samples 902. The sample at the location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in WVC). The direction specified by the angular mode may be given by an angle φ defined relative to the x-axis for horizontal prediction modes (e.g., modes 2-18 in HEVC and modes 2-34 in VVC).

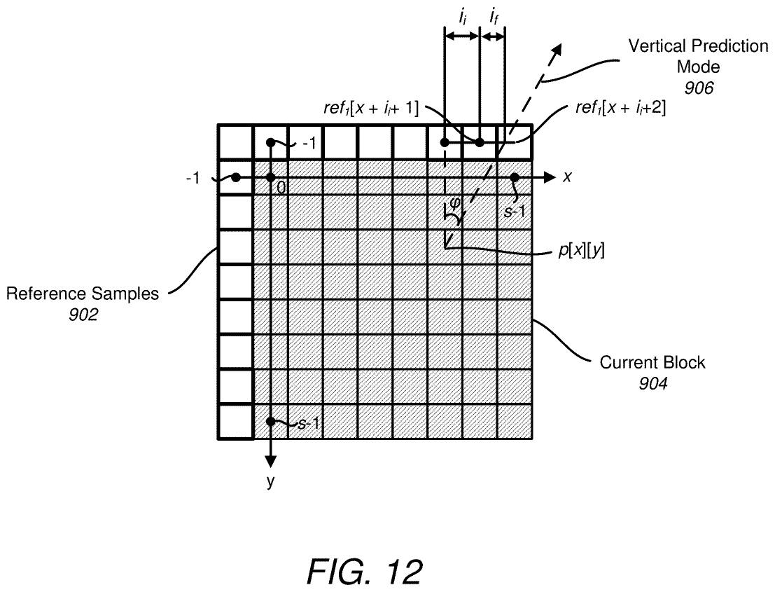

FIG. 12 shows an example applying an intra prediction mode (e.g., an angular mode such as vertical prediction mode 906) for prediction of a current block 904. FIG. 12 specifically shows prediction of a sample at a location [x][y] in current block 904 for a vertical prediction mode 906. Vertical prediction mode 906 may be given by an angle φ with respect to the vertical axis. The location [x][y] in current block 904, in vertical prediction modes, may be projected to a point (e.g., referred to as a projection point) on the horizontal line of reference samples ref₁[x]. The reference samples 902 are only partially shown in FIG. 12 for ease of illustration. As shown in FIG. 12, the projection point on the horizontal line of reference samples ref₁[x] may not be exactly on a reference sample. A predicted sample p[x][y] in current block 904 may be determined/calculated by linearly interpolating between the two reference samples, for example, if the projection point falls at a fractional sample position between two reference samples. The predicted sample p[x][y] may be determined/calculated as:

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] . \qquad ( 7 )$$

iᵢ may be the integer part of the horizontal displacement of the projection point relative to the location [x][y]. iᵢ may be determined/calculated as a function of the tangent of the angle φ of the vertical prediction mode 906 as:

$${i}_{i} = ⌊ ( y + 1 ) \cdot tan φ ⌋ . \qquad ( 8 )$$

i_{f} may be the fractional part of the horizontal displacement of the projection point relative to the location [x][y] and may be determined/calculated as:

$${i}_{f} = ( ( y + 1 ) \cdot tan φ ) - ⌊ ( y + 1 ) \cdot tan φ ⌋ , \qquad ( 9 )$$

where [.] is the integer floor function.

For horizontal prediction modes, a location [x][y] of a sample in current block 904 may be projected onto the vertical line of reference samples ref₂[y]. A predicted sample p[x][y] for horizontal prediction modes may be determined/calculated as:

$$p [ x ] [ y ] = ( 1 - {i}_{f} ) \cdot {ref}_{2} [ y + {i}_{i} + 1 ] + {i}_{f} \cdot {ref}_{2} [ y + {i}_{i} + 2 ] . \qquad ( 10 )$$

iᵢ may be the integer part of the vertical displacement of the projection point relative to the location [x][y]. iᵢ may be determined/calculated as a function of the tangent of the angle φ of the horizontal prediction mode as:

$${i}_{i} = ⌊ ( x + 1 ) \cdot tan φ ⌋ . \qquad ( 11 )$$

if may be the fractional part of the vertical displacement of the projection point relative to the location [x][y]. i_{f} may be determined/calculated as:

$${i}_{f} = ( ( x + 1 ) \cdot tan φ ) - ⌊ ( x + 1 ) \cdot tan φ ⌋ , \qquad ( 12 )$$

where [.] is the integer floor function.

The interpolation functions given by Equations (7) and (10) may be implemented by an encoder and/or a decoder (e.g., encoder 200 in FIG. 2 and/or decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1-i_{f}) and if. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters-one for each of the 32 possible values of the fractional part of the projected displacement if. In other examples, different levels of sample accuracy may be used.

In some examples, the FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four tap FIR filter may be determined based on if (e.g., similar to the two-tap FIR filter). For 1/32 sample accuracy, a set of 32 different four-tap FIR filters may comprise up to 32 different four-tap FIR filters-one for each of the 32 possible values of the fractional part of the projected displacement if. In other examples, different levels of sample accuracy may be used. The set of four-tap FIR filters may be stored in a look-up table (LUT) and referenced based on if. A predicted sample p[x][y], for vertical prediction modes, may be determined based on the four-tap FIR filter as:

$$p [ x ] [ y ] = {\sum }_{i = 0}^{3} f T [ i ] \cdot {ref}_{1} [ x + iIdx + i ] , \qquad ( 13 )$$

where fT[i], i=0 . . . 3, may be the filter coefficients, and Idx is integer displacement. A predicted sample p[x][y], for horizontal prediction modes, may be determined based on the four-tap FIR filter as:

$$p [ x ] [ y ] = {\sum }_{i = 0}^{3} f T [ i ] \cdot {ref}_{2} [ y + iIdx + i ] . \qquad ( 14 )$$

Supplementary reference samples may be determined/constructed if the location [x][y] of a sample in current block 904 to be predicted is projected to a negative x coordinate. The location [x][y] of a sample may be projected to a negative x coordinate, for example, if negative vertical prediction angles φ are used. The supplementary reference samples may be determined/constructed by projecting the reference samples in ref₂[y] in the vertical line of reference samples 902 to the horizontal line of reference samples 902 using the negative vertical prediction angle φ. Supplementary reference samples may be similarly determined/constructed, for example, if the location [x][y] of a sample in current block 904 to be predicted is projected to a negative y coordinate. The location [x][y] of a sample may be projected to a negative y coordinate, for example, if negative horizontal prediction angles φ are used. The supplementary reference samples may be determined/constructed by projecting the reference samples in ref₁[x] on the horizontal line of reference samples 902 to the vertical line of reference samples 902 using the negative horizontal prediction angle φ.

An encoder may determine/predict samples of a current block being encoded (e.g., current block 904) for a plurality of intra prediction modes (e.g., using one or more of the functions described herein). For example, an encoder may determine/predict samples of a current block for each of 35 intra prediction modes in HEVC and/or 67 intra prediction modes in VVC. The encoder may determine, for each intra prediction mode applied, a corresponding prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. In some examples, the encoder may determine/select the intra prediction mode to encode the current block based on a rate-distortion measure (e.g., Lagrangian rate-distortion cost) determined using the prediction errors. The encoder may send an indication of the determined/selected intra prediction mode and its corresponding prediction error (e.g., residual) to a decoder for decoding of the current block.

A decoder may determine/predict samples of a current block being decoded (e.g., current block 904) for an intra prediction mode. For example, a decoder may receive an indication of an intra prediction mode (e.g., an angular intra prediction mode) from an encoder for a current block. The decoder may construct a set of reference samples and perform intra prediction based on the intra prediction mode indicated by the encoder for the current block in a similar manner (e.g., as described above for the encoder). The decoder may add predicted values of the samples (e.g., determined based on the intra prediction mode) of the current block to a residual of the current block to reconstruct the current block. In some examples, a decoder need not receive an indication of an angular intra prediction mode from an encoder for a current block. Instead, the decoder may determine an intra prediction mode through other, decoder-side means.

While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

Similar to intra prediction, an encoder may determine a difference between a current block and a prediction for a current block. An encoder may determine a difference, for example, based on/after determining/generating a prediction for a current block (e.g., using inter prediction). The difference may be a prediction error (e.g., a residual). The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

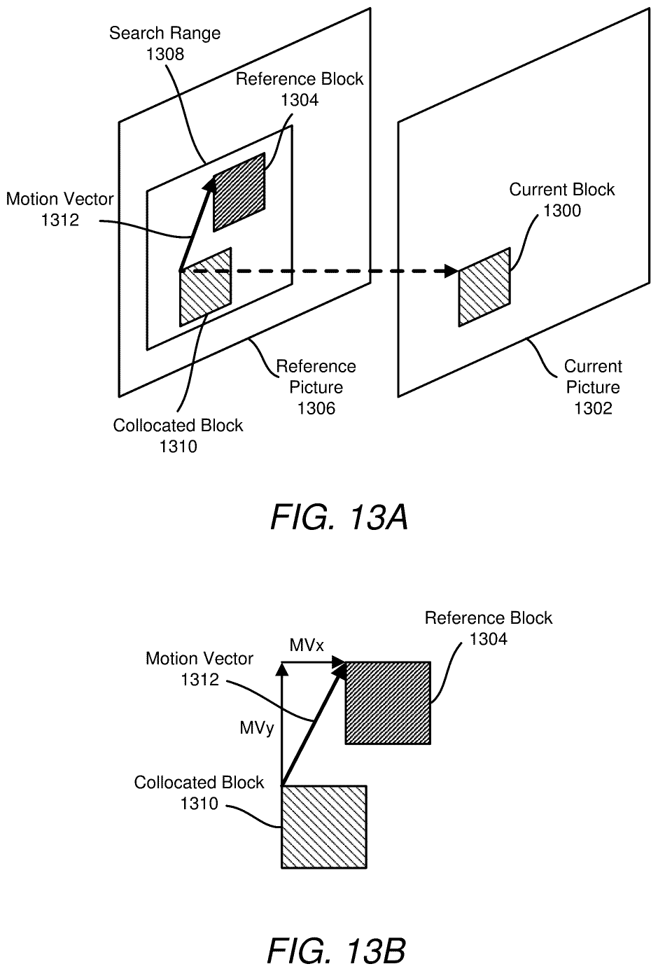

FIG. 13A shows an example of inter prediction. The inter prediction may be performed for a current block 1300 in a current picture 1302 being encoded. An encoder (e.g., encoder 200 as shown in FIG. 2) may perform inter prediction to determine and/or generate a reference block 1304 in a reference picture 1306. Reference block 1304 may be used to predict the current block 1300. Reference pictures (e.g., reference picture 1306) may be prior decoded pictures available at the encoder and/or a decoder. Availability of a prior decoded picture may depend/be based on whether the prior decoded picture is available in a decoded picture buffer, at the time, current block 1300 is being encoded and/or decoded. The encoder may search the one or more reference pictures 1306 for a block (e.g., a candidate reference block) that is similar (or substantially similar) to current block 1300. The encoder may determine the best matching block from the blocks (e.g., candidate reference blocks) tested during the searching process. The best matching block may be a reference block 1304. The encoder may determine that reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of reference block 1304 and original samples of current block 1300.

The encoder may search for reference block 1304 within a reference region (e.g., a search range 1308). The reference region (e.g., a search range 1308) may be positioned around a collocated block (or position) 1310, of current block 1300, in reference picture 1306. Collocated block 1310 may have a same position in the reference picture 1306 as the current block 1300 in the current picture 1302. The reference region (e.g., search range 1308) may at least partially extend outside of reference picture 1306. Constant boundary extension may be used, for example, if the reference region (e.g., search range 1308) extends outside of reference picture 1306. The constant boundary extension may be used such that values of the samples in a row or a column of reference picture 1306, immediately adjacent to a portion of the reference region (e.g., search range 1308) extending outside of reference picture 1306, may be used for sample locations outside of reference picture 1306. A subset of potential positions, or all potential positions, within the reference region (e.g., search range 1308) may be searched for reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of reference block 1304 may be indicated by a reference index pointing into a reference picture list comprising reference picture 1306.

FIG. 13B shows an example motion vector. A displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. A motion vector (e.g., motion vector 1312) may have fractional or integer resolution. A motion vector with fractional resolution may point between two samples in a reference picture to provide a better estimation of the motion of current block 1300. For example, a motion vector may have ½, ¼, ⅛, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between reference block 1304 and current block 1300. The encoder may determine the difference between reference block 1304 and current block 1300, for example, based on/after reference block 1304 is determined and/or generated, using inter prediction, for current block 1300. The difference may be a prediction error (e.g., a residual). The encoder may store and/or send (e.g., signal), in/via a bitstream, the prediction error and/or related motion information. The prediction error and/or the related motion information may be used for decoding (e.g., decoding current block 1300) and/or other forms of consumption. The motion information may comprise the motion vector 1312 and a reference indicator/index. The reference indicator may indicate the reference picture 1306 in a reference picture list. In other examples, the motion information may comprise an indication of motion vector 1312 and/or an indication of the reference indicator/index. The reference indicator may indicate reference picture 1306 in the reference picture list comprising reference picture 1306. A decoder may decode current block 1300 by determining and/or generating the reference block 1304, which may correspond to/form (e.g., be considered as) a prediction of the current block 1300. The decoder may determine and/or generate the reference block 1304, for example, based on the related motion information. The decoder may decode current block 1300 based on combining the prediction (e.g., a reference block) with the prediction error (e.g., a residual block).

Inter prediction, as shown in FIG. 13A, may be performed using one reference picture 1306 as a source of a prediction for current block 1300. Inter prediction based on a prediction of a current block using a single picture may be referred to as uni-prediction.

Inter prediction of a current block, using bi-prediction, may be based on two pictures (e.g., the source of prediction may be from the two pictures). Bi-prediction may be useful, for example, if a video sequence comprises fast motion, camera panning, zooming, and/or scene changes. Bi-prediction also may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction and/or bi-prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

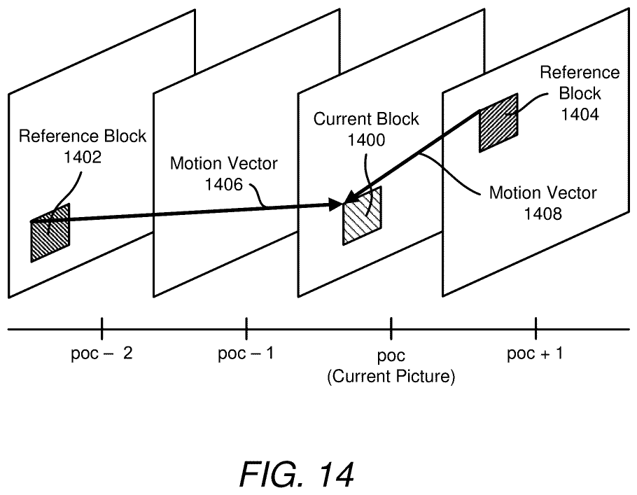

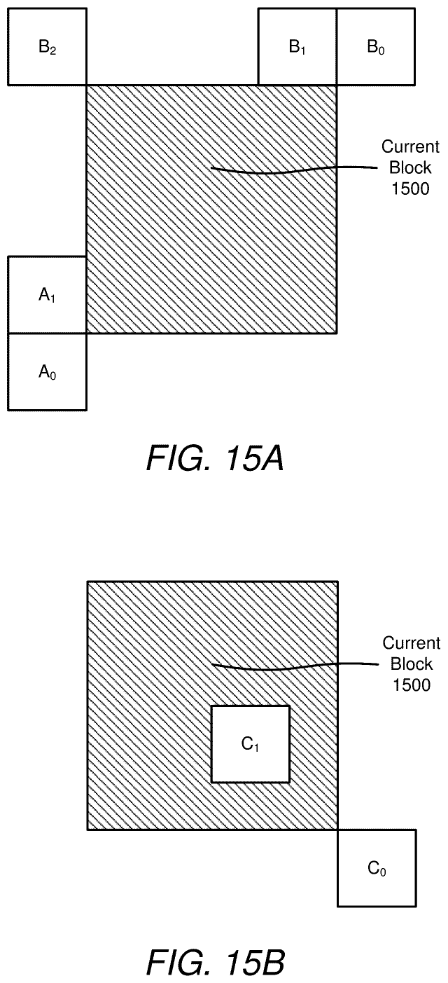

FIG. 14 shows an example of bi-prediction. Two reference blocks 1402 and 1404 may be used to predict a current block 1400. Reference block 1402 may be in a reference picture of one of reference picture list 0 or reference picture list 1. Reference block 1404 may be in a reference picture of another one of reference picture list 0 or reference picture list 1. As shown in FIG. 14, reference block 1402 may be in a first picture that precedes (e.g., in time) a current picture of current block 1400, and the reference block 1404 may be in a second picture that succeeds (e.g., in time) the current picture of current block 1400. The first picture may precede the current picture in terms of a picture order count (POC). The second picture may succeed the current picture in terms of the POC. In other examples, the reference pictures may both precede or both succeed the current picture in terms of POC. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS). The encoder may send/signal the weight and/or offset parameters in a slice segment header for current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between current block 1400 and each of reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption.

The motion information for reference block 1402 may comprise a motion vector 1406 and/or a reference indicator/index. The reference indicator may indicate a reference picture, of the reference block 1402, in a reference picture list. In some examples, the motion information for reference block 1402 may comprise an indication of motion vector 1406 and/or an indication of the reference index. The reference index may indicate the reference picture, of reference block 1402, in the reference picture list.

The motion information for reference block 1404 may comprise a motion vector 1408 and/or a reference index/indicator. The reference indicator may indicate a reference picture, of the reference block 1404, in a reference picture list. The motion information for reference block 1404 may comprise an indication of motion vector 1408 and/or an indication of the reference index. The reference index may indicate the reference picture, of the reference block 1404, in the reference picture list.

A decoder may decode current block 1400 by determining and/or generating the reference blocks 1402 and 1404. The decoder may determine and/or generate the reference blocks 1402 and 1404, for example, based on the respective related motion information for the reference blocks 1402 and 1404. The reference blocks 1402 and 1404 may correspond to/form (e.g., be considered as) the prediction (e.g., used to generate a prediction block) of the current block 1400. The decoder may decode the current block 1400 based on combining the prediction with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques (such as those in HEVC and VVC) may comprise advanced motion vector prediction (AMVP) and/or inter prediction block merging (e.g., merge mode).

An encoder (e.g., encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may reciprocally generate and/or determine the list of candidate MVPs.

The encoder may determine/select an MVP from the list of candidate MVPs. Then, the encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector (e.g., comprising a horizontal component (MVx) and a vertical component (MVy) that indicates a position relative to a position of the current block being coded, the MVD may be represented by two components MVDₓ and MVD_{y}. MVDₓ and MVD_{y} may be determined/calculated as:

$$M V {D}_{x} = M {V}_{x} - M V {P}_{x} \qquad ( 15 )$$

$$MV {D}_{y} = M {V}_{y} - M V {P}_{y} . \qquad ( 16 )$$

MVDx and MVDy may respectively represent horizontal and vertical components of the MVD. MVPx and MVPy may respectively represent horizontal and vertical components of the MVP.

A decoder (e.g., decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block (e.g., a prediction block). The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., if both of the two spatial candidate MVPs are not available or are identical); and/or zero motion vector candidate MVPs (e.g., if one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

FIG. 15A shows example spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to current block 1500 being coded. The two temporal, co-located blocks may be C0 and C1. The two temporal, co-located blocks may be in one or more reference pictures that may be different from the current picture of current block 1500.

An encoder (e.g., encoder 200 as shown in FIG. 2) may code a motion vector using inter prediction block merging (e.g., a merge mode). For example, the encoder (e.g., using merge mode) may reuse the same motion information of a neighboring block (e.g., one of neighboring blocks A0, A1, B0, B1, and B2) for inter prediction of a current block. For example, the encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may reciprocally generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bitstream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. In some examples, the spatial neighboring blocks and the temporal, co-located blocks used for merge mode may be the same as the spatial neighboring blocks and the temporal, co-located blocks used for AMVP.

Inter prediction may be performed in other ways and variants than those described herein. For example, motion information prediction techniques other than AMVP and merge mode may be used. While various examples herein correspond to inter prediction modes, such as used in HEVC and VVC, the methods, devices, and systems as described herein may be applied to/used for other inter prediction modes (e.g., as used for other video coding standards/formats such as VP8, VP9, AV1, etc.). History based motion vector prediction (HMVP), combined intra/inter prediction mode (CIIP), and/or merge mode with motion vector difference (MMVD) (e.g., as described in VVC) may be performed/used and are within the scope of the present disclosure.

A block matching operation (or technique) may be applied/used (e.g., in inter prediction) to determine a reference block in a different picture than that of a current block being coded (e.g., encoded and/or decoded). A block matching operation also may be applied/used to determine a reference block in a same picture as that of a current block being coded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, VVC, and/or any other coding standards/formats/protocols) to exploit correlation between blocks of samples within a same picture (e.g., of screen content videos). The prediction technique may be intra block copy (IBC) or current picture referencing (CPR). An encoder may apply/use a block matching technique (e.g., similar to inter prediction) to determine a displacement vector (e.g., a block vector (BV)). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples (e.g., reconstructed samples) of the current picture. The reference block may comprise decoded blocks of samples of the current picture prior to being processed by in-loop filtering operations (e.g., deblocking and/or SAO filtering).

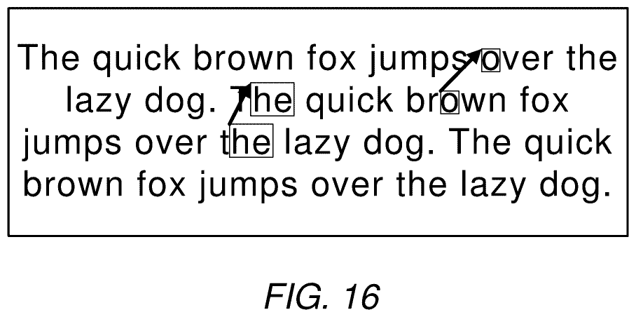

FIG. 16 shows an example of IBC (e.g., an IBC mode). The example shown in FIG. 16 may correspond to screen content. The rectangular portions/sections with arrows beginning at their boundaries may be the current blocks being encoded. The rectangular portions/sections that the arrows point to may be the reference blocks for predicting the respective current blocks.

A reference block may be determined and/or generated, for a current block, using IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction (e.g., a prediction block) of the current block. The decoder may decode the current block by combining the prediction (e.g., prediction block) with the prediction error (e.g., residual or residual block).

A BV may be predictively coded (e.g., in HEVC, VVC, and/or any other coding standards/formats/protocols) before being stored and/or sent/signaled in/via a bitstream. For example, the BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may reciprocally generate or determine the list of candidate BVPs.

The encoder may send/signal, in/via a bitstream, an indication of the selected BVP and a block vector difference (BVD). The encoder may indicate the selected BVP in the bitstream using an index/indicator. The index may indicate (e.g., point to) the selected BVP in the list of candidate BVPs. The BVD may be determined/calculated based on a difference between a BV of the current block and the selected BVP. For example, for a BV (e.g., represented by a horizontal component (BVx) and a vertical component (BVy)) that indicates a position relative to a position of the current block being coded, the BVD may be represented by two components BVDₓ and BVD_{y}. BVDₓ and BVD_{y} may be determined/calculated as:

$$B V {D}_{x} = B {V}_{x} - B V {P}_{x} , \qquad ( 17 )$$

$$BV {D}_{y} = B {V}_{y} - {BVP}_{y} . \qquad ( 18 )$$

BVDx and BVDy may respectively represent horizontal and vertical components of the BVD. BVPx and BVPy may respectively represent horizontal and vertical components of the BVP. A decoder (e.g., decoder 300 as shown in FIG. 3), may decode the BV by adding the BVD to the BVP indicated in/via the bitstream. The decoder may decode the current block by determining and/or generating the reference block. The decoder may determine and/or generate the reference block, for example, based on the decoded BV. The reference block may correspond to/form (e.g., be considered as) the prediction (e.g., a prediction block) of the current block. The decoder may decode the current block by combining the prediction (e.g., the prediction block) with the prediction error (e.g., residual or residual block).

A same BV as that of a neighboring block may be used for the current block and a BVD need not be separately signaled/sent for the current block, such as in the merge mode. A BVP (in the candidate BVPs), which may correspond to a decoded BV of the neighboring block, may itself be used as a BV for the current block. Not sending the BVD may reduce the signaling overhead.

A list of candidate BVPs (e.g., in HEVC, VVC, and/or any other coding standard/format/protocol) may comprise two (or more) candidates. The candidates may comprise candidates A and B. Candidates A and B may comprise: up to two (or any other quantity of) spatial candidate BVPs determined/derived from five (or any other quantity of) spatial neighboring blocks of a current block being encoded; and/or one or more of last two (or any other quantity of) coded BVs (e.g., if spatial neighboring candidates are not available). Spatial neighboring candidates may not be available, for example, if neighboring blocks are encoded using intra prediction or inter prediction. Locations of the spatial candidate neighboring blocks, relative to a current block, being encoded using IBC may be illustrated in a manner similar to spatial candidate neighboring blocks used for coding motion vectors in inter prediction (e.g., as shown in FIG. 15A). For example, five spatial candidate neighboring blocks of a current block being coded using IBC may be respectively denoted A0, A1, B0, B1, and B2 as shown in FIG. 15A.

Local illumination compensation (LIC) is a prediction technique proposed for reducing prediction errors of prediction blocks generated for coding blocks (e.g., a current block). LIC models illumination variation between a current block and its reference block as a function of illumination variation between a current block template and a reference block template. The parameters of the LIC model (e.g., LIC function) are denoted by a scale α and an offset β, to form the linear equation (19) (shown below) that is used to compensate illumination variations in the reference block. P_{ref} is a sample (e.g., a reference sample) in the reference block pointed to by a displacement vector (motion vector (MV)) in inter prediction. P_{pred} is a predicted samples corresponding to the reference sample (P_{ref}) being filtered, e.g., in accordance with illumination variation modeled by the parameters scale α and offset β.

$${P}_{p r e d} = α * {P}_{r e f} - β \qquad ( 19 )$$

The parameters α and β (e.g., also referred to as coefficients) are derived based on a template associated with the current block (referred to as current block template or current template) and a corresponding template associated with the reference block (referred to as reference block template or reference template). Consequently, LIC incurs no additional signaling overhead, other than for an LIC flag that may be signaled to indicate the use of LIC.

The application of LIC to the reference block associated with a current block comprises adjusting reference samples by multiplying the reference samples (respectively the values of the samples) with α (respectively with a value of α) and adding β (respectively a value of β) in accordance with the above-described linear equation (19) for compensating for local illumination differences. The parameters α and β are derived from samples in the templates of the current block and the reference block to reduce differences between samples of the current template and filtered samples of the reference template. For example, a least mean squares method may be used to select (e.g., determine or derive) the parameters to reduce the differences, but other methods such as SAD, SATD, SSE, etc. may be used as well. The parameters α and β can be derived using all, a subset, or subsets of samples in the templates.

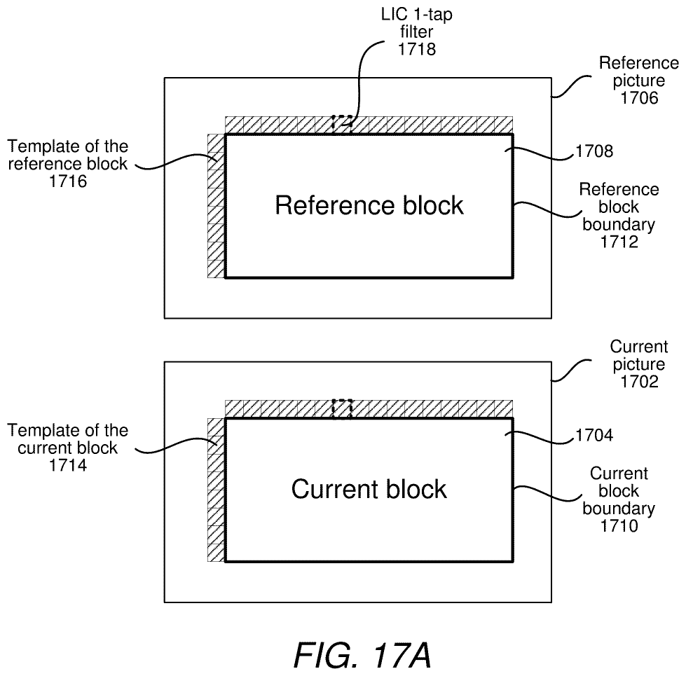

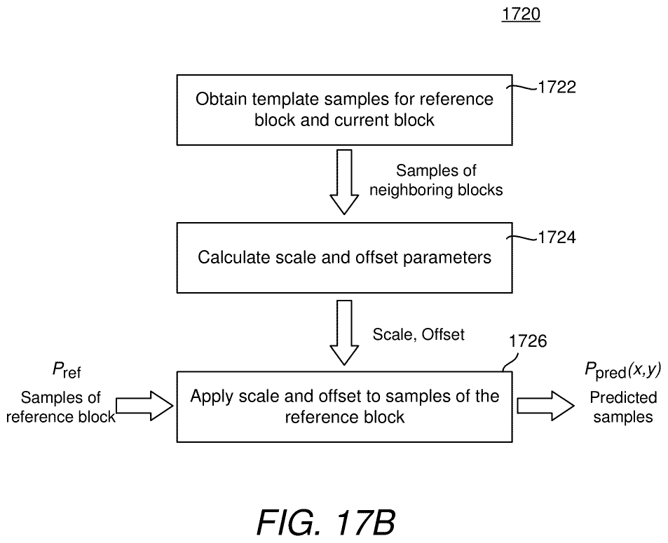

FIG. 17A shows an example of a current block and a reference block with their corresponding templates that are used in determining α and β for LIC for inter prediction. A current block 1704 is shown in a current picture 1702 and a reference block 1708 is shown in a reference picture 1706. In an example sequence of pictures, the current block 1704 may correspond to the current block 1400 shown in FIG. 14 and the reference block 1708 may correspond to either reference block 1402 or reference block 1404. Corresponding templates 1714 and 1716 are shown in relation to the current block 1704 and reference block 1708, respectively. The current template 1714 comprises neighboring samples adjacent to the current block boundary (current block border) 1710 at the left edge and the top edge of the current block 1704. The length of the current template 1714 is the sum of the lengths of the left column and the top row of samples in the current block 1704. The reference template 1716 comprises neighboring samples adjacent to the reference block boundary (reference block border) 1712 at the left edge and the top edge of the reference block 1708. The length of the reference template 1716 is the sum of the lengths of the left column and the top row of samples in the reference block 1708. The templates 1714 and 1716 have a height of 1 sample (i.e., the left portion of each template 1714 and 1716 is a singe column of samples, and the top portion of each template 1714 and 1716 is a single row of samples).

The scale parameter, α, can be determined by:

$$scale = \frac{n Σ {T}_{r e f} ( i ) {T}_{r e c} ( i ) - Σ {T}_{r e f} ( i ) Σ {T}_{r e c} ( i )}{n Σ {T}_{r e f}^{2} ( i ) - {( Σ {T}_{r e f} ( i ) )}^{2}} . \qquad ( 20 )$$

The offset parameter, β, can be determined by

$$offset = \frac{Σ {T}_{r e c} ( i ) - scale \cdot Σ {T}_{r e f} ( i )}{n} . \qquad ( 21 )$$

In the above two equations (20) and (21), n is the number of samples, T_{rec}(i) is the i^{th} sample of the current template (as noted above, the current template is the template of the current block), and T_{ref}(i) is the i^{th} sample of the reference template (as noted above, the reference template is the template of the reference block). The current block may also be referred to as the reconstructed block when decoded by the decoder. It will be noted that when the current block 1704 is yet to be reconstructed, the neighboring blocks (to which the samples of the current template 1714 belong) adjacent to the left edge and the top edge of the current block 1704 have been reconstructed. Samples of reference template 1716 and current template 1714 are reconstructed samples of reference picture 1706 and current picture 1702, respectively.

FIG. 17B shows a method 1720 to generate (e.g., calculate) a prediction block when performing inter prediction using LIC. The method 1720 may be performed at an encoder (e.g., encoder 200 of FIG. 2) and/or a decoder (e.g., decoder 300 of FIG. 3).

At operation 1722, template samples for the current block and the reference block are obtained. LIC uses a one-tap filter model 1718 to sample templates 1714 and 1716. The one-tap filter model 1718 is used to obtain each respective template sample i from the same relative position in the two templates 1714 and 1716.

At operation 1724, the template samples (e.g., neighbor samples of the reference block and the current block) are used in the equation (20) to calculate the scale parameter. In some implementations, as shown above in equation (21), the offset parameter is calculated using the calculated scale parameter. Accordingly, an LIC filter may be determined that corresponds to the one-tap LIC model with the calculated scale and offset parameters.

In some examples, after scale α and offset β parameters are determined by applying the one-tap filter model 1718 to the current template 1714 and the reference template 1716, at operation 1726, they (i.e., scale α and offset β) are applied to respective reference samples P_{ref} to obtain prediction samples P_{pred} (samples of the prediction block) in accordance with the equation (19) shown above.

When method 1720 is used at an encoder, the thus determined prediction block may be subtracted from the current block to obtain the prediction errors (e.g., residual or a residual block) that are subsequently encoded in a bitstream. When method 1720 is used at a decoder, the prediction error received in the bitstream may be added to the thus determined prediction block to obtain the current block. The prediction block determined based on LIC may have improved illumination variation relative to the reference block and may consequently yield smaller prediction errors that need to be encoded in the bitstream.

The present disclosure is not limited to include all samples adjacent to left border and the top border of the block in the LIC parameter calculation and may include only a subset of the samples in some embodiments. LIC is described for inter prediction in the Enhanced Compression Model (ECM) software algorithm that is currently under coordinated exploration study by the Joint Video Exploration Team (JVET) of ITU-T Video Coding Experts Group (VCEG) and ISO/IEC MPEG as potential enhanced video coding technology beyond the capabilities of VVC. Although the present disclosure describes LIC for inter prediction, many of the described embodiments are equally applicable to intra prediction in which prediction blocks for a current block are generated from the same picture as that of the current block.

Illumination variations in reference blocks sometimes yield large prediction errors. LIC was proposed to improve inter prediction when such illumination variation exists in the reference block. Further improvement in addressing illumination variations in the reference block may be obtained by, instead of the one-tap filter in LIC, using a multiple-tap filter for illumination compensation so that correlations between multiple template samples can be captured and addressed by the use of the filter. Further, in some examples, complex non-linear filter models and/or non-linear functions applied to components of linear filter models may be used to generate prediction blocks that better compensate for illumination variations between reference blocks and corresponding current blocks.

In some embodiments, a plurality of filter models (e.g., which may include one or more multi-parameter filter models) are provided from which one filter model may be selected for LIC in inter prediction. Addition of multiple possible filter models increases flexibility at the encoder and enables an appropriate filter model to be selected to cater for different characteristics of content in video blocks. In some examples, the decoder may receive an indication of a filter model of the plurality of filter models, as determined and signaled by the encoder, to be used for LIC in inter prediction. In other examples, the encoder and decoder may reciprocally (e.g., independently and identically) derive that filter model from the plurality of filter models such that no signaling of that filter model is needed in the bitstream.

Example embodiments may provide for changing the size and/or shape of the filter for sampling the templates, and/or for changing the size of the templates to adapt the illumination compensation in accordance with the current block's block size/shape and/or content. The multiple-tap filter may provide for improving capturing of correlations among neighboring template samples improving the accuracy of the illumination compensation model compared to the one-tap filter in LIC. Moreover, templates of heights greater than one can be used to obtain more template samples and thereby further improve the accuracy of the illumination compensation model.

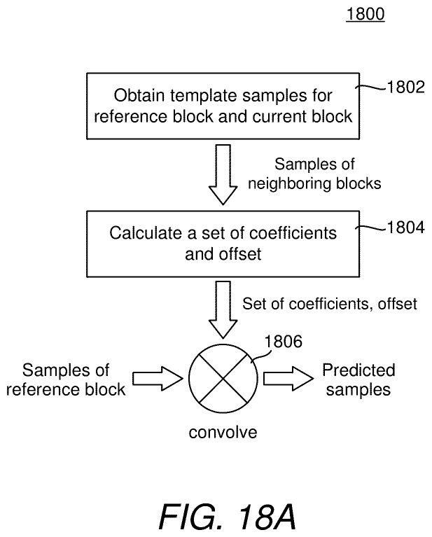

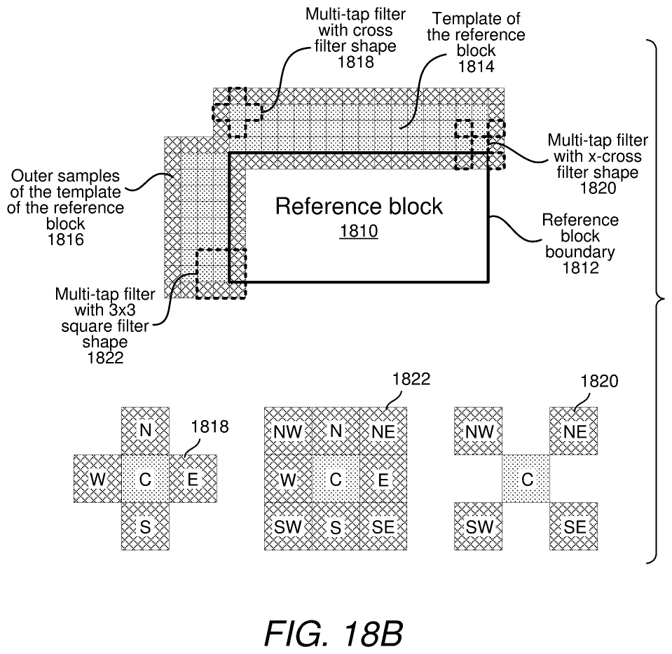

FIG. 18A shows an example of a method 1800 for generating (e.g., calculating) a prediction block by using an illumination compensation function (e.g., a filter model) that uses a multiple-tap filter (e.g., multi-parametric reference filter (MPRF) to sample the current template and the reference template. The method 1800 can be performed by an encoder, for example, encoder 200 shown in FIG. 2, and/or a decoder, for example, decoder 300 shown in FIG. 3. At the encoder, the current block may be subtracted from the prediction block to obtain the prediction error (e.g., a residual or a residual block) that is then encoded into a bitstream. At the decoder the prediction error received in a bitstream may be added to the prediction block to obtain the current (reconstructed) block.

At operation 1802, template samples from a reference template are obtained using a multiple-tap filter model. FIG. 18B illustrates an example reference template 1814 and example multiple-tap filter models 1818, 1820, and 1822 that can be used on the reference template 1814 to obtain a plurality of reference template samples for each sample location in the reference template. Corresponding current template samples are obtained for each sample location in the current template. As in conventional LIC technologies, the reference template 1814 extends over the left edge and the top edge of the boundary 1812 of the reference block 1810. In some examples, the reference template and the current template have identical size, shape and relative placement relative to their respective blocks.

In contrast to conventional LIC, the templates (the current template and the reference template) in example embodiments may have a height greater than 1 sample. For example, template 1814 may have a height of 3 (3 samples). Additionally, in contrast to the one-tap filter used in conventional LIC, example embodiments use a multiple-tap filter model such as, for example, one of multiple-tap filter models 1818-1822. The cross-shaped 5-tap filter model 1818 and the x-cross shaped 5-tap filter model 1820 each obtains 5 samples (e.g., a target sample and four neighboring/adjacent samples) at each template sample location in the template. The 3×3 square-shaped 9-tap filter model 1822 obtains 9 samples (e.g., a target sample and all neighboring/adjacent samples) at each template sample position. The example filter models 1818-1822 each illustrates an arrangement of a plurality of spatial components adjacent to a center spatial component C (which may correspond to a template sample location). In the illustrations in FIG. 18B, each filter spatial component is indicated relative to the center spatial component C as north N, north east NE, east E, south east SE, south S, south west SW, west W, or north west NW. Each filter shape and size may yield different illumination compensation results when applied to a reference block, based on the suitability of the filter's size and shape to capture the block's image characteristics.

Due to the size and shape of the multiple-tap filters such as, for example, provided by filter models 1818-1822, the template samples obtained by the multiple-tap filter may include some samples that are immediately adjacent to the template. FIG. 18B illustrates outer samples 1816 some of which may be obtained as template samples when any of the multiple-tap filter models 1818-1822 are used on template 1814. For example, in the illustration shown in FIG. 18B, spatial component C of filter model 1818 is positioned within the template 1814 such that spatial components N and W of filter model 1818 may be outside of template 1814 and overlay outer samples 1816. The illustrated position of filter model 1820 within template 1814 results in the filter model 1820 overlapping 3 outer samples 1816. The illustrated position of filter model 1822 within template 1814 results in the filter model 1822 overlaying 5 outer samples 1816.

Returning to method 1800, at operation 1804, the template samples (neighbor samples of the current block and the reference block) obtained at operation 1802, are used to calculate multiple spatial parameters (e.g., coefficients of the filter model). For example, in some embodiments, a respective spatial parameter is calculated for each tap in the applied filter. When, for example, 5-tap filter model 1818 is the filter that is used on the reference template, 5 spatial parameters are calculated, and when the 9-tap filter model 1822 is the filter model that is used on the reference template, 9 spatial parameters are calculated. The spatial parameter for a particular filter tap spatial component can be calculated by aggregating template samples corresponding to that filter tap spatial component according to an equation such as, for example, equation (20). The calculation of spatial parameters for the multiple-tap filter model may be thought of as similar to the calculation of the scale parameter for the one-tap filter as shown in equation (20).

An offset parameter (also referred to as a bias term or a bias component) can be calculated based on one or more aspects of the blocks and/or the calculated spatial parameters. For example, in some embodiments the offset is calculated based on the calculated spatial parameters by using an equation such as equation (21) adapted for the multiple-tap filter model.

At operation 1806, the set of coefficients (the plurality of spatial parameters) and the offset parameter calculated at operation 1804 are applied to respective reference samples to obtain respective predicted samples of the prediction block. This operation may be referred to as applying the multiple-tap filter corresponding to the multiple-tap filter model being applied to the reference block.

The calculation of the respective samples of the prediction block can be done in accordance with an equation that convolves the respective coefficients in the calculated set of coefficients with reference samples. An example equation for convolving the set of coefficients and a reference sample to obtain a predicted sample is as follows:

$$p ( x , y ) = \sum {a}_{i} r ( x , y ) + \sum {b}_{j} {f}_{0} ( r ( x , y ) ) + \sum {c}_{k} {f}_{1} ( {r}^{′ ( x , y )} ) + \sum {d}_{l} {f}_{2} ( {r}^{″ ( x , y )} ) + offset . \qquad ( 22 )$$

Here, {aᵢ, bⱼ, cₖ, dₜ} is the set of coefficients, f₀(.), f₁(.), f₂(.) are non-linear functions, r(x, y) are reference samples, r′(x, y) are gradients (derivatives) of reference samples, and r″(x, y) are second-order derivatives of reference samples. Equation 22 shows an example manner in which a set of 4 calculated coefficients is convolved with reference samples to obtain predicted samples. Each of the coefficients aᵢ, bⱼ, cₖ, dₗ may be obtained in a manner similar to the obtaining of the scale parameter described in relation to equation (20) by using a collection of template samples (current template samples and reference template samples). An example manner in which coefficients aᵢ, bⱼ, cₖ, cₗ may be determined is described below.

When using equation (22) to determine coefficients aᵢ, bⱼ, cₖ, dₗ, the r(x, y) is a reference template sample and p(x, y) is a current template sample. The first term Σaᵢr(x, y) comprises N, E, S, W, and C samples. Σaᵢr(x, y) can be expanded, e.g., as:

$$\sum {a}_{▯} r ( x , y ) = {a}_{0} r ( x , y - 1 ) + {a}_{1} r ( x + 1 , y ) + {a}_{2} r ( x , y + 1 ) + {a}_{3} r ( x - 1 , y ) + {a}_{4} r ( x , y ) \qquad ( 23 )$$

In equation (23), the template samples corresponding to N, E, S, W, and C spatial components of the 5-tap filter model 1818 are denoted as r(x, y−1), r(x+1, y), r(x, y+1), r(x−1, y), and r(x, y), respectively. For the following terms comprising ‘b’, ‘c’ and ‘d’ coefficients, these coefficients are applied to some non-linear functions of the N, E, S, W, and C samples (second term Σbⱼf₀(r(x, y)), non-linear functions of gradients of the samples (third term Σcₖf₁(r′(x, y))) and non-linear functions of second-order derivatives of the samples (fourth term Σdₗf₂(r″(x, y)).

f( ) could be applied to a set of gradient values {r [symbol] ′(x, y), r_{y}′(x, y), r_{xy}′(x, y)}. One of the examples of a such a non-linear function:

$$f ( x , y ) = √ ( {{r}_{▯}^{′} ( x , y )}^{2} + ( {{r}_{y}^{′} ( x , y )}^{2}$$

Another example of such a non-linear function is a clipping function defined for some threshold value T:

$$f ( x , y ) = min ( 0 , max ( T , {r}^{′} ( x , y ) )$$

$$or$$

$$f ( x , y ) = min ( 0 , max ( T , {r}^{″} ( x , y ) ) .$$

Threshold value T could be selected from the reference area samples, e.g., by taking a mean value in the reference area. Another example is a square function, defined, e.g., as f(x, y)=r [symbol] ′(x, y)² or f(x, y)=r [symbol] ′(x, y)². Another example is a maximum of squares function: f(x, y)=max(r [symbol] ′(x, y)², r_{y}′(x, y)².

Derivation of the coefficients in presence of the non-linear terms may be performed in a similar way as it is done for the linear terms. Specifically, a system of linear equations may be composed and further solved, e.g., using the well-known Gaussian elimination technique. Hence, though operations that are applied to the reference template samples could be non-linear, the filter itself may be linear because its coefficients are fixed after they are determined and do not depend on the reference block samples.

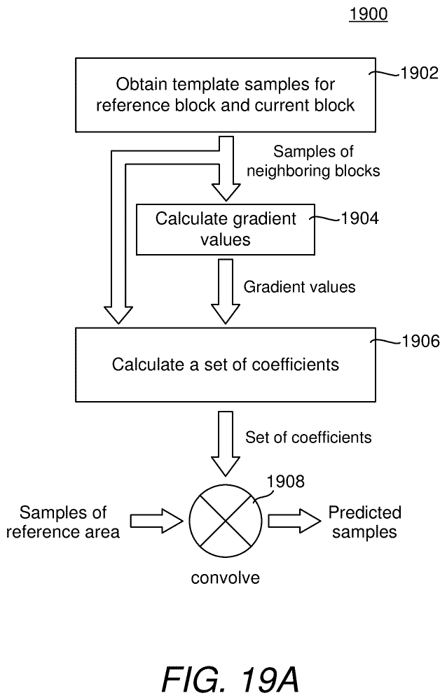

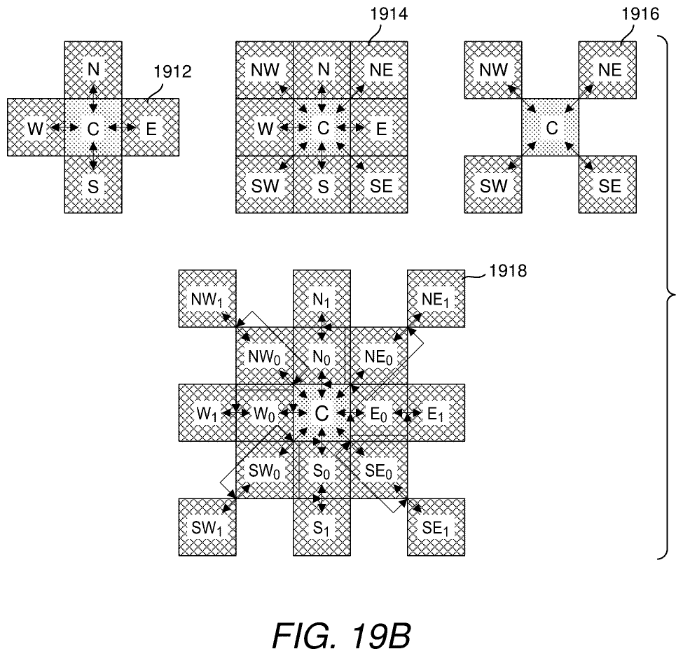

FIGS. 19A and 19B show another manner of performing illumination compensation using a multiple-tap filter, according to some embodiments. In the embodiments illustrated in FIGS. 19A and 19B, in addition to the template samples of the multiple-tap filters, their gradients are used as inputs to the process of coefficient calculation.

FIG. 19A shows an example method 1900 of using the gradients of multiple-tap filter samples to obtain illumination compensated predicted samples for inter prediction, according to some embodiments. The method 1900 can be performed by an encoder, for example, encoder 200 shown in FIG. 2, and/or a decoder, for example, decoder 300 shown in FIG. 3. At the encoder, the current block may be subtracted from the prediction block to obtain the prediction error that is then encoded into a bitstream. At the decoder the prediction error received in a bitstream may be added to the prediction block to obtain the current (reconstructed) block.

At operation 1902, in the same manner as described above in relation to operation 1802, template samples are obtained from a current template and from a reference template. The reference template samples are obtained by applying a multiple-tap filter model such as, for example, any one of the filter models 1818-1822, to the reference template.

At operation 1904, gradients (e.g., first-order derivatives, second-order derivatives, etc.) of the samples are calculated. In FIG. 19B, illustrated filter models 1912, 1914 and 1916 graphically show how first-order derivatives are obtained from the samples of filter models 1818, 1820, and 1822, respectively. An example of a second-order derivative of filter model samples is shown in the 17-tap filter model 1918. As graphically represented in the filter model illustrations 1912-1916, the first-order derivative represents changes in pairs of samples, and, as shown in 1918, the second-order derivative represents changes in respective pairs of pairs of samples. The first-order derivatives can capture information associated with edges in the pictures, and the second-order derivatives can capture information associated with smoothness of such edges. In example embodiments, the template samples only, or the template samples and their derivative(s) can be used as inputs to the next operation. Respective embodiments may use first-order derivatives and/or a higher-order derivative (e.g., second-order derivative or higher).

At operation 1906, the set of template samples obtained at operation 1902 and one or more sets of derivative values (e.g., first-order and/or higher-order) calculated from the template samples obtained at operation 1904, are taken as input to calculate the set of coefficients. For example, a respective spatial parameter can be calculated based on template samples, non-linear function(s) of template samples, non-linear functions of derivatives of the template samples, or a combination thereof. Equations (23) and (22) above illustrate how the set of coefficients for a multiple-tab filter model can be calculated.

In some embodiments, an offset parameter can be calculated based on one or more coefficients of the set of calculated coefficients. For example, the offset may be based on calculated coefficients in a manner similar to that shown in equation (21).

At operation 1908, the calculated set of coefficients and the offset are used to determine the prediction block. The coefficients and the offset can be combined with the reference samples in the manner shown in equation (22). As shown in the equation (22), the value of a predicted sample can be determined by multiplying the respective coefficients by the reference samples, derivatives of the reference sample, and/or non-linear functions of the reference sample and/or its derivative(s).

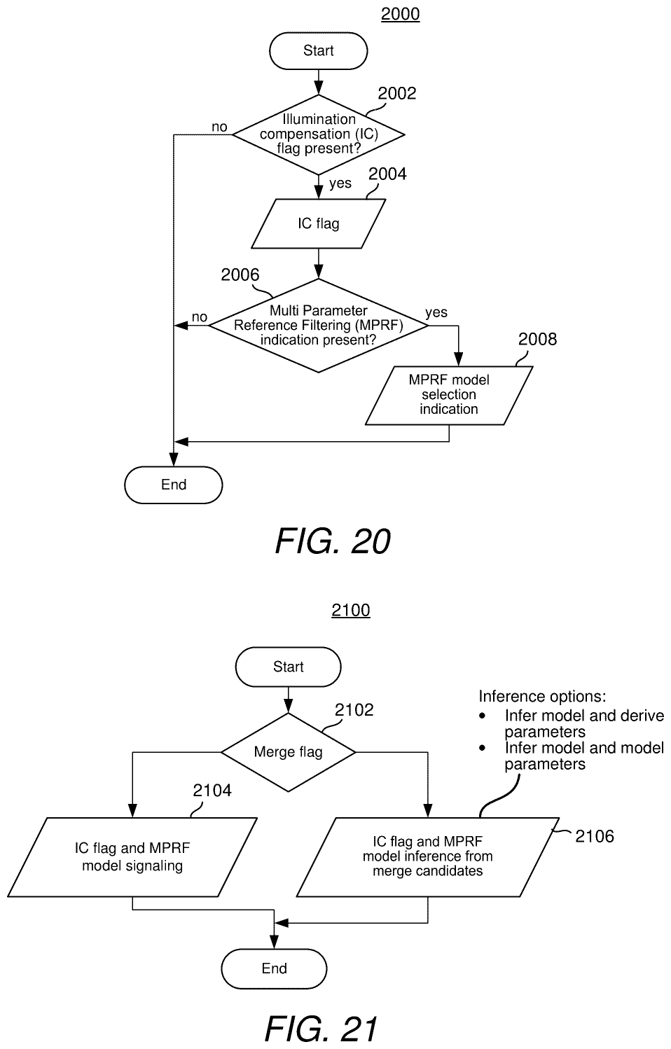

FIG. 20 shows a flowchart of a method 2000 of signaling the illumination compensation associated with a current block, according to some embodiments. The method may be performed at a decoder, such as, for example, the decoder 300 shown in FIG. 3.

At operation 2002, it is determined whether an indication (e.g., a flag) of illumination compensation is included in the bitstream. If the illumination compensation indication 2004 is present, it may indicate either local illumination compensation (LIC) or illumination compensation based on multi-parametric reference function is applied. In other words, illumination compensation indication 2004 may indicate whether an LIC model or a multi-parameter filter model is to be applied.

At operation 2006, it is determined whether illumination compensation based on multi-parametric reference function (MPRF) is applied. As used in the present disclosure, MPRF refers to a multi-parameter filter model being used. In some examples, if the illumination compensation based on multi-parametric reference function selection indication (Multi-parameter reference filtering (MPRF) block-level indication) 2008 is set, then illumination compensation based on MPRF is applied. Whether to apply MPRF based illumination compensation (e.g., and if applied, to include the MPRF block-level indication) may be decided based on constraints such as, one or more of block size of the current block, block orientation of the current block, whether uni- or bi-prediction is used for inter prediction, and/or whether affine flag is present, etc. For example, if the block size is too small (e.g., 4×4 etc.) or if the orientation is not conducive for template use, then MPRF illumination compensation may not be used. If bi-prediction is used or if the affine flag is set, then additional improvements provided by MPRF illumination compensation may be considered as unnecessary.

The MPRF block-level indication 2008 comprises one or more flags indicating aspects of the multiple-tap filter and/or models, such as, for example, 2-parameter model (LIC-like) 6-parameter model, . . . , 19-parameter model (with gradients and non-linear filter). In some embodiments, the indication 2008 may be an index into a table of respective filter models that can be applied.

FIG. 21 shows a method 2100 by which a decoder can determine, when using inter prediction merge mode, whether illumination compensation based on MPRF is to be used for the current block, and if so, what filter model and/or filter model parameters are to be used, according to some embodiments.

If, at operation 2102, the decoder detects a merge flag indicating merge mode inter prediction, method 2100 proceeds to operation 2106. At operation 2106, the absence or presence of the illumination compensation indication/flag (e.g., illumination compensation (IC) indication 2004) and the presence or absence of a MPRF model indication (e.g., MPRF block level indication at operation 2006) can be inferred based on the corresponding aspects in the selected merge candidate. For example, if a MPRF block-level indication at operation 2006 was received for the selected merge candidate, it can be decided that an MPRF block-level indication at operation 2006 would have been signaled in association with the current block, and, if a particular MPRF model indication was received in association with the selected merge candidate, it can be decided that the same MPRF model indication would be signaled in association with the current block.

At operation 2106, after inferring the MPRF model indication (e.g., determining a filter model that applies for MPRF), the corresponding model parameters for the current block may either be calculated or may be copied from the selected merge candidate. For example, in one embodiment, the inferred model indication identifies a particular multiple-tap filter model (e.g., any one of filter models 1818-1822), and then, the decoder calculates the set of coefficients based on the templates and the identified filter model to determine the filters (i.e., the multi-tap filter model with the calculated coefficients/parameters). In another embodiment, the inferred model indication identifies a particular multiple-tap filter model (e.g., any one of filter models 1818-1822), and the decoder copies the set of coefficients (e.g., also referred to as parameters of the filter model) from the selected merge candidate as the set of coefficients for the current block. Accordingly, the multiple-tap filter model and its coefficients may be derived (e.g., inferred by copying) to determine the multiple-tap filter, which corresponds to the selected multiple-tap filter model with the derived coefficients.

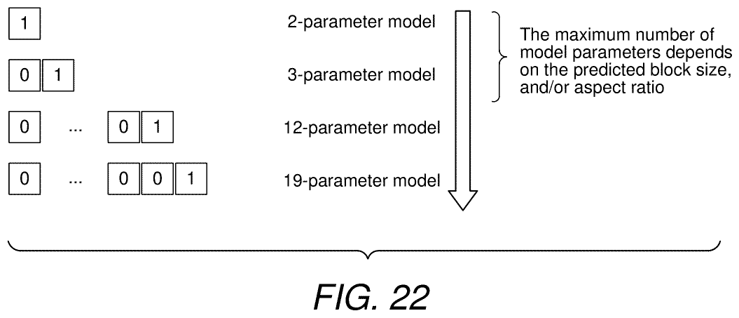

In some embodiment, the model indication may be encoded so that the length of the model indication as represented in the bitstream is proportional to the number of parameters (e.g., coefficients of spatial components) in the filter model (e.g., increases/decreases as the number of model parameters for the model increases/decreases). FIG. 22 shows an example coding scheme (e.g., a unary code) in which the unary codes 1, 01, 0 . . . 01, 0 . . . 001 are used to represent filter models such as a 2-parameter model, a 3-parameter model, a 12-parameter model, and a 19-parameter model, respectively. This enables taking advantage of the characteristic that the probability of models with higher number of parameters being necessary decreases with the increase of the number of parameters.

In some examples, the maximum number of model parameters may depend on the size of the prediction block and/or the aspect ratio of the prediction block. In some examples, the encoder and decoder may reciprocally determine (e.g., select) the available/permitted filter models to be indicated by codewords of the coding scheme. For example, the encoder and decoder may reciprocally determine that, e.g., the codeword 1 refers to a 2-parameter model and the codeword 01 refers to a 4-parameter model based on a 3-parameter model determined not to be used/available.

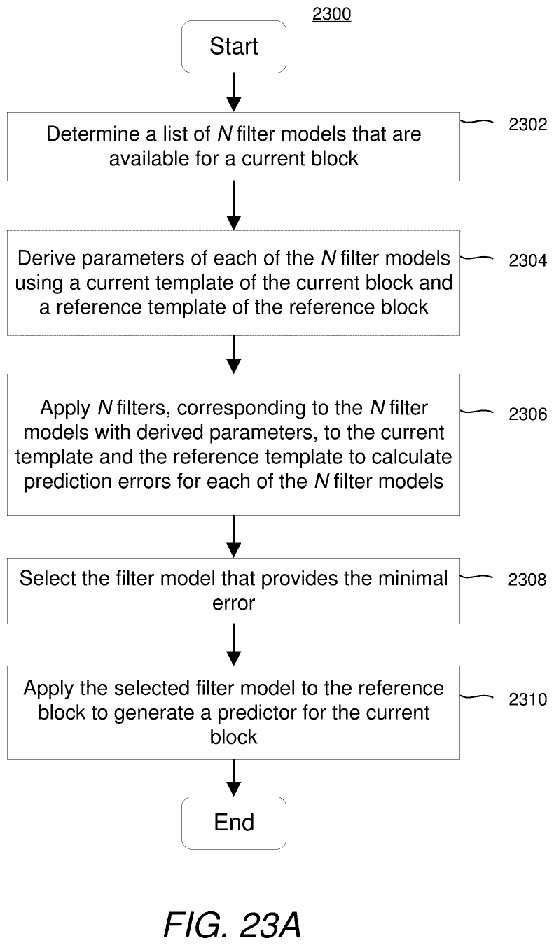

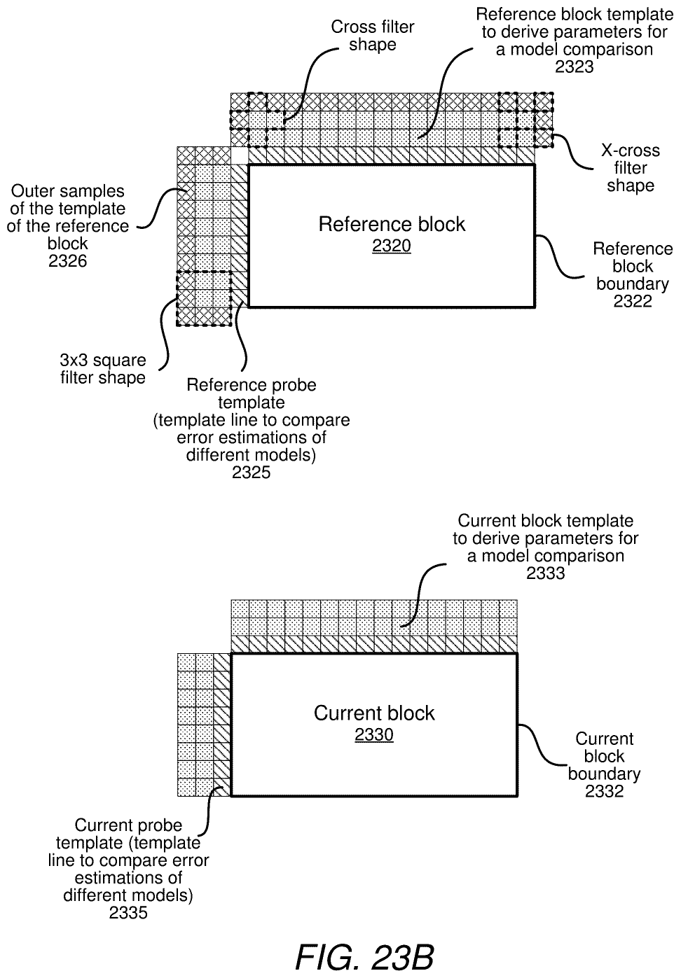

FIG. 23A shows an example flowchart of a method 2300 of determining (e.g., deriving) a filter model to be applied for illumination compensation in inter prediction, according to some embodiments. The method 2300 can be performed by an encoder, for example, encoder 200 shown in FIG. 2, and/or a decoder, for example, decoder 300 shown in FIG. 3.

At operation 2302, a list of N filter models (e.g., a first plurality of filter models) that can be used for illumination compensation of a reference block for a current block is determined. The N filter models may be a subset of a plurality of filter models (e.g., a second plurality of filter models) that are available (e.g., defined or enabled) for inter prediction in the system. For example, the subset of N filter models can be selected based on the block size. N is a positive integer greater than 1.

At operation 2304, for each of the N filter models in the subset, the filter parameters (e.g., model coefficients) are derived using a current template of the current block and a reference template of the reference block. The model coefficients can be derived, for example, as described in relation to equations (23) and (22) above. In some examples, the model coefficients for each filter model is derived based on a first portion of the current template and a first portion of the reference template. In some examples, the first portion of the current template and the first portion of the reference template may have the same shape, size, and orientation. Further, the first portion of the current template and the first portion of the reference template may have the same relative position within respect to the current template and the reference template, respectively.

FIG. 23B shows an example reference template format and a current template format that are used to derive the filter model, of a plurality of filter models, in the method shown in the flowchart of FIG. 23A, according to some embodiments. FIG. 23B shows a reference block 2320 and an associated reference template and a current block 2330 and an associated current template. In contrast to the reference template 1814 described in relation to FIG. 18B, the reference template of the reference block 2320 has a first template portion 2323 that can be used for deriving parameters for the filter model comparison and a second portion (probe areas 2325), referred to herein as a probe template, that can be used to compare error estimations of the different models. The probe template may be formed by the neighboring row and column that is closest to the reference block boundary 2322. As illustrated, multiple-tap filters (e.g., any of the illustrated 3×3 square filter, the cross-shape filter, the x-cross filter, etc.) can be applied to template portion 2323 without having the filters overlap the probe template. Outer template samples 2326 that are adjacent to template portion 2323 may be included within the filter coverage area of the reference template. When deriving the model coefficients for a particular reference filter model, the corresponding reference filter is applied to the reference block template portion 2323 of the reference template. A current block 2330 with its current template is also illustrated. In the current template, a first portion 2333 of the template is used to derive parameters for the model comparison, and a second portion, that is the probe area 2335 and also referred to as probe template, that is used to compare error estimations of different filter models. According to some embodiments, the model coefficients are determined by using template samples obtained from the template portion 2323 in the reference template (e.g., using a multiple-tap filter model) and template portion 2333 in the current template.

Returning to method 2300, at operation 2306, each of the N filters, using the calculated model coefficients for each filter model, are applied to the current template and the reference template to calculate prediction errors for each of the N filter models. In some examples, each filter, corresponding to a respective filter model with determined/derived model coefficients, may be applied to a second portion of the current template and a second portion of the reference template. In some examples, the second portion of the current template and the second portion of the reference template may have the same shape, size, and orientation. Further, the second portion of the current template and the second portion of the reference template may have the same relative position within respect to the current template and the reference template, respectively. In some examples, the first and second portions of the current template do not overlap and the first and second portions of the reference template do not overlap. For example, each filter may be applied to a second portion of the reference template such as probe areas 2325 in the reference template and the resulting/calculated predicted sample (e.g., that is an illumination compensated sample value) is compared to the sample in the corresponding template area 2335 associated with the current block, to calculate the prediction error.

At operation 2308, the errors calculated for the respective filter models are compared, and the filter model that provides the minimal error (e.g., as applied to the second portion of the reference template and compared to the second portion of the current template, which is also referred to as the probe templates) may be selected as the filter model to apply to the reference block. In some embodiments, criteria other than the minimum error can be used in addition to, or in place of, the minimum error, in selecting the filter model to be applied to the reference block.

At operation 2310, the filter corresponding to the selected filter model is applied to the reference block to generate the predictor for the current block. For example, the predictor may be calculated using an equation such as equation (22) with r(x, y) being reference samples and p(x, y) being prediction samples. Note that the filter would already have its set of coefficients determined at 2304 by using an equation such as equation (23) with r(x, y) being reference template samples and p(x, y) being current template samples.

It should be noted that the plurality of filter models considered at operation 2302 may include various sizes of filter models.

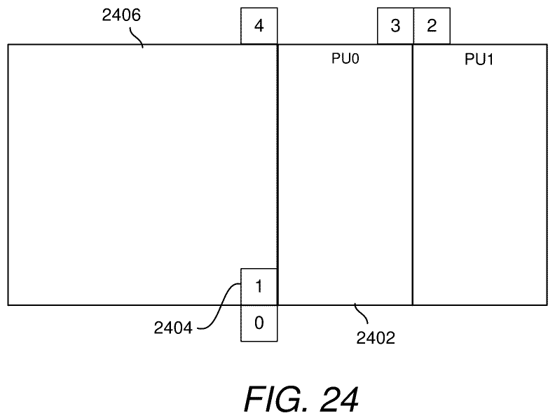

FIG. 24 illustrates an example of when filter model parameters can be obtained from a merge candidate, according to some embodiments. Examples of merge mode and indications of merge candidates are described above with respect to FIG. 15A and FIG. 15B. As described above with respect to FIG. 21, in merge mode inter prediction, the MPRF filter model information can either be signaled in the bitstream or can be inferred at the decoder. For example, the determination of which multiple-tap filter model to use for the current block may either be signaled in the bitstream or may be based on an indication copied from the selected merge candidate. Moreover, the model parameters to be used with the filter model may either be signaled in the bitstream or may be based on an indication copied from the selected merge candidate.

In some embodiments, for example, after having determined based on the selected merge candidate that a particular MPRF multiple-tap filter model applies to the current block, the decoder determines the model parameters in accordance with a block size of the selected merge candidate. For example, when the current block (corresponding to PU0) 2402 is being decoded in merge mode inter prediction, the selected merge candidate may be signaled as candidate 1 2404, e.g., a neighboring block containing a sample/pixel at the location shown in FIG. 24. The decoder determines that the block size of the block 2406 corresponding to the sample of candidate 1 2404 (the signaled selected merge candidate) is larger than the block size of current block 2402, and, since the larger size of block 2406 is likely indicative of blocks 2406 and 2402 being parts of the same object, may copy the model parameters corresponding to the multiple-tap filter model from selected merge candidate block 2406.

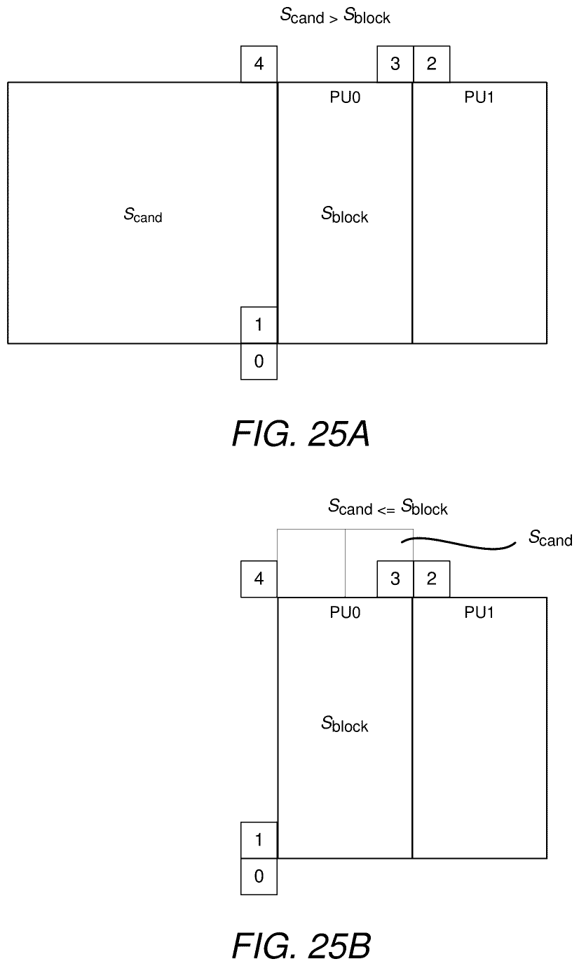

FIG. 25A and FIG. 25B show example block sizes of merge candidate blocks that can be considered when deciding whether to obtain filter model parameters from one of the merge candidates, according to some embodiments. As shown, the block size of the block of merge candidate 1 is larger than the block size of PU0 which may be a current block to be coded, and the block size of the block of merge candidate 3 is smaller than the block size of PU0. Therefore, when the selected merge candidate is determined to be merge candidate 1, the model parameters may be directly copied (e.g., inferred or inherited) from the selected merge candidate, and, when the selected merge candidate is determined to be merge candidate 3, the model parameters can be derived. Examples for determining or deriving the model parameters (e.g., coefficients of components of the filter model) are described above with respect to FIGS. 17-19. In example embodiments, the size difference of a merge candidate block and the current block may be determined in accordance with the configured threshold. Further, the decoder may determine whether to copy (i.e., infer or inherit) the coefficients of the filter model (copied or derived from the indicated merge candidate) or to separately derive those coefficients. In some embodiments, the encoder and the decoder reciprocally (e.g., independently and identically) determine whether model parameters (e.g., coefficients) of a filter model, associated with an indicated merge candidate, are to be copied or derived.

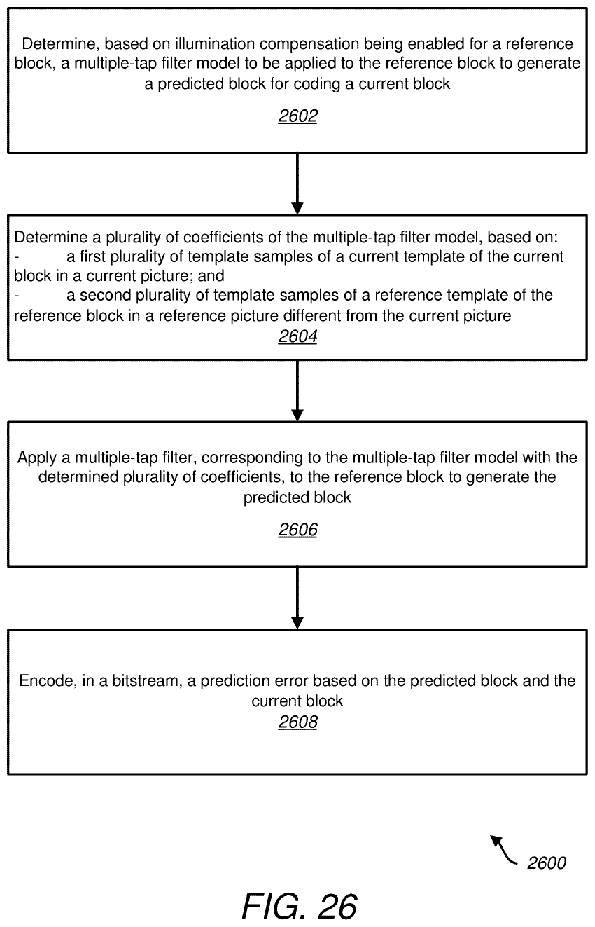

FIG. 26 shows a flowchart 2600 of a method for applying illumination compensation using MPRF in inter prediction, according to some embodiments. The method of flowchart 2600 may be implemented by an encoder, such as encoder 200 in FIG. 2.

The method of flowchart 2600 begins at 2602. At 2602, the encoder determines, based on illumination compensation being enabled for a reference block, a multiple-tap filter model to be applied to the reference block to generate a prediction block for coding a current block.

In some embodiments, the determining may include using a preconfigured (or default) multiple-tap filter model. For example, in some embodiments, any one of the filter models 1818-1822 may be determined as the filter model for which the corresponding filter is applied to the reference block.

In some embodiments, the determining may include selecting one filter model, from among a plurality of filter models, as the filter model for which the corresponding filter is applied to the reference block. An example method of selecting a filter model is described in relation to FIGS. 23A and 23B.

The determination as to whether illumination compensation is enabled may be based on configuration (e.g., setting specifying illumination compensation to be always enabled for inter prediction), or considerations based on one or more of a current block size, current block orientation, whether uni- or bi-prediction is used in the inter prediction, or whether an affine flag is associated with the current block.

As noted above, in some embodiments, the multiple-tap filter model is determined from a plurality of filter models. The plurality of filter models may comprise the multiple-tap filter model and a linear filter model with a single spatial component and a bias term (e.g., a bias component in the linear filter model).

At operation 2604, the encoder determines a plurality of coefficients of the multiple-tap filter model, based on: a first plurality of template samples of a current template of the current block in a current picture; and a second plurality of template samples of a reference template of the reference block in a reference picture different from the current picture.

The first plurality of template samples is obtained from the current template associated with the current block the current picture. The second plurality of template samples is obtained from the reference template of the reference block from a reference picture. The current template is adjacent to a current block in the current picture and the reference template is adjacent to a reference block in the reference picture. The current template comprises a plurality of columns of samples nearest a left edge of the current block and a plurality of rows of samples nearest a top edge of the current block, and the reference template comprises a plurality of columns of samples nearest a left edge of the reference block and a plurality of rows of samples nearest a top edge of the reference block. As would be noted, in inter prediction the current picture and the reference picture are respective pictures in a sequence of pictures. The second plurality of template samples is obtained by using the determined/selected multiple-tap filter model to the reference template.

In some embodiments, the second plurality of template samples comprises some samples adjacent to the reference template. In some embodiments, the samples adjacent to the reference template comprise padded samples obtained by copying the corresponding template sample values. In some embodiments, the outer samples include real sample (e.g., neighbor block sample that is a reconstructed sample) values. Padded samples may provide some savings in memory bandwidth. FIG. 18B shows an example reference template 1814 according to embodiments of this disclosure. The figure also shows outer samples 1816 adjacent to the reference template 1814.

In some embodiments, the multiple-tap filter model comprises a plurality of spatial components comprising: one spatial component for a target sample on which the multiple-tap filter is applied, and a spatial component for each selected sample adjacent to the target sample. For example, in the 5-tap filter model 1818, when the spatial component for a target sample on which the multiple-tap filter is applied is C, the spatial components N, S, E, W correspond to the selected samples adjacent to the target sample. FIG. 18B shows a selection of example non-limiting multiple-tap filter models. As illustrated, in respective embodiments, the multiple-tap filter model may have 2 or more template samples arranged in a plurality of ways. In some embodiments, the multiple-tap filter model comprises 5 spatial components, 9 spatial components, 17 spatial components, or another number of spatial components. In respective embodiments, the multiple-tap filter model comprises a plurality of spatial components arranged in a cross shape, in a x-cross shape, in a rectangular shape, or another shape.

The encoder determines the plurality of coefficients of the illumination compensation function, based on the first plurality of template samples and the second plurality of template samples. For example, for illumination compensation using MPRF, the spatial parameters (e.g., set of coefficients with a function similar to the scale parameter used in equation (20) and the offset parameter may be determined. The spatial parameters may comprise a plurality of spatial parameters (coefficients).

Example calculation of the spatial parameters and the offset parameter are described above in relation to equations (23) and (22) for a selected multiple-tap filter model. It would be understood that the parameters for other multiple-tap filter models can be determined in a similar manner. As noted above, in example embodiments, the spatial parameters may be determined based on reference template samples, derivatives of reference template samples, and/or non-linear functions of reference samples or their derivatives.

The determining of the plurality of coefficients may be based on a difference minimization technique applied between the first plurality of template samples and a plurality of filtered samples output from the multiple-tap filter model applied to the second plurality of template samples. For example, such difference minimization techniques may include minimum squared error, SAD, SATD, SSD, etc.

In some embodiments, the multiple-tap filter model comprises two or more spatial components and a bias component. The multiple-tap filter model may comprise a linear filter model, a linear filter model comprising one or more components with a non-linear function, a derivative filter model of an nth order, wherein n is n is a positive integer (e.g., first order, second order, etc.), or a combination of linear filter models. (e.g., a first order model and a second order model).

At operation 2606, the encoder applies a multiple-tap filter, corresponding to the multiple-tap filter model with the determined plurality of coefficients, to the reference block to generate the prediction block. The multiple-tap filter may be an example of the illumination compensation function and may include a plurality of components comprising the determined plurality of coefficients and a bias term (e.g., a bias component). Equation (22) may be used in calculating the predicted samples based on the spatial parameters calculated using reference template and the current template, and using reference block samples.

In some embodiments, the applying includes calculating each predicted sample of the prediction block based at least on the determined plurality of coefficients, a reference sample, and the bias term, wherein the reference sample is from the reference block. In some embodiments the applying includes calculating each predicted sample of the prediction block based at least on the determined set of coefficients, a reference sample, one or more non-linear functions of the reference sample, and the bias term, wherein the reference sample is from the reference block. The one or more non-linear functions of the reference sample may comprise at least a first-order derivative of the reference sample or a second-order derivative of the reference sample.

At operation 2608, the encoder encodes, in a bitstream, a prediction error based on the prediction block and the current block. The encoded prediction error values, when illumination compensation using MPRF has been applied to the reference block, may be smaller compared to when such illumination compensation is not applied, and thus may be more efficiently encoded.

According to some embodiments, operations of flowchart 2600 may further include the encoder directly signaling whether or not illumination compensation using MPRF is being applied to the current block. For example, the encoder may encode a first indication indicating that an illumination compensation function is applied and a second indication indicating one or more aspects of the illumination compensation function and/or the multiple-tap filter. The encoding of the second indication indicating one or more aspects of the illumination compensation function and/or the multiple-tap filter may include dynamically deciding whether to apply the illumination compensation function and/or the multiple-tap filter to the reference block. The decision may be made based on factors such as, for example, the block size and/or block orientation of the current block, whether uni- or bi-prediction is used, the affine flag, etc. When included, the second indication may include an identification of the multiple-tap filter and/or a parametric model of the illumination compensation function. For example, the second indication may identify which one of parametric models from a predetermined set of models such as, for example, a 2-parameter model (LIC-like), 6-parameter model, . . . , and 19-parameter model (with gradients and non-linear filter), is being used. The second indication may be encoded efficiently using a codeword where a relative length of the codeword is determined in accordance with a relative number of parameters in the parametric model. An example unary code is shown in FIG. 22.

According to some embodiments, operations of flowchart 2600 may further include dynamically switching between a first mode in which a local illumination compensation (LIC) is applied to the reference block and one or more second modes in which illumination compensation based on the multiple-tap filter (MPRF enabled) is applied to the reference block. For example, when at operation 2006 described above, it is determined not to perform illumination compensation using MPRF, instead LIC-like illumination compensation (e.g., a 1-tap filter as in conventional LIC, but with templates of height more than 1) can be performed and the local illumination indication that is signaled can indicate to the decoder that the LIC-like illumination compensation (e.g., without a multiple-tap filter) is being used.

In some embodiments, when inter prediction merge mode is used for the current block, the encoder may not include the first indication and/or the second indication in the bitstream, and the decoder may infer the first indication and the second indication from the selected merge candidate.

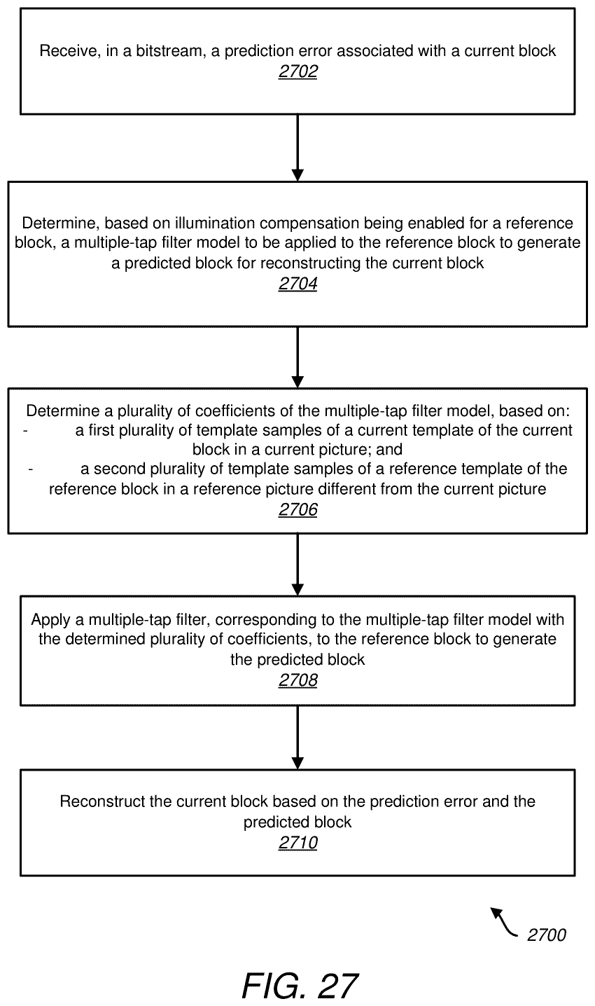

FIG. 27 shows a flowchart of a method 2700 for determining a current block that has been encoded by applying illumination compensation using MPRF in inter prediction, according to some embodiments. The method 2700 may be implemented by a decoder, such as decoder 300 in FIG. 3.

The method 2700 begins at 2702. At 2702, the decoder receives, in a bitstream, a prediction error associated with a current block.

At operation 2704, the decoder determines, based on illumination compensation being en abled for a reference block, a multiple-tap filter model to be applied to the reference block to generate a prediction block for reconstructing the current block.

In some embodiments, the determining may include receiving one or more indications in the bitstream indicating an MPRF filter/filter model or using a preconfigured (or default) multiple-tap filter model. For example, in some embodiments, any one of the filter models 1818-1822 may be signaled or determined as the filter model for which the corresponding filter is applied to the reference block.

In some embodiments, the determining may include selecting one filter model, from among a plurality of filter models, as the filter model for which the corresponding filter is applied to the reference block. An example method of selecting a filter model is described in relation to FIGS. 23A and 23B.

The determination as to whether illumination compensation is enabled may be based on configuration (e.g., setting specifying illumination compensation to be always enabled for inter prediction), or considerations based on one or more of a current block size, current block orientation, whether uni- or bi-prediction is used in the inter prediction, or whether an affine flag is associated with the current block.

At operation 2706, the decoder determines a plurality of coefficients of the multiple-tap filter model, based on: a first plurality of template samples of a current template of the current block in a current picture; and a second plurality of template samples of a reference template of the reference block in a reference picture different from the current picture.

The first plurality of template samples is obtained from the current template associated with the current block the current picture. The second plurality of template samples is obtained from the reference template of the reference block from a reference picture. The current template is adjacent to a current block in the current picture and the reference template is adjacent to a reference block in the reference picture. The current template comprises a plurality of columns of samples nearest a left edge of the current block and a plurality of rows of samples nearest a top edge of the current block, and the reference template comprises a plurality of columns of samples nearest a left edge of the reference block and a plurality of rows of samples nearest a top edge of the reference block. As would be noted, in inter prediction the current picture and the reference picture are respective pictures in a sequence of pictures. The second plurality of template samples is obtained by using the determined/selected multiple-tap filter model to the reference template.

In some embodiments, the second plurality of template samples comprises some samples adjacent to the reference template. In some embodiments, the samples adjacent to the reference template comprise padded samples obtained by copying the corresponding template sample values. In some embodiments, the outer samples include real sample (e.g., neighbor block sample that is a reconstructed sample) values. Padded samples may provide some savings in memory bandwidth. FIG. 18B shows an example reference template 1814 according to embodiments of this disclosure. The figure also shows outer samples 1816 adjacent to the reference template 1814.

In some embodiments, the multiple-tap filter model comprises a plurality of spatial components comprising: one spatial component for a target sample on which the multiple-tap filter is applied, and a spatial component for each selected sample adjacent to the target sample. For example, in the 5-tap filter model 1818, when the spatial component for a target sample on which the multiple-tap filter is applied is C, the spatial components N, S, E, W correspond to the selected samples adjacent to the target sample. FIG. 18B shows a selection of example non-limiting multiple-tap filter models. As illustrated, in respective embodiments, the multiple-tap filter model may have 2 or more template samples arranged in a plurality of ways. In some embodiments, the multiple-tap filter model comprises 5 spatial components, 9 spatial components, 17 spatial components, or another number of spatial components. In respective embodiments, the multiple-tap filter model comprises a plurality of spatial components arranged in a cross shape, in a x-cross shape, in a rectangular shape, or another shape.

The decoder determines the plurality of coefficients of the illumination compensation function, based on the first plurality of template samples and the second plurality of template samples. For example, for illumination compensation using MPRF, the spatial parameters (e.g., set of coefficients with a function similar to the scale parameter used in equation (20) and the offset parameter may be determined. The spatial parameters may comprise a plurality of spatial parameters (coefficients).

Example calculation of the spatial parameters and the offset parameter are described above in relation to equations (23) and (22) for a selected multiple-tap filter model. It would be understood that the parameters for other multiple-tap filter models can be determined in a similar manner. As noted above, in example embodiments, the spatial parameters may be determined based on reference template samples, derivatives of reference template samples, and/or non-linear functions of reference samples or their derivatives.

The determining of the plurality of coefficients may be based on a difference minimization technique applied between the first plurality of template samples and a plurality of filtered samples output from the multiple-tap filter model applied to the second plurality of template samples. For example, such difference minimization techniques may include minimum squared error, SAD, SATD, SSD, etc.

In some embodiments, the multiple-tap filter model comprises two or more spatial components and a bias component. The multiple-tap filter model may comprise a linear filter model, a linear filter model comprising one or more components with a non-linear function, a derivative filter model of an nth order, wherein n is n is a positive integer (e.g., first order, second order, etc.), or a combination of linear filter models. (e.g., a first order model and a second order model).

In some embodiments, the determining a multiple-tap filter model may comprise determining, based on at least relative block sizes of the selected merge candidate block and a current block, the multiple-tap filter model. For example, as described above in relation to FIG. 24 (also FIGS. 25A-25B), when merge mode inter prediction is used, the filter model for the current block may be inferred from the filter model of the selected merge candidate. The inferring of the filter model from the selected merge candidate may be performed for any selected merge candidates, or only when the block size of the selected merge candidate is larger (e.g., beyond a threshold) than that of the current block. Moreover, when the filter model is inferred from the selected merge candidate, the filter model coefficients may either be determined based on the templates, or may be inferred from the selected merge candidate (without calculating based on the templates of the current block and the reference block).

At operation 2708, the decoder applies a multiple-tap filter, corresponding to the multiple-tap filter model with the determined plurality of coefficients, to the reference block to generate the prediction block. The multiple-tap filter may be an example of the illumination compensation function and may include a plurality of components comprising the determined plurality of coefficients and a bias term (e.g., a bias component). Equation (22) may be used in calculating the predicted samples based on the spatial parameters calculated using reference template and the current template, and using reference block samples.

In some embodiments, the applying includes calculating each predicted sample of the prediction block based at least on the determined plurality of coefficients, a reference sample, and the bias term, wherein the reference sample is from the reference block. In some embodiments the applying includes calculating each predicted sample of the prediction block based at least on the determined set of coefficients, a reference sample, one or more non-linear functions of the reference sample, and the bias term, wherein the reference sample is from the reference block. The one or more non-linear functions of the reference sample may comprise at least a first-order derivative of the reference sample or a second-order derivative of the reference sample.

At operation 2710, the decoder reconstructs the current block based on the prediction error and the prediction block.

The operation 2710 may include decoding, from the bitstream, a first indication indicating that the illumination compensation function is to be applied and a second indication indicating one or more aspects of the illumination compensation function and/or the multiple-tap filter. The one or more aspects of the illumination compensation function and/or the multiple-tap filter includes an identification of the multiple-tap filter/filter model and/or a parametric model (e.g., set of parameters) of the illumination compensation function. The identification of the multiple-tap filter and/or the parametric model is encoded in a codeword wherein a relative length of the codeword is determined in accordance with a relative number of parameters in the parametric model. As described above in relation to flowchart 2600, the encoding of the second indication indicating one or more aspects of the illumination compensation function and/or the multiple-tap filter may include the encoder dynamically deciding whether to apply the illumination compensation function and/or the multiple-tap filter to the reference block. The decision may be made based on factors such as, for example, the block size and/or block orientation of the current block, whether uni- or bi-prediction is used, the affine flag, etc. When included, the second indication may include an identification of the multiple-tap filter/filter model and/or a parametric model of the illumination compensation function. For example, the second indication may identify which one of parametric models from a predetermined set of models such as, for example, a 2-parameter model (LIC-like), 6-parameter model, . . . , and 19-parameter model (with gradients and non-linear filter), is being used. The second indication may be encoded efficiently using a codeword where a relative length of the codeword is determined in accordance with a relative number of parameters in the parametric model. An example unary code is shown in FIG. 22.

In some embodiments, as described above in relation to FIG. 21 when merge mode inter prediction applies to the current block, the first indication and the second indication are inferred from the selected merge candidate.

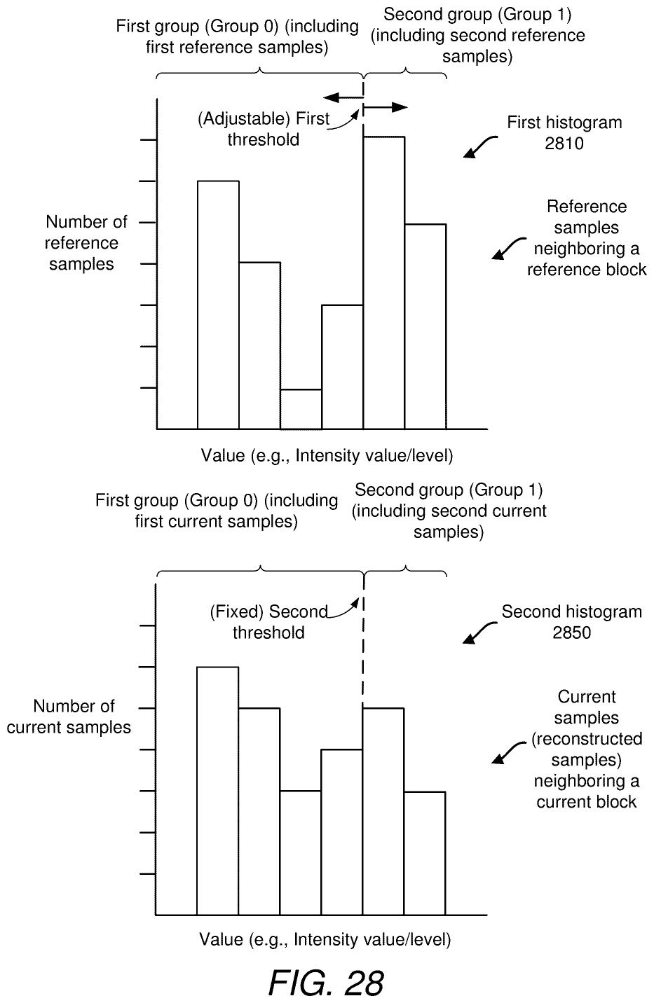

FIG. 28 shows a first example histogram 2810 of values of reference samples (e.g., luma components of pixels) neighboring a reference block (e.g., reference samples in template 1716 of the reference block 1708, reference samples in template 1814 of the reference block 1810) classified into a first group (including first reference samples) and a second group (including second reference samples) by a first threshold, according to some embodiments.

In this disclosure, the first group is also referred to as group 0, and the second group is referred to as group 1. In some embodiments, the values of the reference samples are (associated with) intensity/luminance (Y) values. In some embodiments, the values of the reference samples are (associated with) chrominance (Cr) values. In some embodiments, the values of the reference samples are (associated with) chrominance (Cb) values. In some embodiments, the values of the reference samples are (associated with) other suitable values associated with the reference samples.

FIG. 28 also shows a second example histogram 2850 of values of current samples (e.g., luma components of pixels) neighboring a current block (e.g., current samples in template 1714 of the current block 1704) classified into a first group (including first current samples) and a second group (including second current samples) by a second threshold. In this disclosure, the first group is also referred to as group 0, and the second group is referred to as group 1. In some embodiments, the values of the current samples are (associated with) intensity/luminance (Y) values. In some embodiments, the values of the current samples are (associated with) chrominance (Cr) values. In some embodiments, the values of the current samples are (associated with) chrominance (Cb) values. In some embodiments, the values of the current samples are (associated with) other suitable values associated with the current samples.

In some embodiments, the reference samples neighboring the reference block include samples that are directly (e.g., immediately) adjacent to the reference block. In some embodiments, the reference samples neighboring the reference block include samples that are adjacent (but not directly adjacent to) the reference block.

In some embodiments, the current samples neighboring the current block include samples that are directly (e.g., immediately) adjacent to the current block. In some embodiments, the current samples neighboring the current block include samples that are adjacent (but not directly adjacent to) the current block.

As shown, in some embodiments, the first threshold and the second threshold are the same. In some embodiments, the first threshold is different from the second threshold. For example, the first threshold may be greater than the second threshold. In some examples, the second threshold may be greater than the first threshold.

In some embodiments, the first threshold is (associated with) intensity/luma values. In some embodiments, the first threshold is (associated with) chrominance (Cr) values. In some embodiments, the first threshold is (associated with) chrominance (Cb) values. In some embodiments, the first threshold is (associated with) other suitable values associated with the reference samples.

In some embodiments, the second threshold is (associated with) intensity/luma values. In some embodiments, the second threshold is (associated with) chrominance (Cr) values. In some embodiments, the second threshold is (associated with) chrominance (Cb) values. In some embodiments, the second threshold is (associated with) other suitable values associated with the current samples.

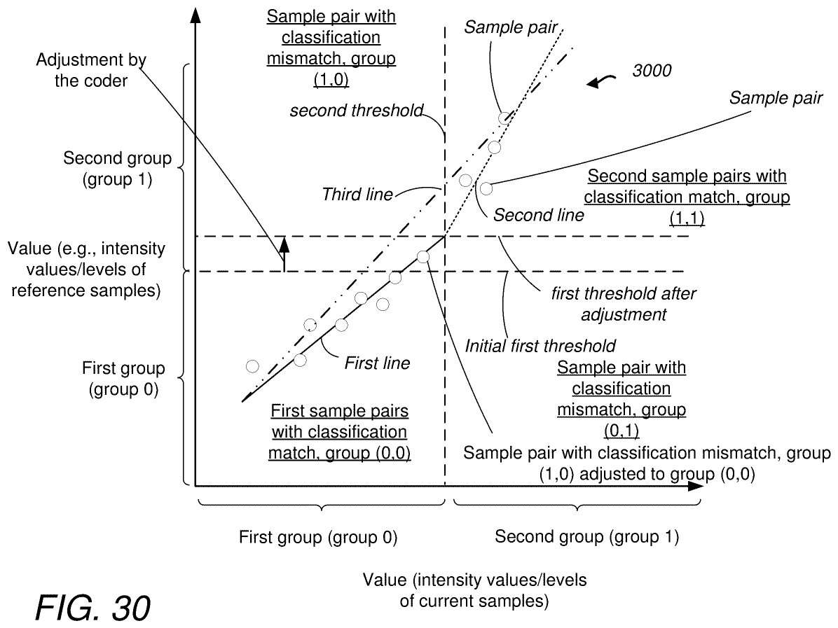

In some embodiments, the coder (e.g., encoder 200, decoder 300) determines (e.g., generates) the histograms 2810, 2850. In some embodiments, the coder determines the first threshold for classifying the reference samples and the second threshold for classifying the current samples. As will be described later in this disclosure, in some embodiments, the coder adjusts the first threshold to reduce the number of sample pairs with classification mismatch. For example, as shown in FIG. 30, in some embodiments, the coder adjusts the first threshold while the second threshold remains un-changed.

As discussed above, in some embodiments, the coder determines (e.g., derives) a single filter (e.g., filter based on the filter model in equation 19 with defined or determined parameters and offset) based on sample pairs of un-classified reference samples and un-classified current and determines (e.g., generates) a prediction block by applying the determined single filter to the reference block. In embodiments, the coder applies the determined single filter to gradients (e.g., derivatives) of reference block to generate the prediction block. In some embodiments, the coder applies the determined single filter to second-order derivatives of reference block to generate the prediction block. In some embodiments, the coder applies the determined single filter to any combination of the reference block (samples), the gradients (e.g., derivatives) of the reference block (samples), and the second-order derivatives of the reference block (samples) to generate the prediction block.

As discussed, in some embodiments, the single filter includes a linear function. In some embodiments, the single filter is a non-linear filter (e.g., filter including a non-linear function discussed above). In some embodiments, the coder uses a one-tap filter model (e.g., one-tap filter model 1718) to collect samples to determine (e.g., to calculate or to derive) parameters (e.g., scale α, offset β for a linear filter) associated with the single filter. In some embodiments, the coder uses a multiple-tap filter model (e.g., cross-shaped 5-tap filter model 1818, x-cross shaped 5-tap filter model 1820, 3×3 square-shaped 9-tap filter model 1822, etc.) to collect samples to derive parameters (e.g., offset, coefficients such as coefficient ai) associated with the single filter.

In some embodiments, the coder determines (e.g., derives) a plurality of filters. For example, the coder determines a first filter based on sample pairs of reference samples in the first group (also referred to as group 0) and corresponding current samples (e.g., corresponding current samples in the first group (group 0), corresponding current samples in the second group (group 1) and a second filter based on sample pairs of reference samples in the second group (also referred to as group 1) and corresponding current samples (e.g., corresponding current samples in the first group (group 0), corresponding current samples in the second group (group 1)).

In some embodiments, each sample pair for the first filter includes the reference sample in the first group and the corresponding current sample that are relatively collocated (e.g., located at the same relative position within their respective templates). In some embodiments, each sample pair for the second filter includes the reference sample in the second group and the corresponding current sample that are relatively collocated (e.g., located at the same relative position within their respective templates).

In some embodiments, the coder determines (e.g., derives) a plurality of filters based on sample pairs of the reference samples and the current samples that belong to the same group. For example, in some embodiments, the coder determines a first filter based on sample pairs of reference samples in the first group (also referred to as group 0) and corresponding current samples in the first group (also referred to as group 0) and determines a second filter based on sample pairs of reference samples in the second group (also referred to as group 1) and corresponding current samples in the second group (also referred to as group 1). In other words, in this example, each of sample pairs for the first filter includes the reference sample in the first group and the corresponding current sample in the first group that are relatively collocated (e.g., located at the same relative position within their respective templates). In this example, each of sample pairs for the second filter includes the reference sample in the second group and the corresponding reference sample in the second group that are relatively collocated (e.g., located at the same relative position within their respective templates).

In some embodiments, the coder determines each of the plurality of filters (e.g., first filter, second filter) similar to the single filter discussed above (e.g., paragraph [0258], paragraph [0259]). However, unlike the single filter, which is determined based on un-classified samples, the coder determines the plurality of filters (e.g., first filter, second filter) based on classified samples (e.g., classified reference samples, classified current samples) discussed above. Based on the plurality of filters, the coder generates the prediction block. For example, the coder applies the first filter to samples in a first group of the reference block to generate a first samples (e.g., first portion) of the prediction block. Likewise, the coder applies the second filter to samples in a second group of the reference block to generate a second samples (e.g., second portion) of the prediction block.

As discussed, the coder is configured to determine (e.g., derive) the plurality of the filters (e.g., first filter, second filter) based on sample pairs with similar characteristics (e.g., similar intensity values based on the thresholds), and the coder is configured to generate the prediction block by applying the plurality of the filters to corresponding samples in the reference block. As a result, the coder determines the prediction block with fewer prediction errors based on the plurality of filters than prediction errors based on the single filter.

As shown in some embodiments, the coder determines (e.g., adjusts) the first threshold to reduce the number of sample pairs with classification mismatch. This includes cases where a reference sample in the first group pairs with a corresponding current sample in the second group, and vice versa (i.e., a reference sample in the second group pairs with a corresponding current sample in the first group)-situations where a reference sample classified into one group pairs with a corresponding current sample classified into a different group. As a result of adjusting the first threshold, the coder determines (e.g., derives) the plurality of filters based on more sample pairs with similar characteristics (e.g., similar intensity values based on the adjusted first threshold). In some embodiments, the coder adjusts the first threshold for the reference samples, however, the coder does not adjust the second threshold. In other words, the second threshold is unchanged in this example. As a result, the coder can generate the prediction block with fewer prediction errors.

As shown in FIG. 28, in some embodiments, the coder determines the first threshold and the second threshold having the same value (e.g., same intensity value/level). Accordingly, in this example, the coder classifies the reference samples and the current samples based on the same threshold. In some embodiments, the coder determines the first threshold and the second threshold that are different from each other. In some embodiments, when the first threshold and the second threshold are different from each other, the coder classifies the reference samples based on the first threshold and the current samples based on the second threshold different from the first threshold.

In some embodiments, the coder determines the first threshold based on an average value of the reference samples (e.g., average intensity value of the reference samples). In some embodiments, the coder determines the first threshold based on an average value based on the lowest value of the reference samples and the greatest value of the reference samples (e.g., average intensity value based on the lowest intensity value of the reference samples and the greatest intensity value of the reference samples). In some embodiments, the coder determines the first threshold based on the Otsu's algorithm (e.g., calculating the first threshold by applying the Otsu's algorithm to the reference samples). In other words, in some embodiments, the coder determines the first threshold that results in a minimum intra-class intensity variance when the first threshold is applied to the reference samples. In some embodiments, the coder determines the first threshold that results in a maximum inter-class intensity variance when the first threshold is applied to the reference samples. As discussed, in some embodiments, the coder further determines (e.g., adjusts) the first threshold to reduce the number of sample pairs with classification mismatch.

In some embodiments, the coder determines the second threshold based on an average value of the current samples (e.g., average intensity value of the current samples). In some embodiments, the coder determines the second threshold based on an average value based on the lowest value of the current samples and the greatest value of the current samples (e.g., average intensity value based on the lowest intensity value of the current samples and the greatest intensity value of the current samples). In some embodiments, the coder determines the second threshold based on the Otsu's algorithm (e.g., calculating the second threshold by applying the Otsu's algorithm to the current samples). In other words, in some embodiments, the coder determines the second threshold that results in a minimum intra-class intensity variance when the second threshold is applied to the current samples. In some embodiments, the coder determines the second threshold that results in a maximum inter-class intensity variance when the second threshold is applied to the current samples.

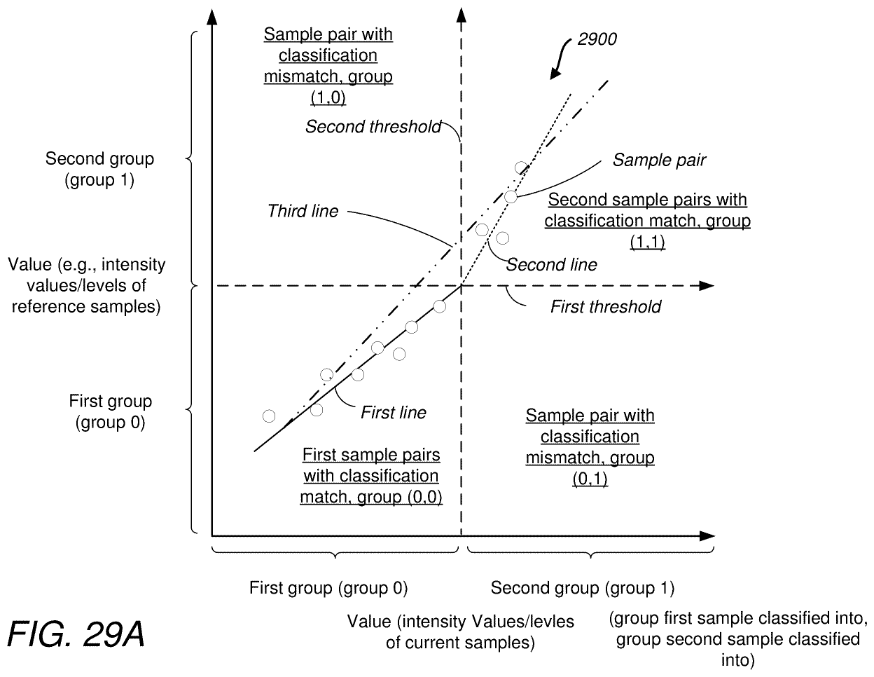

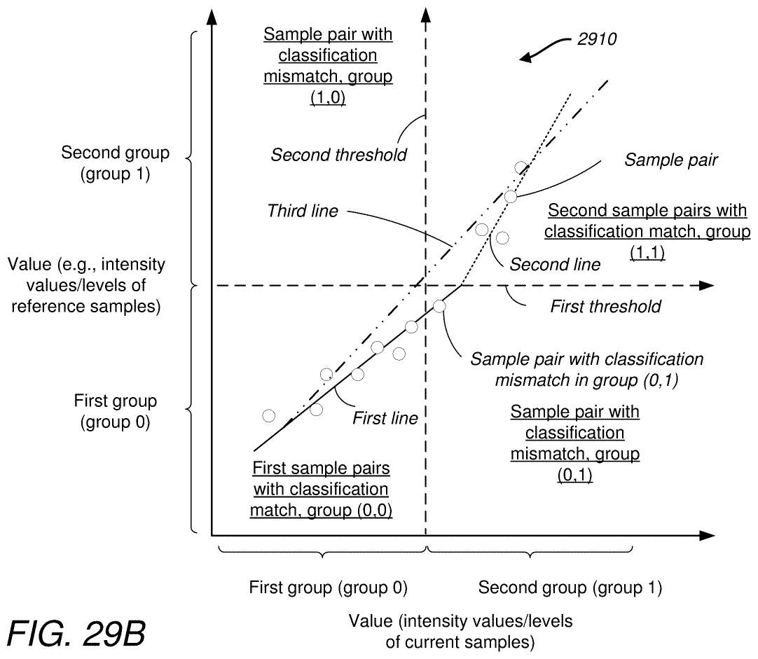

FIG. 29A shows an example graph 2900 illustrating a plurality of sample pairs (with classification match), a first threshold for classifying reference samples of the sample pairs, and a second threshold for classifying current samples of the sample pairs according to some embodiments.

A reference sample and its corresponding current sample (e.g., reference sample and corresponding current sample) form a sample pair with classification match when both the reference sample and the corresponding current sample in the sample pair are classified into the same group (e.g., sample pair classified into the group (0, 0), sample pair classified into the group (1, 1)) by the first and second thresholds. In the present disclosure, ‘M’ in the group (M, N) represents the group to which the reference sample of the sample pair is classified by the first threshold, and ‘N’ in the group (M, N) represents the group to which the current sample of the same sample pair is classified by the second threshold.

For example, eight sample pairs on the left side of the graph 2900 (“first sample pairs” in the graph 2900) are sample pairs with classification match since the reference sample and the current sample of each of the “first sample pairs” are classified into the group (0, 0) with classification match. Likewise, four sample pairs on the right side of the graph 2900 (“second sample pairs” in the graph 2900) are sample pairs with classification match since the reference sample and the current sample of each of the “second sample pairs” are classified into the group (1, 1) with classification match.

A reference sample and its corresponding current sample (e.g., reference sample and current sample corresponding to each other) form a sample pair with classification mismatch when the reference sample classified into one group by the first threshold pairs with the corresponding current sample classified into a different group by the second threshold (e.g., sample pair classified into the group (0, 1), sample pair classified into the group (1, 0).

In some embodiments, each of the sample pairs includes a reference sample and a corresponding current sample (e.g., reference sample and current sample corresponding to each other) that are relatively collocated. For instance, the reference sample and the corresponding current sample are relatively collocated when they are located at the same relative position within their respective templates (e.g., matching of relative position within the template of the reference block for a reference sample and relative position within template of the current block for a current sample).

As shown, in this example, based on the first and second thresholds, the coder classifies twelve sample pairs into four groups. Eight sample pairs are classified into the group (0, 0) with classification match, and four sample pairs are classified into the group (1, 1) with classification match. Notably, there are no sample pairs classified into the group (0, 1) with classification mismatch, and similarly, there are no sample pairs classified into the group (1, 0) with classification mismatch. In this example, the first threshold and the second threshold are the same. However, in some examples, the first threshold and the second threshold are not the same. For example, the first threshold may be greater than the second threshold, or the second threshold may be greater than the first threshold.

As shown, in some embodiments, based on the eight sample pairs in the group (0, 0) with classification match, the coder determines (e.g., derives) a first filter (which is represented by a first line). As shown, in some embodiments, based on the four sample pairs in the group (1, 1) with classification math, the coder determines (e.g., derives) a second filter (which is represented by a second line). In this example, the coder determines the filters (e.g., first filter, second filter) based on the sample pairs with classification match. However, as will be explained later in the disclosure, in some embodiments, the coder determines the filters (e.g., first filter in FIG. 29B) based on the sample pairs with classification match and the sample pairs with classification mismatch.

On the other hand, as shown, based on the existing technologies, the coder may determine (e.g., derive) the single filter based on un-classified twelve sample pairs. As shown, the single filter is represented by a third line, which is linear. Since a combination of the first line and the second line represents the sample pairs much closely than the third line does alone, comparing to the single filter, a combination of the first filter and the second filter provides better outcomes (e.g., fewer prediction errors) when the coder applies the combination of the first filter and the second filter to the reference block for generating the prediction block.

As shown, in this example, the first line and the second line are linear based on the first filter (first filter based on a linear filter model in this example) and the second filter (second filter based on a linear filter model in this example). However, the present disclosure does not limit that the first line and the second line are linear. For example, in some embodiments, the first filter is based on a non-linear filter model (e.g., filter model including a non-linear function). As a result, the first line may be a non-linear line in some embodiments. In some embodiments, the second filter is based on a non-linear filter model (e.g., filter model including a non-linear function). As a result, the second line may be a non-linear line in some embodiments. In the existing technologies, the third line, which represents the single filter, is always linear. As a result, the existing technologies have severe limitations in representing sample pairs when the sample pairs are not formed in a linear manner. As a result, the prediction block, generated based on applying the single filter to the reference block, may exhibit more prediction errors. Additionally, existing technologies do not classify the reference samples and the current samples of the sample pairs based on a plurality of thresholds (e.g., first threshold, second threshold).

As shown, the first threshold and the second threshold are the same in FIG. 29A. However, as discussed, the first threshold and the second threshold may be different from each other. As will be described later in this disclosure (e.g., FIG. 30), in some embodiments, the coder adjusts the first threshold to reduce the number of sample pairs with classification mismatch.

For example, the coder may classify a reference sample of a sample pair into the second group (group 1) based on the first threshold but may also classify a current sample of the same sample pair into the first group (group 0) based on the second threshold, resulting in the sample pair in the group (1, 0) with classification mismatch in this example. In response to determining the sample pair with classification mismatch, in some embodiments, the coder determines (e.g., adjusts) the first threshold. In this example, the coder may increase the first threshold. As a result, the coder classifies (e.g., re-classifies) the sample pair into the group (0, 0) with classification match.

Similarly, in some embodiments, the coder classifies a reference sample of a sample pair into the first group (group 0) based on the first threshold but may also classify a current sample of the same sample pair into the second group (group 1) based on the second threshold, resulting in the sample pair in the group (0, 1) with classification mismatch. In response to determining the sample pair with classification mismatch, in some embodiments, the coder determines (e.g., adjusts) the first threshold. In this example, the coder may decrease the first threshold. As a result, the coder classifies (e.g., re-classifies) the sample pair into the group (1, 1) with classification match.

FIG. 29B shows an example graph 2910 illustrating a plurality of sample pairs (including eleven sample pairs with classification match and one sample pair with classification mismatch), a first threshold for classifying reference samples of the sample pairs, and a second threshold for classifying current samples of the sample pairs according to some embodiments.

As discussed, a reference sample and its corresponding current sample (e.g., reference sample and current sample corresponding to each other) form a sample pair with classification match when both the reference sample of the sample pair and the corresponding current sample in the same sample pair are classified into the same group (e.g., sample pair classified into the group (0, 0), sample pair classified into the group (1, 1) by the first threshold and the second threshold.

For example, seven sample pairs on the left side of the graph 2910 (“first sample pairs” in the graph 2910) are sample pairs with classification match since the reference sample and the current sample of each of the “first sample pairs” are classified into the group (0, 0). Likewise, four sample pairs on the right side of the graph 2910 (“second sample pairs” in the graph 2910) are sample pairs with classification match since the reference sample and the current sample of each of the “second sample pairs” are classified into the group (1, 1).

As discussed, a reference sample and its corresponding current sample (e.g., reference sample and current sample corresponding to each other) form a sample pair with classification mismatch when the reference sample classified into one group by the first threshold pairs with the corresponding current sample classified into a different group by the second threshold (e.g., sample pair classified into the group (0, 1), sample pair classified into the group (1, 0)). As shown, one sample pair between the seven sample pairs (“first sample pairs”) and the four sample pairs of the graph 2910 (“second sample pairs”) is a sample pair with classification mismatch since the reference sample of the sample pair and the current sample of the same sample pair are classified into different groups, resulting in the sample pair in the group (0, 1) with classification mismatch.

In this example, as shown, the coder classifies twelve sample pairs into four groups. As illustrated in FIG. 29B, seven sample pairs (on the left in the graph 2910) are classified into the group (0, 0) with classification match, four sample pairs (on the right in the graph 2910) into the group (1, 1) with classification match, one sample pair into the group (0, 1) with classification mismatch, and there are no sample pairs classified into the group (1, 0) with classification mismatch. As shown, the classification is based on the first threshold and the second threshold. In this example, the first threshold and the second threshold are not the same.

As shown, in some embodiments, the coder determines (e.g., derives) a first filter based on sample pairs having reference samples that are classified into the first group (group 0) by the first threshold and a second filter based on sample pairs having reference samples that are classified into the second group (group 1) by the first threshold. As a result, in this example, the coder determines the first filter based on the seven sample pairs in the group (0, 0) with classification match and the one sample pair in group (0, 1) with classification mismatch. In this example, the coder determines the second filter based on the four sample pairs in group (1, 1) with classification match. In some embodiments, if there is one or more sample pairs in the group (1, 0) with classification mismatch, the coder determines the second filter based on the four sample pairs in the group (1, 1) with classification match and the one more sample pair in group (1, 0) with classification mismatch.

On the other hand, as discussed, based on the existing technologies, the coder may determine (e.g., derive) the single filter, based on un-classified sample pairs. As shown, the single filter is represented by a third line, that is linear. Since a combination of the first line and the second line represents the sample pairs much closely than the third line does alone, comparing to the single filter, a combination of the first filter and the second filter provides better outcomes (e.g., fewer prediction errors) when the coder applies the combination of the first filter and the second filter to the reference block for generating the prediction block.

As shown, in this example, the first line and the second line are linear based on the first filter (first filter based on a linear filter model in this example) and the second filter (second filter based on a linear filter model in this example). However, the present disclosure does not limit that the first line and the second line are linear. For example, in some embodiments, the first filter is based on a non-linear filter model (e.g., filter model including a non-linear function). As a result, the first line may be a non-linear line in some embodiments. In some embodiments, the second filter is based on a non-linear filter model (e.g., filter model including a non-linear function). As a result, the second line may be a non-linear line in some embodiments. In the existing technologies, the third line, which represents the single filter, is always linear. As a result, the existing technologies have severe limitations of representing the sample pairs when the sample pairs are not formed in a linear form. As a result, the prediction block, generated based on applying the single filter to the reference block, is likely to have more prediction errors. In addition, the existing technologies do not classify the reference samples and the current samples based on the plurality of thresholds (e.g., first threshold, second threshold).

As shown, the first threshold and the second threshold are not the same in FIG. 29B. However, as discussed, the first threshold and the second threshold may be the same. As will be described later in this disclosure (e.g., FIG. 30), in some embodiments, the coder adjusts the first threshold to reduce the number of sample pairs with classification mismatch.

As explained above, exiting technologies have many shortcomings. For example, in the existing technologies, the coder does not classify sample pairs with a plurality of thresholds. In addition, the coder does not adjust the first threshold (e.g., a plurality of first thresholds) to reduce the number of sample pairs with classification mismatch. As a result, in the existing technologies, the coder is likely to generate the prediction block with more prediction errors than the prediction block generated by the methods described in the present disclosure.

Embodiments of the present disclosure are directed to improving the plurality of filters that may be used to generate the prediction block with fewer prediction errors.

In some embodiments, a method includes classifying, based on a first threshold, reference samples neighboring a reference block into a plurality of groups, the plurality of groups including a first group and a second group. The method includes classifying, based on a second threshold, current samples neighboring a current block into a plurality of groups, the plurality of groups including a first group and a second group. The method also includes determining sample pairs with classification mismatch. The method further includes adjusting the first threshold to reduce a number of sample pairs with classification mismatch.

FIG. 30 shows an example graph 3000 illustrating a plurality of sample pairs, a first threshold (e.g., initial first threshold, adjusted first threshold) for classifying reference samples of the sample pairs, and a second threshold for classifying current samples of the sample pairs according to some embodiments.

As shown, in some embodiments, the coder adjusts the first threshold to reduce the number of sample pairs with classification mismatch.

As discussed, in some embodiments, the coder determines the first threshold and the second threshold to classify the reference samples and the current samples of the sample pairs. As shown in FIG. 30, in some examples, the coder may classify one or more sample pairs into one or more groups with classification mismatch (e.g., group (1, 0) with classification mismatch, group (0, 1) with classification mismatch). As shown, in this example, the coder classifies seven sample pairs into the group (0, 0) with classification match, four sample pairs into the group (1, 1) with classification match, one sample pair into the group (1, 0) with classification mismatch, and zero sample pair into group (0, 1) with classification mismatch based on the initial first threshold and the second threshold.

In some embodiments, when the coder determines that the number of the sample pairs with classification mismatch is equal to or above a predetermined number, the coder adjusts the first threshold to a value (e.g., intensity value) that produces the least number of the sample pairs with classification mismatch.

In some embodiments, to determine the first threshold that results the least number of the sample pairs with classification mismatch, the coder tries all the values (e.g., intensity values/levels) within the range of the reference samples as the first threshold and adjust the first threshold based on the value that produces the least number of the sample pairs with classification mismatch.

In some embodiments, to determine the first threshold that results the least number of the sample pairs with classification mismatch, the coder tries some of the values within the range of the reference samples (e.g., trying every 2^{nd} value within in the range for the reference samples, every 3^{rd} value within in the range for the reference samples, every Nth value within in the range for the reference samples) as the first threshold and adjust the first threshold based on the value that produces the least number of the sample pairs with classification mismatch.

In some embodiments, to determine the first threshold that results the least number of the sample pairs with classification mismatch, the coder tries some of the values within the range of the reference samples (e.g., trying values neighboring the initial first threshold within a predetermined range such (initial first threshold−2), (initial first threshold−1), (initial first threshold+1), (initial first threshold+2) as the first threshold and adjust the first threshold based on the value that produces the least number of the sample pairs with classification mismatch.

As a result, as shown, the coder classifies (e.g., re-classifies) the sample pair with classification mismatch so that the sample pair with classification mismatch is re-classified into the group (0, 0) with classification match.

As shown, based on the eight sample pairs (which includes the re-classified sample pair) in the group (0, 0), the coder determines (e.g., derives) the first filter (which is represented by the first line). As shown, based on the four sample pairs in the group (1, 1), the coder derives or determines the second filter (which is represented by the second line). As shown, by adjusting the first threshold, the coder can determine the first filter and the second filter based on more relevant sample pairs. As a result, the coder can generate the prediction block with fewer prediction errors.

As shown in FIG. 30, the coder adjusts the first threshold to reduce the number of sample pairs with classification mismatch. In some cases, even after the adjustment to the first threshold, in some circumstances, the sample pairs with classification mismatch still exist. In some embodiments, the coder determines the first filter and the second filter based on sample pairs with classification match and sample pairs with classification mismatch as described in FIG. 29B.

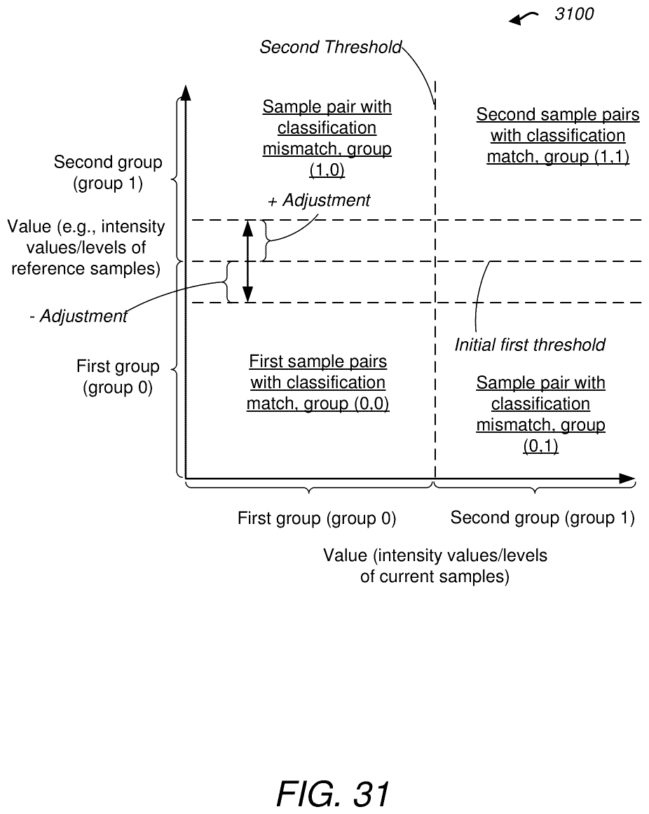

FIG. 31 illustrates a first threshold determined by the coder (e.g., initial first threshold, adjusted first threshold) and a second threshold determined by the coder according to some embodiments.

As discussed, the coder determines the first threshold (e.g., initial first threshold, adjusted first threshold) to classify the reference samples of the sample pairs into a plurality of groups (e.g., first group, second group) in some embodiments. As discussed, the coder determines the second threshold to classify the current samples of the sample pairs into a plurality of groups (e.g., first group, second group) in some embodiments.

As discussed, in some embodiments, the coder adjusts the first threshold to reduce the number of sample pairs with classification mismatch. As discussed, each of the sample pairs includes a reference sample and a corresponding current sample (e.g., reference sample and current sample corresponding to each other) that are relatively collocated. For instance, the reference sample and the corresponding current sample are relatively collocated when they are located at the same relative position within their respective templates (e.g., matching of relative position within the template of the reference block for a reference sample and relative position within template of the current block for a current sample).

As shown, in some embodiments, the coder increases the first threshold (e.g., first threshold with + adjustment) to reduce the number of sample pairs with classification mismatching. As shown, in some embodiments, the coder decreases the first threshold (e.g., first threshold with − adjustment) to reduce the number of sample pairs with classification mismatching.

As shown, in this example, there is one first threshold that is being adjustable by the coder and one second threshold. However, the present disclosure does not limit the number of first thresholds (e.g., adjustable first thresholds). Also, the present disclosure does not limit the number of the second thresholds. For example, in some embodiments, the coder adjusts a plurality of first thresholds (e.g., first first threshold, second first threshold) to reduce the number of the number of sample pairs with classification mismatch. In some embodiments, the coder adjusts the first first threshold and the second first threshold by the same adjustment value. In some embodiments, the coder adjusts the first first threshold by a first adjustment value and adjusts the second first threshold by a second adjustment value different from the first adjustment value.

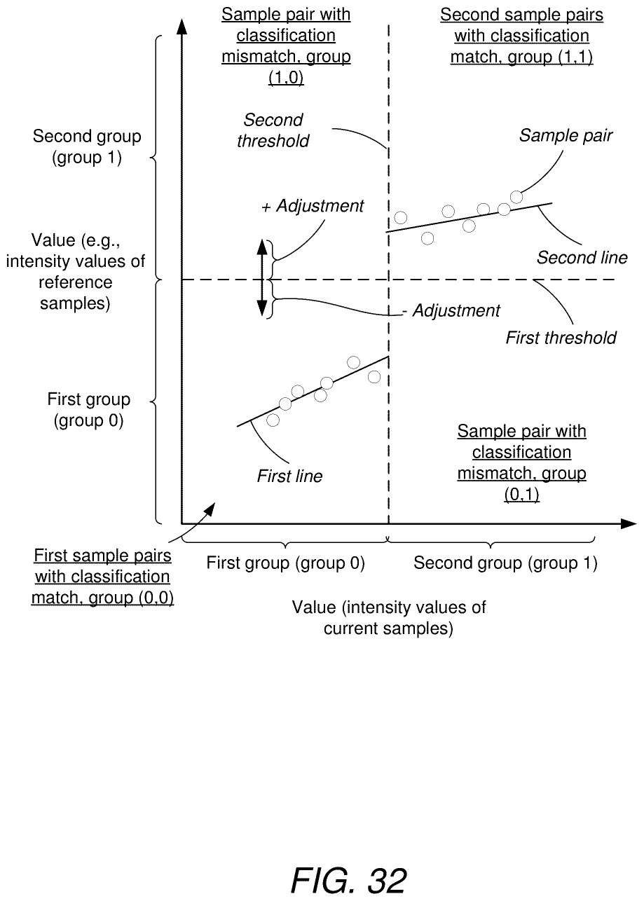

FIG. 32 illustrates a first line representing a first filter and a second line representing a second filter where the first line and the second line are not connected (e.g., non-continuous lines) according to some embodiments.

As discussed, in some embodiments, the coder classifies the sample pairs of the reference samples and the current samples into a plurality of groups (e.g., group (0, 0) with classification match, group (1, 1) with classification match, group (1, 0) with classification mismatch, group (0, 1) with classification mismatch in this example). In this example, the coder classifies the sample pairs into the group (0, 0) with classification match and the group (1, 1) with classification match.

As discussed, in some embodiments, the coder determines (e.g., derives) the first filter (which is represented by the first line) based on the sample pairs in the group (0, 0) with classification match. Likewise, in some embodiments, the coder determines (e.g., derives) the second filter (which is represented by the second line) based on the sample pairs in the group (1.1) with classification match.

As discussed, in some embodiments, the coder determines (e.g., derives) the first filter (which is represented by the first line) based on the sample pairs in the group (0, 0) with classification match and sample pairs in the group (0, 1) with classification mismatch (if any). Likewise, in some embodiments, the coder determines (e.g., derives) the second filter (which is represented by the second line) based on the sample pairs in the group (1, 1) with classification match and sample pairs in the group (1, 0) with classification mismatch (if any).

As shown, in this example, the first line and the second line are linear. However, the present disclosure does not limit that the first line and the second line are linear. In some embodiments, the first filter includes a non-linear function. As a result, the first line is non-linear in some embodiments. In some embodiments, the second filter includes a non-linear function. As a result, the second is non-linear in some embodiments.

As shown, in this example, unlike the example shown in graph 3000 of FIG. 30, the first line and the second line are non-continuous. In other words, in some embodiments, the first line and the second line are apart from each other.

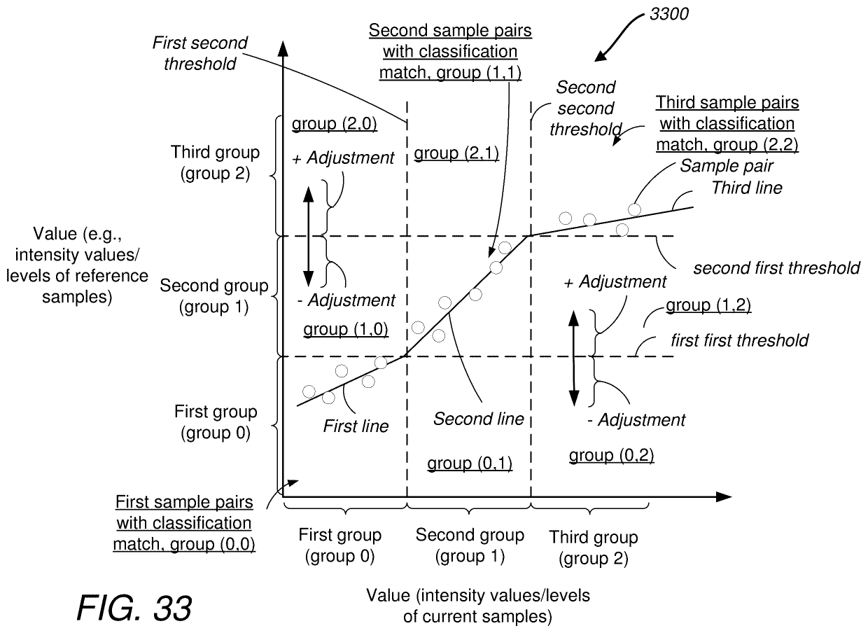

FIG. 33 illustrates a plurality of first thresholds (e.g., first first threshold determined by the coder, second first threshold determined by the coder) for classifying first samples of sample pairs and a plurality of second thresholds (e.g., first second threshold determined by the coder, second second threshold determined by the coder) for classifying current samples of the sample pairs according to some embodiments.

As shown in this example, the coder classifies fifteen sample pairs into nine groups (e.g., group (0, 0) with classification match, group (1, 1) with classification match, group (2,2) with classification match, group (0, 1) group with classification mismatch, group (0,2) with classification mismatch, group (1, 0) with classification mismatch, group (1,2) with classification mismatch, group (2,0) with classification mismatch, group (2,1) with classification mismatch) based on the plurality of first thresholds and the plurality of second thresholds.

As shown, in some embodiments, the coder adjusts the plurality of first thresholds (one or more first threshold) to reduce the number of sample pair with classification mismatch. In some embodiments, the coder adjusts one of the first thresholds. In some embodiments, the coder adjusts more than one first threshold. In some embodiments, the coder adjusts all of the first thresholds. In some embodiments, the coder adjusts the first thresholds such that each of the first thresholds is adjusted independent from each other. For first example, the coder adjusts the first first threshold by a first adjustment value and adjusts the second first threshold by a second adjustment value which is different from the first adjustment value to reduce the number of sample pairs with classification mismatch. In some embodiments, the coder adjusts the first thresholds by the same adjustment value.

As shown, based on five sample pairs in the group (0, 0), the coder determines (e.g., derives) a first filter (which is represented by a first line). As shown, based on the six sample pairs in the group (1, 1), the coder determines (e.g., derives) a second filter (which is represented by a second line). As shown, based on the four sample pairs in the group (2,2), the coder determines (e.g., derives) a third filter (which is represented by a third line). In this example, the first line, the second line, and the third line are connected-forming a continuous line. However, the present disclosure does not limit that the lines (first line, second line, and third line in this example) are connected to each other. For example, in some embodiments, the first line, the second line, and the third line are apart from each other.

In some embodiments, the coder classifies samples in the reference block into the plurality of reference blocks (e.g., first reference block, second reference block, third reference block in this example) based on the first thresholds (e.g., first first threshold, second first threshold). In some embodiments, the coder generates a first portion of the prediction block by applying the first filter to first reference samples in the reference block, the coder generates a second portion of the prediction block by applying the second filter to second reference samples in the reference block, and the coder generates a third portion of the prediction block by applying the third filter to third reference samples in the reference block.

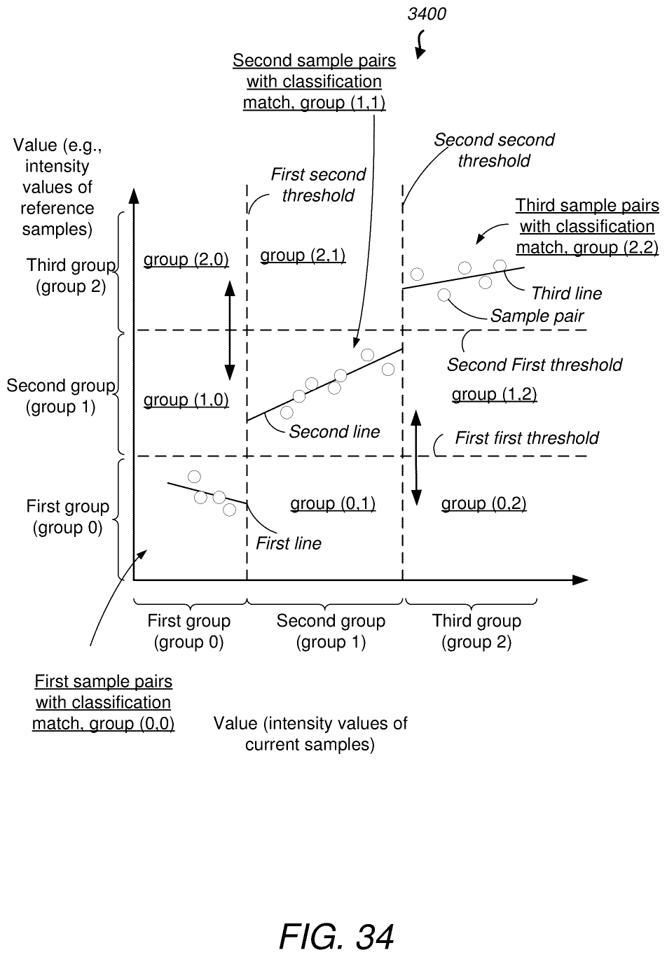

FIG. 34 illustrates a first line representing a first filter, a second line representing a second filter, and a third line representing a third filter where the first line, the second line, and the third line are apart from each other (e.g., non-continuous lines) according to some embodiments.

As discussed, in some embodiments, the coder classifies the sample pairs into the plurality of groups (e.g., group (0, 0) with classification match, group (1, 1) with classification match, group (2,2) with classification match, group (0, 1) with classification mismatch, group (0,2) with classification mismatch, group (1, 0) with classification mismatch, group (1,2) with classification mismatch, group (2,0) with classification mismatch, group (2,1) with classification mismatch).

As shown, in some embodiments, the coder determines (e.g., derives) the first filter (which is represented by the first line) based on the sample pairs in the group (0, 0). Likewise, in some embodiments, the coder determines (e.g., drives) the second filter (which is represented by the second line) based on the sample pairs in the group (1, 1). Also, in some embodiments, the coder determines (e.g., drives) the third filter (which is represented by the third line) based on the sample pairs in the group (2,2).

In some embodiments, the coder determines (e.g., derives) the first filter (which is represented by the first line) based on the sample pairs in the group (0, 0), group (0, 1), and group (0,2). Likewise, in some embodiments, the coder determines (e.g., drives) the second filter (which is represented by the second line) based on the sample pairs in the group (1, 0), group (1, 1), and group (1,2). Also, in some embodiments, the coder determines (e.g., drives) the third filter (which is represented by the third line) based on the sample pairs in the group (2,0), group (2,1), and group (2,2).

As shown, in this example, the first line, the second line, and the third line are linear. However, the present disclosure does not limit that the first line, the second line, and the third line are linear. For example, in some embodiments, the first filter includes a non-linear function. As a result, the first line is non-linear in some embodiments. In some embodiments, the second filter includes a non-function. As a result, the second line is non-linear in some embodiments. In some embodiments, the third filter includes a non-linear function. As a result, the third line is non-linear.

As shown, in this example, unlike the example shown in FIG. 33, the first line, second line, third line are not connected to each other (e.g., non-continuous lines). In other words, in some embodiments, the first line representing the first filter, the second line representing the second filter, and the third line representing the third filter are apart from each other. In some embodiments, the first line and the second line are connected, and the third line is apart from the first line and the second line. In some embodiments, the second line and the third line are connected, and the first line is apart from the second line and the third line.

As shown, the coder may adjust at least one of the first thresholds to reduce sample pairs in groups with classification mismatch (sample pairs in the group (0, 1), group (0,2), group (1, 0), group (1,2), group (2,0), and group (2,1) in this example).

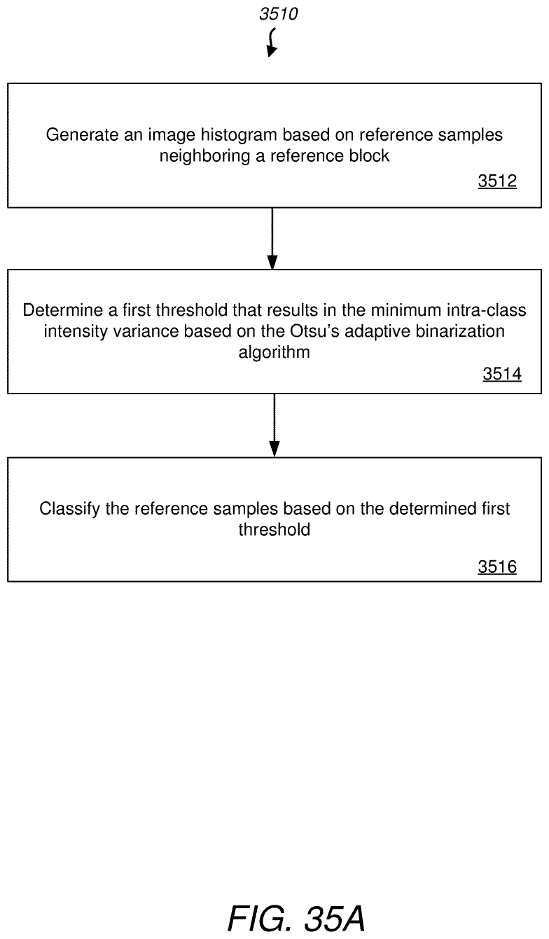

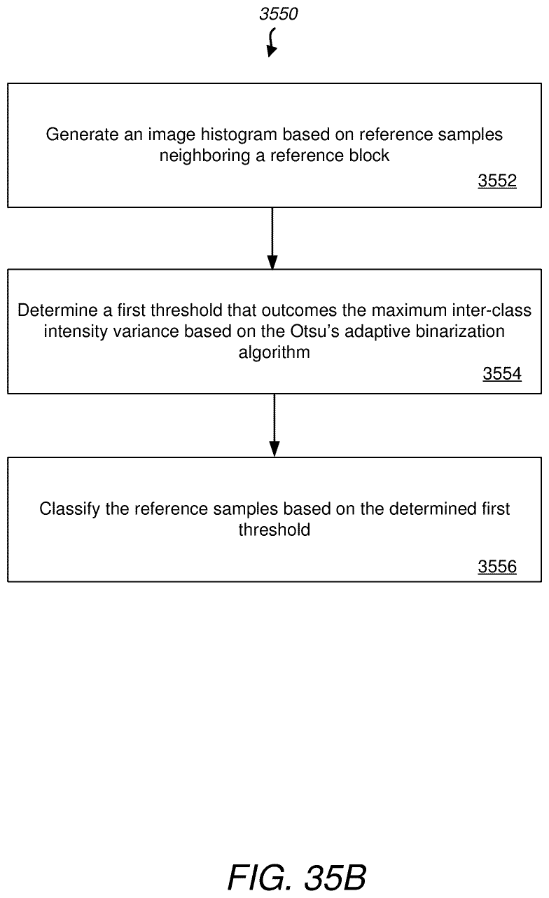

FIG. 35A shows a flowchart of an example method 3510 for determining a first threshold for classifying reference samples according to some embodiments. The method 3510 may be performed by a coder (e.g., encoder, decoder) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At operation 3512, the coder generates an image histogram based on the reference samples neighboring a reference block.

At operation 3514, the coder determines the first threshold (e.g., threshold that is used to classify the reference samples into a plurality of groups (e.g., first group, second group)) that results in (e.g., has an outcome of) the minimum intra-class intensity variance when the first threshold is applied to the reference samples in the image histogram. In some embodiment, the coder determines the first threshold that outcomes the minimum intra-class intensity variance based on the Otsu's adaptive binarization algorithm disclosed by Nobuyuki Otsu in “[a] threshold selection method from gray-level histograms,” IEEE Transactions on Systems, Man, and Cybernetics. 9 (1): 62-66 (1979), which is hereby incorporated by reference in its entirety.

At operation 3516, the coder classifies the reference samples based on the determined first threshold into the plurality of groups. For example, the coder classifies the reference samples into the first group (also referred to as group 0) and the second group (also referred to as group 1).

FIG. 35B shows a flowchart of an example method 3550 for determining a first threshold for classifying reference samples according to some embodiments. The method 3550 may be performed by a coder (e.g., encoder, decoder) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At operation 3552, the coder generates an image histogram based on reference samples neighboring a reference block.

At operation 3554, the coder determines the first threshold (e.g., threshold that is used to classify the reference samples into a plurality of groups (e.g., first group, second group)) that outcomes the maximum inter-class intensity variance when the first threshold is applied to the reference samples in the image histogram. In some embodiment, the coder determines the first threshold that outcomes the maximum inter-class intensity variance based on the Otsu's adaptive binarization algorithm disclosed by Nobuyuki Otsu in “[a] threshold selection method from gray-level histograms,” IEEE Transactions on Systems, Man, and Cybernetics. 9 (1): 62-66 (1979), which is hereby incorporated by reference in its entirety.

At operation 3556, the coder classifies the reference samples based on the determined first threshold into the plurality of groups. For example, the coder classifies the first samples into the first group (also referred to as group 0) and the second group (also referred to as group 1).

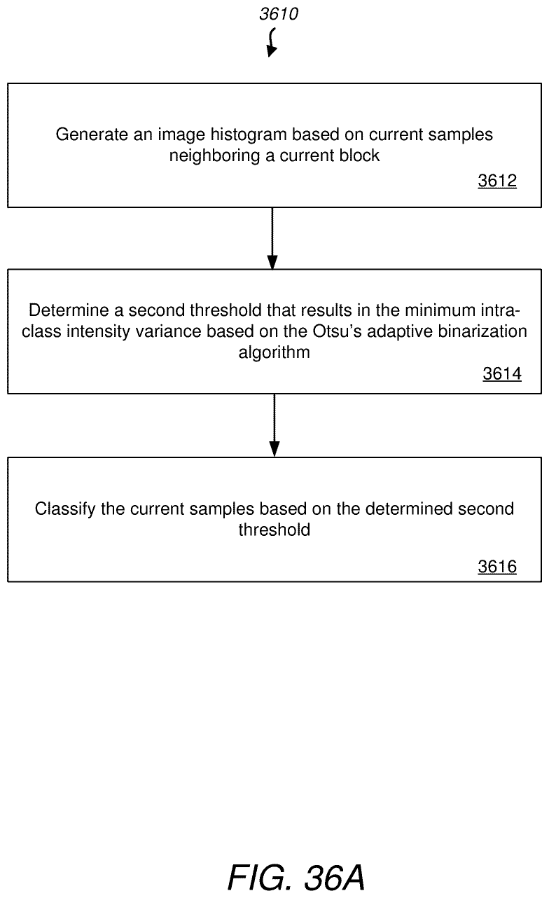

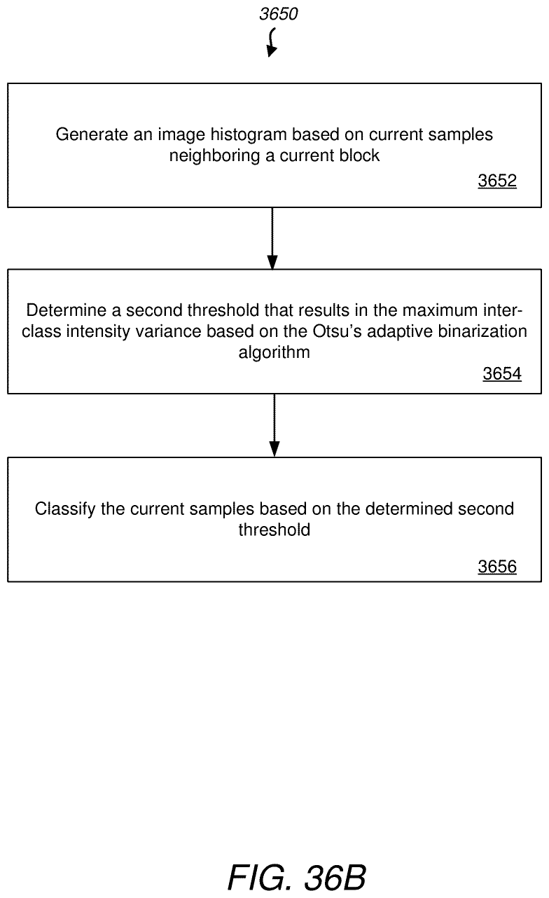

FIG. 36A shows a flowchart of an example method 3610 for determining a second threshold for classifying current samples according to some embodiments. The method 3610 may be performed by a coder (e.g., encoder, decoder) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At operation 3612, the coder generates an image histogram based on current samples neighboring the current block.

At operation 3614, the coder determines the second threshold (e.g., threshold that is used to classify the current samples into a plurality of groups (e.g., first group, second group) that results in (e.g., with an outcome of) the minimum intra-class intensity variance when the second threshold is applied to the current samples in the image histogram. In some embodiment, the coder determines the second threshold that outcomes the minimum intra-class intensity variance based on the Otsu's adaptive binarization algorithm disclosed by Nobuyuki Otsu in “[a] threshold selection method from gray-level histograms,” IEEE Transactions on Systems, Man, and Cybernetics. 9 (1): 62-66 (1979), which is hereby incorporated by reference in its entirety.

At operation 3616, the coder classifies the current samples based on the determined second threshold into the plurality of groups. For example, the coder classifies the current samples into the first group (also referred to as group 0) and the second group (also referred to as group 1).

FIG. 36B shows a flowchart of an example method 3650 for determining a second threshold for classifying current samples according to some embodiments. The method 3650 may be performed by a coder (e.g., encoder, decoder) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At operation 3652, the coder generates an image histogram based on the current samples neighboring a current block.

At operation 3654, the coder determines the second threshold (e.g., threshold that is used to classify the current samples into a plurality of groups (e.g., first group, second group) that results in (e.g., with an outcome of) the maximum inter-class intensity variance when the second threshold is applied to the current samples in the image histogram. In some embodiment, the coder determines the second threshold that outcomes the maximum inter-class intensity variance based on the Otsu's adaptive binarization algorithm disclosed by Nobuyuki Otsu in “[a] threshold selection method from gray-level histograms,” IEEE Transactions on Systems, Man, and Cybernetics. 9 (1): 62-66 (1979), which is hereby incorporated by reference in its entirety.

At block 3656, the coder classifies the current samples based on the determined second threshold into the plurality of groups. For example, the coder classifies the current samples into the first group (also referred to as group 0) and the second group (also referred to as group 1).

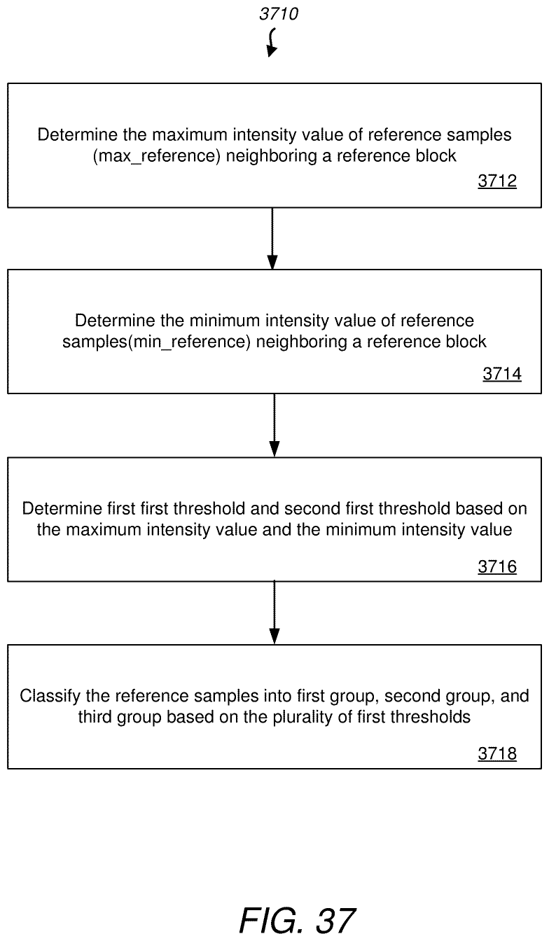

FIG. 37 shows a flowchart of an example method 3710 for determining a plurality of first thresholds (e.g., first first threshold, second first threshold) for classifying reference samples according to some embodiments. The method 3710 may be performed by a coder (e.g., encoder, decoder) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At operation 3712, the coder determines the maximum intensity value of reference samples (max_reference) neighboring a reference block.

At operation 3714, the coder determines the minimum intensity value of reference samples (min_reference) neighboring the reference block.

At operation 3716, the coder determines a first first threshold and a second first threshold based on the maximum intensity value and the minimum intensity value. In some examples, each of the first first threshold and the second first threshold may be determined based on a weighted average of the maximum intensity value and the minimum intensity value (e.g., first first threshold=⅓×max_reference+⅔×min_reference, second first threshold=⅔×max_reference+⅓×min_reference).

At operation 3718, the coder classifies the reference samples into first group (also referred to as group 0), second group (also referred to as group 1), and third group (also referred to as group 2) based on the determined the first first threshold and the second first threshold.

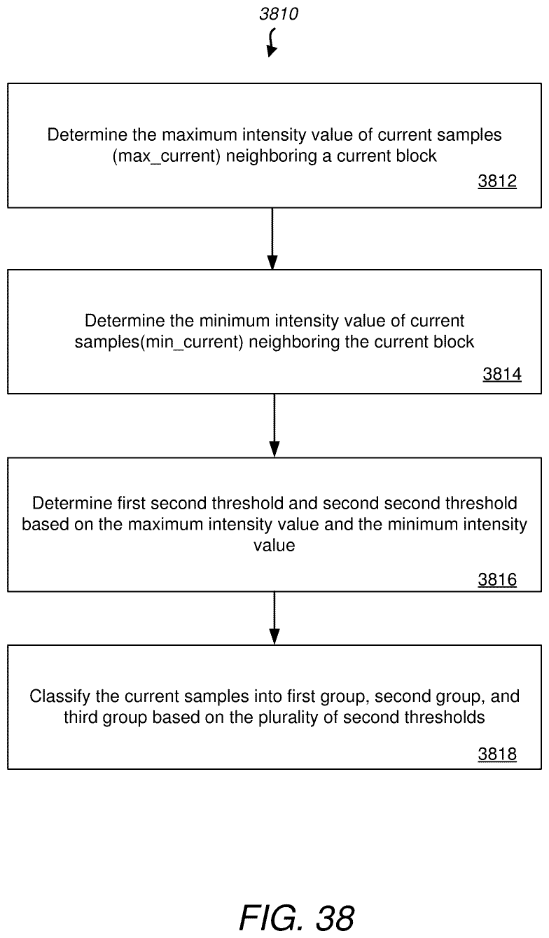

FIG. 38 shows a flowchart of an example method 3810 for determining a plurality of second thresholds (e.g., first second threshold, second second threshold) for classifying current samples according to some embodiments. The method 3810 may be performed by a coder (e.g., encoder, decoder) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At operation 3812, the coder determines the maximum intensity value of current samples (max_current) neighboring a current block.

At block 3814, the coder determines the minimum intensity value of current samples (min_current) neighboring the current block.

At operation 3816, the coder determines a first second threshold and a second second threshold based on the maximum intensity value and the minimum intensity value. In some examples, each of the first second threshold and the second second threshold may be determined based on a weighted average of the maximum intensity value and the minimum intensity value (e.g., first second threshold=⅓×max_current+⅔×min_current, second first threshold=⅔×max_current+⅓×min_current).

At operation 3818, the coder classifies the current samples into first second group (also referred to as group 0), second group (also referred to as group 1), and third group (also referred to as group 2) based on the determined the first second threshold and the second second threshold.

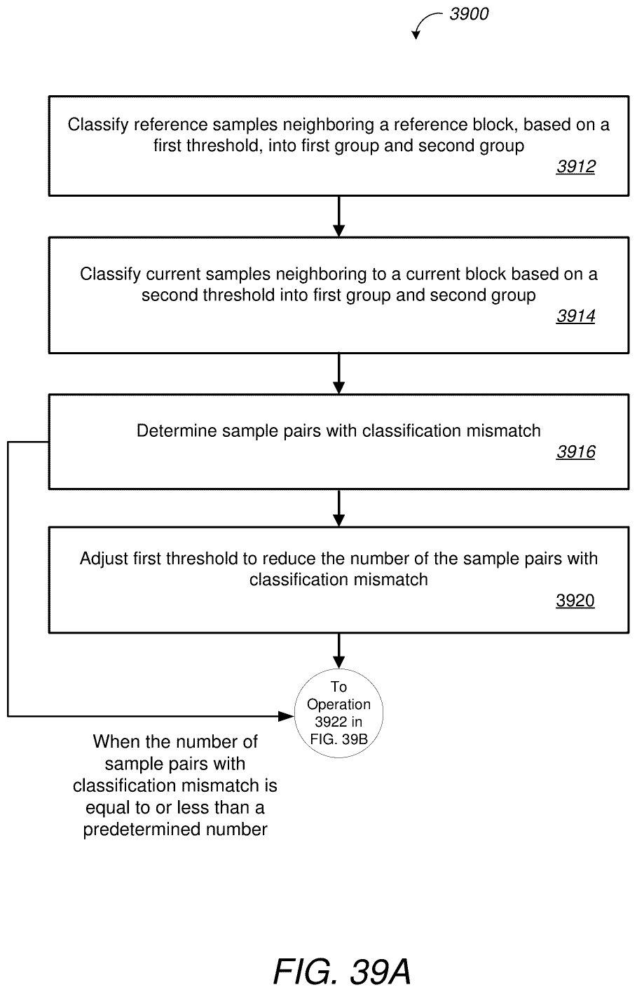

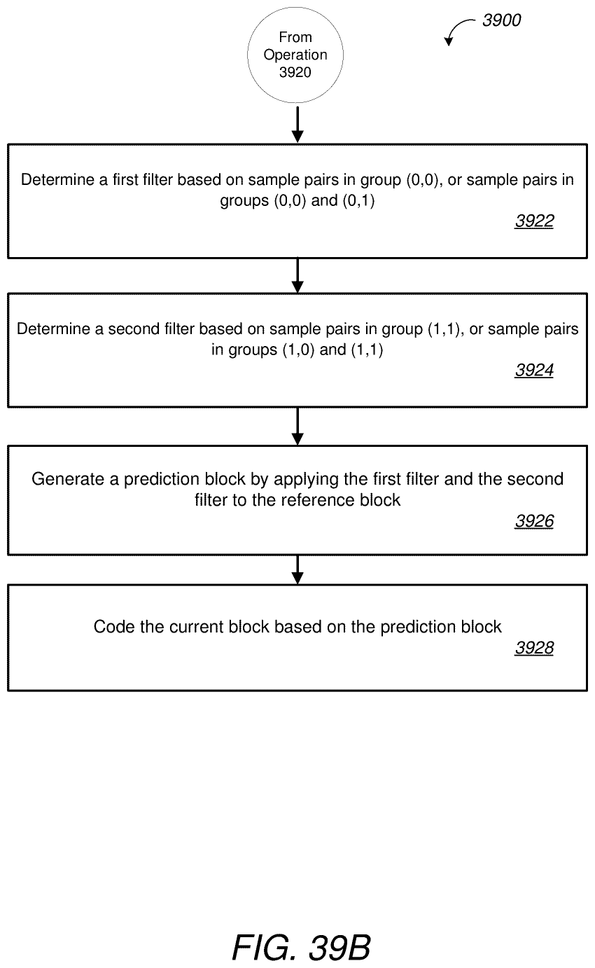

FIG. 39A and FIG. 39B illustrate a flowchart of an example method 3900 for generating a prediction block for a current block (e.g., for decoding a current block, for reconstructing a current block) according to some embodiments. The method 3900 may be performed by a coder (e.g., encoder, decoder) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At operation 3912, the coder classifies reference samples neighboring a reference block based on a first threshold into a first group and a second group.

At operation 3914, the coder classifies current samples neighboring a current block based on a second threshold into a first group and a second group.

At operation 3916, the coder determines samples pairs with classification mismatch.

At operation 3920, the coder adjusts the first threshold to reduce the number of sample pairs with classification mismatch. For example, as shown in FIGS. 30-34, the coder increases or decreases the first threshold to reduce the number of the sample pairs with classification mismatch. In some embodiments, the coder does not adjust the first threshold when the number of the sample pairs with classification mismatch is equal or less than a predetermined number.

At operation 3922, the coder determines (e.g., derives) a first filter based on sample pairs in the group (0, 0), or sample pairs in the groups (0, 0) and (0, 1).

At operation 3924, the coder determines (e.g., derives) a second filter based on samples pairs in the group (1, 1), or sample pairs in the groups (1, 0) and (1, 1).

At operation 3926, the coder generates a prediction block by applying the first filter and the second filter to the reference block. In some embodiments, the coder classifies samples in the reference block into a first group and a second group based on the first threshold. In some embodiments, the coder classifies samples in the reference block into a first group and a second group based on the second threshold. In some embodiments, the coder classifies samples in the reference block into a first group and a second group based on an average value of intensity values of samples in the reference block. In some embodiments, the coder classifies samples in the reference block into a first group and a second group based on an average value of the lowest intensity value of samples in the reference block and the greatest intensity value of samples in the reference block. In some embodiments, the coder classifies samples in the reference block into a first group and a second group based on a reference block threshold that results in a maximum inter-class intensity variance when the reference block threshold is applied to samples in the reference block. In some embodiments, the coder classifies samples in the reference block into a first group and a second group based on a reference block threshold that results in a minimum intra-class intensity variance when the reference block threshold is applied to samples in the reference block. In some embodiments, the coder generates a first portion of the prediction block by applying the first filter to reference samples in the first group, and the coder generates a second portion of the prediction block by applying the second filter to reference sample in the second group.

At operation 3928, when the coder is an encoder, in some embodiments, the coder determines (e.g., codes, generates) a prediction error (e.g., residual) based on the difference between a block being encoded and the prediction block. At operation 3928, when the coder is a decoder, the coder determines (e.g., codes, generates) the current block based on the prediction block (and the residual received from another coder (e.g., encoder). In this example, the coder determines the first filter and the second filter, and the coder applies the first filter and the second filter to the reference block to determine (e.g., to generate) the prediction block. However, the present disclosure does not limit the number of filters for determining (e.g., generating) the prediction block. For example, the coder determines a first filter, a second filter and third filter, and the coder applies the first filter, the second filter and the third filter to the reference block to determine (e.g., to generate) the prediction block.

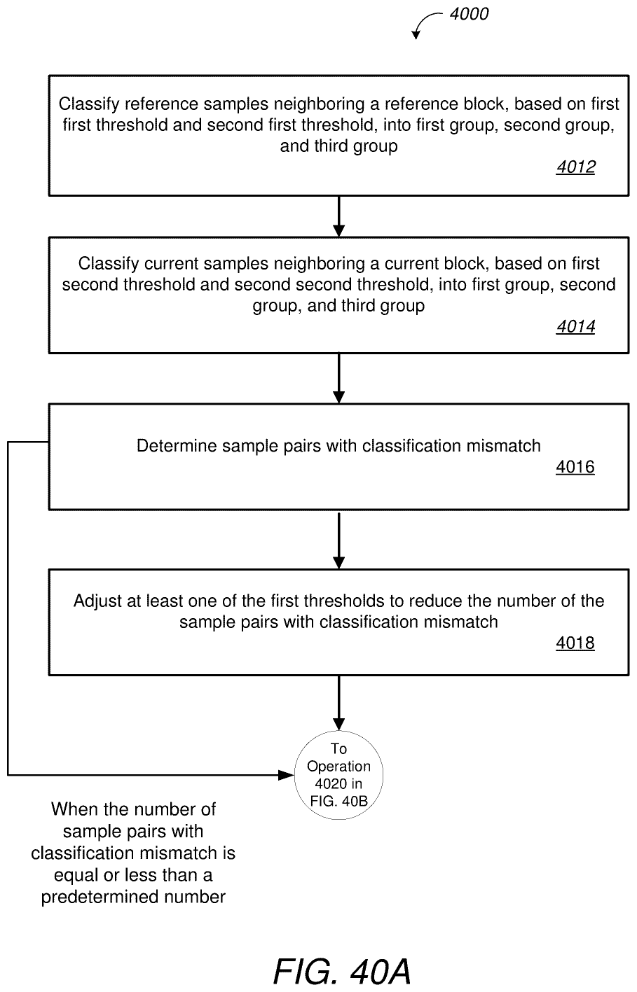

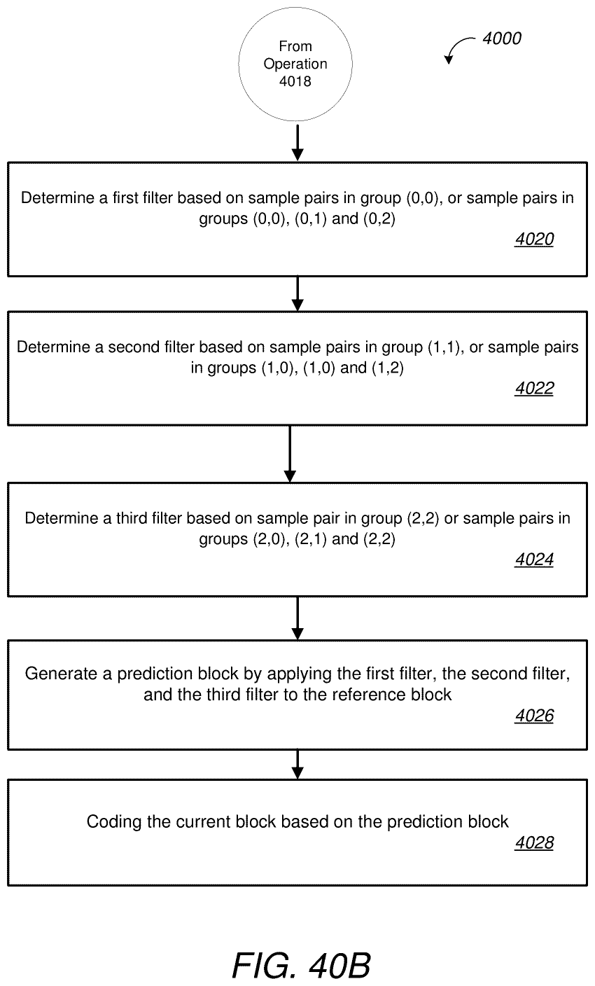

FIG. 40A and FIG. 40B illustrate a flowchart of an example method 4000 for generating a prediction block for a current block (e.g., for decoding a current block, for reconstructing a current block) according to some embodiments. The method 4000 may be performed by a coder (e.g., encoder, decoder) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At operation 4012, the coder classifies the reference samples neighboring a reference block based on first first threshold and second first threshold into first group (also referred to as group 0), second group (also referred to as group 1), and third group (also referred to as group 2).

At operation 4014, the coder classifies the current samples neighboring a current block based on first second threshold and second second threshold into first group (also referred to as group 0), second group (also referred to as group 1), and third group (also referred to as group 2).

At operation 4016, the coder determining samples pairs with classification mismatch.

At operation 4018, the coder adjusts at least one of the first first threshold, and second first threshold to reduce the number of the sample pairs with classification mismatch. In some embodiments, the coder skips the operation 4018 when the number of the sample pair is less than or equal to a predetermined number.

At operation 4020, the coder determines (e.g., derives) a first filter based on sample pairs in the group (0, 0), or sample pairs in the groups (0, 0), (0, 1) and (0,2).

At operation 4022, the coder determines (e.g., derives) a second filter based on sample pairs in group (1, 1) or sample pairs in the groups (1, 0), (1, 1) and (1,2).

At operation 4024, the coder determines (e.g., derives) a third filter based on samples pairs in group (2,2), or sample pairs in the group (2,0), (2,1) and (2,2).

At operation 4026, the coder generates the prediction block by applying the first filter, the second filter, and the third filter to the reference block. In some embodiments, the coder classifies samples in the reference block into a first group, a second group, and third group based on the first first threshold and the second first threshold discussed in FIG. 37. In some embodiments, the coder classifies samples in the reference block into a first group, a second group, and third group based on the first second threshold and the second second threshold discussed in FIG. 38.

In some embodiments, the coder classifies samples in the reference block into a first group, a second group, and third group based a first third threshold and second third threshold (e.g., first third threshold=⅓×max_ref+⅔×min_ref, second third threshold=⅔×max_ref+⅓×min_ref, wherein max_ref is the maximum intensity value of sample in the reference block and min_ref is the minimum intensity value of sample in the reference block).

In some embodiments, the coder generates a first portion of the prediction block by applying the first filter to reference samples in the first group, the coder generates a second portion of the prediction block by applying the second filter to reference samples in the second group, and coder generates a third portion of the prediction block by applying the third filter to reference samples in the third group.

At operation 4028, when the coder is an encoder, in some embodiments, the coder determines (e.g., codes, generates) a prediction error (e.g., residual) based on the difference between a block being encoded and the prediction block. At operation 4028, when the coder is a decoder, the coder determines (e.g., codes, generates) the current block based on the prediction block (and the residual received from another coder (e.g., encoder).

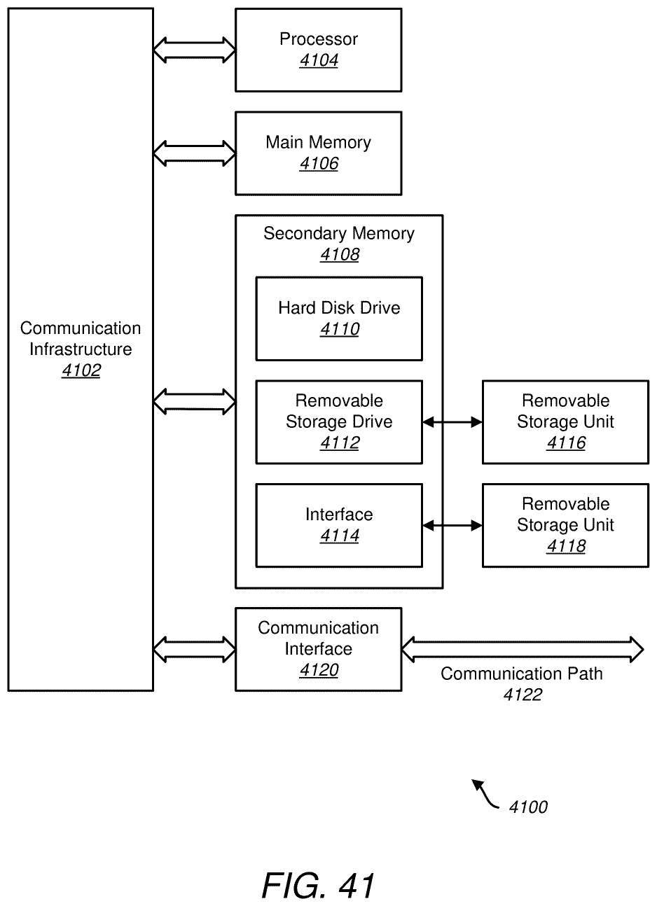

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system (e.g., processing logic) or other processing system. An example of such a computer system 4100 is shown in FIG. 41. Blocks depicted in the figures above, such as the blocks in FIGS. 1, 2, and 3, may execute on one or more computer systems 4100. Furthermore, each of the steps of the flowcharts depicted in this disclosure may be implemented on one or more computer systems 4100.

Computer system 4100 includes one or more processors, such as processor 4104. Processor 4104 may be, for example, a special purpose processor, general purpose processor, microprocessor, or digital signal processor. Processor 4104 may be connected to a communication infrastructure 4102 (for example, a bus or network). Computer system 4100 may also include a main memory 4106, such as random access memory (RAM), and may also include a secondary memory 4108.

Secondary memory 4108 may include, for example, a hard disk drive 4110 and/or a removable storage drive 4112, representing a magnetic tape drive, an optical disk drive, or the like. Removable storage drive 4112 may read from and/or write to a removable storage unit 4116 in a well-known manner. Removable storage unit 4116 represents a magnetic tape, optical disk, or the like, which is read by and written to by removable storage drive 4112. As will be appreciated by persons skilled in the relevant art(s), removable storage unit 4116 includes a computer usable storage medium having stored therein computer software and/or data.

In alternative implementations, secondary memory 4108 may include other similar means for allowing computer programs or other instructions to be loaded into computer system 4100. Such means may include, for example, a removable storage unit 4118 and an interface 4114. Examples of such means may include a program cartridge and cartridge interface (such as that found in video game devices), a removable memory chip (such as an EPROM or PROM) and associated socket, a thumb drive and USB port, and other removable storage units 4118 and interfaces 4114 which allow software and data to be transferred from removable storage unit 4118 to computer system 4100.

Computer system 4100 may also include a communications interface 4120. Communications interface 4120 allows software and data to be transferred between computer system 4100 and external devices. Examples of communications interface 4120 may include a modem, a network interface (such as an Ethernet card), a communications port, etc. Software and data transferred via communications interface 4120 are in the form of signals which may be electronic, electromagnetic, optical, or other signals capable of being received by communications interface 4120. These signals are provided to communications interface 4120 via a communications path 4122. Communications path 4122 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 4116 and 4118 or a hard disk installed in hard disk drive 4110. These computer program products are means for providing software to computer system 4100. Computer programs (also called computer control logic) may be stored in main memory 4106 and/or secondary memory 4108. Computer programs may also be received via communications interface 2820. Such computer programs, when executed, enable the computer system 4100 to implement the present disclosure as discussed herein. In particular, the computer programs, when executed, enable processor 4104 to implement the processes of the present disclosure, such as any of the methods described herein. Accordingly, such computer programs represent controllers of the computer system 4100.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
classifying, based on a first threshold, first samples neighboring a reference block into at least a first group and a second group;
classifying, based on a second threshold, second samples corresponding to the first samples and neighboring a current block into at least the first group and the second group;
determining a first filter based on first sample pairs of samples, of the first samples, classified in the first group and corresponding samples, of the second samples, classified in the first group;
determining a second filter based on second sample pairs of samples, of the first samples, classified in the second group and corresponding samples, of the second samples, classified in the second group;
determining a prediction block based on applying at least the first and second filters to the reference block; and
coding the current block based on the prediction block.

2. The method of claim 1, wherein:
the first sample pairs exclude first non-matching sample pairs of samples, of the first samples, classified in the first group and corresponding samples, of the second samples, classified in the second group; and
the second sample pairs exclude second non-matching sample pairs of samples, of the first samples, classified in the second group and corresponding samples, of the second samples, classified in the first group.

3. The method of claim 2, further comprising:
adjusting an initial first threshold to determine the first threshold that reduces a number of the first and second non-matching sample pairs.

4. The method of claim 1, wherein:
the first threshold is determined based on:
an average of intensity values of the first samples; or
an average of a minimum intensity value of the first samples and a maximum intensity value of the first samples; and
the second threshold is determined based on:
an average of intensity values of the second samples; or
an average of a minimum intensity value of the second samples and a maximum intensity value of the second samples.

5. The method of claim 1, wherein:
the first threshold is determined to result in:
a minimum intra-class intensity variance when the first threshold is applied to the first samples; or
a maximum inter-class intensity variance when the first threshold is applied to the first samples; and
the second threshold is determined to result in:
a minimum intra-class intensity variance when the second threshold is applied to the second samples; or
a maximum inter-class intensity variance when the second threshold is applied to the second samples.

6. The method of claim 1, wherein the determining the prediction block comprises:
applying the first filter to a first portion of the reference block to generate a first portion of the prediction block; and
applying the second filter to a second portion of the reference block to generate a second portion of the prediction block.

7. The method of claim 6, wherein the first portion of the reference block and the second portion of the reference block are determined based on classifying samples of the reference block according to a reference block threshold that is:
the second threshold;
an average value of intensity values of the samples in the reference block; or
an average value of a minimum intensity value of samples in the reference block and a maximum intensity value of samples in the reference block.

8. The method of claim 6, wherein the first portion of the reference block and the second portion of the reference block are determined based on a reference block threshold that results in:
a minimum intra-class intensity variance when the reference block threshold is applied to samples in the reference block; or
a maximum inter-class intensity variance when the reference block threshold is applied to samples in the reference block.

9. A device comprising one or more processors and memory storing instructions that, when executed by the one or more processors, cause the device to:
classify, based on a first threshold, first samples neighboring a reference block into at least a first group and a second group;
classify, based on a second threshold, second samples corresponding to the first samples and neighboring a current block into at least the first group and the second group;
determine a first filter based on first sample pairs of samples, of the first samples, classified in the first group and corresponding samples, of the second samples, classified in the first group;
determine a second filter based on second sample pairs of samples, of the first samples, classified in the second group and corresponding samples, of the second samples, classified in the second group;
determine a prediction block based on applying at least the first and second filters to the reference block; and
code the current block based on the prediction block.

10. The device of claim 9, wherein:
the first sample pairs exclude first non-matching sample pairs of samples, of the first samples, classified in the first group and corresponding samples, of the second samples, classified in the second group; and
the second sample pairs exclude second non-matching sample pairs of samples, of the first samples, classified in the second group and corresponding samples, of the second samples, classified in the first group.

11. The device of claim 9, wherein:
the first threshold is determined based on:
an average of intensity values of the first samples; or
an average of a minimum intensity value of the first samples and a maximum intensity value of the first samples; and
the second threshold is determined based on:
an average of intensity values of the second samples; or
an average of a minimum intensity value of the second samples and a maximum intensity value of the second samples.

12. The device of claim 9, wherein:
the first threshold is determined to result in:
a minimum intra-class intensity variance when the first threshold is applied to the first samples; or
a maximum inter-class intensity variance when the first threshold is applied to the first samples; and
the second threshold is determined to result in:
a minimum intra-class intensity variance when the second threshold is applied to the second samples; or
a maximum inter-class intensity variance when the second threshold is applied to the second samples.

13. The device of claim 9, wherein to determine the prediction block, the device is further caused to:
apply the first filter to a first portion of the reference block to generate a first portion of the prediction block; and
apply the second filter to a second portion of the reference block to generate a second portion of the prediction block.

14. The device of claim 13, wherein the first portion of the reference block and the second portion of the reference block are determined based on classifying samples of the reference block according to a reference block threshold that is:
the second threshold;
an average value of intensity values of the samples in the reference block; or
an average value of a minimum intensity value of samples in the reference block and a maximum intensity value of samples in the reference block.

15. The device of claim 13, wherein the first portion of the reference block and the second portion of the reference block are determined based on a reference block threshold that results in:
a minimum intra-class intensity variance when the reference block threshold is applied to samples in the reference block; or
a maximum inter-class intensity variance when the reference block threshold is applied to samples in the reference block.

16. A non-transitory computer-readable medium comprising instructions that, when executed by one or more processors of a device, cause the device to:
classify, based on a first threshold, first samples neighboring a reference block into at least a first group and a second group;
classify, based on a second threshold, second samples corresponding to the first samples and neighboring a current block into at least the first group and the second group;
determine a first filter based on first sample pairs of samples, of the first samples, classified in the first group and corresponding samples, of the second samples, classified in the first group;
determine a second filter based on second sample pairs of samples, of the first samples, classified in the second group and corresponding samples, of the second samples, classified in the second group;
determine a prediction block based on applying at least the first and second filters to the reference block; and
code the current block based on the prediction block.

17. The non-transitory computer-readable medium of claim 16, wherein:
the first sample pairs exclude first non-matching sample pairs of samples, of the first samples, classified in the first group and corresponding samples, of the second samples, classified in the second group; and
the second sample pairs exclude second non-matching sample pairs of samples, of the first samples, classified in the second group and corresponding samples, of the second samples, classified in the first group.

18. The non-transitory computer-readable medium of claim 16, wherein:
the first threshold is determined based on:
an average of intensity values of the first samples; or
an average of a minimum intensity value of the first samples and a maximum intensity value of the first samples; and
the second threshold is determined based on:
an average of intensity values of the second samples; or
an average of a minimum intensity value of the second samples and a maximum intensity value of the second samples.

19. The non-transitory computer-readable medium of claim 16, wherein:
the first threshold is determined to result in:
a minimum intra-class intensity variance when the first threshold is applied to the first samples; or
a maximum inter-class intensity variance when the first threshold is applied to the first samples; and
the second threshold is determined to result in:
a minimum intra-class intensity variance when the second threshold is applied to the second samples; or
a maximum inter-class intensity variance when the second threshold is applied to the second samples.

20. The non-transitory computer-readable medium of claim 16, wherein to determine the prediction block, the device is further caused to:
apply the first filter to a first portion of the reference block to generate a first portion of the prediction block; and
apply the second filter to a second portion of the reference block to generate a second portion of the prediction block.
